(19) United States
(12) Patent Application Publication
(10) Pub. No.: US 2013/0309005 A1
(43) Pub. Date: Nov. 21, 2013

(54) ELECTRICAL ENCLOSURE

(71) Applicant: Benedict Barrett, County Kildare (IE)

(72) Inventor: Benedict Barrett, County Kildare (IE)

(73) Assignee: BENEDICT RESEARCH COMPANY LIMITED, County Kildare (IE)

(21) Appl. No.: 13/981,931

(22) PCT Filed: Jan. 30, 2012
(86) PCT No.: PCT/EP12/51475

§ 371 Date: Aug. 8, 2013

(30) Foreign Application Priority Data
Jan. 28, 2011 (IE) S2011/0038

(51) Int. Cl. H02B 1/30

(52) U.S. Cl. CPC H02B 1/30
USPC 403/361

(57) ABSTRACT

The present invention relates to an assembly suitable for use in forming an electrical enclosure comprising at least one joining bracket having a set of first connectors disposed along at least one edge thereof; and at least one structural component having at least one set of second connectors affixed thereto, the first connectors being complementary to the second connectors, such that the at least one joining bracket and the at least one structural component become automatically secured together when the first and second connectors are brought into engagement. The connectors may be male and female connectors. The engagement may be releasable. The invention is not limited to electrical boxes but may be used to form assemblies and enclosures for other purposes, such as storage, toys and so on.

### INTRODUCTION

The present invention relates to an assembly suitable for use in forming an electrical enclosure. In particular, it relates to an assembly comprising at least one joining bracket having a set of first connectors disposed along at least one edge thereof; and at least one component having at least one set of second connectors affixed thereto, the first connectors being complementary to the second connectors.

Such electrical enclosures, also known as electrical boxes or low-voltage enclosures, include fuse boxes; control panels for electronic and pneumatic systems, telecom cabinets, computer server boxes, meter boxes, switch gear installations and so on. Such enclosures are widely installed, in residential, commercial and industrial environments.

Electrical enclosures are in general formed using sheets of metal welded together into the desired configuration. There may also be some folding steps involved in their manufacture, to form lips for doors and the like. In other examples, forming the electrical enclosure involves bolting or screwing together the panels to form the box. It will be understood that such processes may also require the use of drilling and tapping steps. Further methods for forming electrical boxes include riveting the panels together.

The electrical enclosures may be formed on site or, more commonly and formed by a manufacturer and shipped to a re-seller or their end location.

The known methods of forming electrical enclosures have a number of disadvantages associated therewith however. Welding and riveting, for example, require complicated equipment and skilled operators. These can therefore be costly methods of assembly.

Bolting sheets of material together is a time consuming task and can also require complex machinery to punch suitable holes in the materials.

It is an object therefore of the present invention to provide an assembly for use in forming an electrical enclosure that overcomes at least some of the above-mentioned problems.

### STATEMENTS OF INVENTION

According to the invention there is provided an assembly for use in forming an electrical enclosure comprising at least one joining bracket having a set of first connectors disposed along at least one edge thereof; and at least one structural component having at least one set of second connectors affixed thereto, the first connectors being complementary to the second connectors, such that the at least one joining bracket and the at least one structural component become automatically secured together when the first and second connectors are brought into engagement.

In this way, a quick and simple manner of forming an assembly suitable for use as an electrical enclosure is provided. The assembly may be shipped unassembled, reducing the space required, as shipping assembled boxes involves a very inefficient use of the space available for loading. Shipping unassembled boxes is therefore much more efficient and better value than shipping assembled boxes. Additionally, putting together the assembly of the invention in an extremely quick and simple process that does not require the use of any tools or any special skills. Components may simply be clicked together without the requirement for any further components such as nuts, screws, rivets or bolts are required, nor is any of the drilling, folding, welding or tapping equipment that is required to form known electrical boxes. It will be understood that the invention is not limited to electrical boxes but may be used to form assemblies and enclosures for other purposes, such as storage, toys and so on.

In one embodiment of the invention there is provided an assembly in which one of the first connector and second connector comprises a female connector having a recess and the other of the first connector and second connector comprises a male connector having a projecting finger. This is a convenient and adaptable method of providing connectors.

In another embodiment of the invention there is provided an assembly in which the first connectors or second connectors comprise a release mechanism adapted to disengage an engagement of the first connectors and second connectors. In this way, the assembly may be taken apart and re-assembled as required. This allows for the construction of modular boxes and the like that may be easily expanded and adjusted as required.

Users may experiment with a number of configurations of the assembly of the invention before settling on a final version that they are happy with.

In a further embodiment of the invention there is provided an assembly in which the male connector comprises a neck portion adjacent a distal end of the projecting finger. In this way, a secure engagement may be made between the neck and the female connecter

In an alternative embodiment of the invention there is provided an assembly in which the male connector comprises a plurality of sawtooth serrations on at least one surface of the projecting finger. Sawtooth serrations allow a complementary connector to move in one direction over inclined faces, but prevent movement in the other direction with upright faces.

In one embodiment of the invention there is provided an assembly in which the projecting finger of the male connector tapers towards its distal end. This eases insertion of the male connector into the recess of the female connector.

In another embodiment of the invention there is provided an assembly in which the female connector comprises a locking mechanism adapted to project into the recess. In this way, the male connector may be secured in the recess of the female connector when the connectors are brought into engagement.

In a further embodiment of the invention there is provided an assembly in which the locking mechanism comprises a plurality of sawtooth serrations on at least one surface thereof. Sawtooth serrations are a very effective locking mechanism.

In an alternative embodiment of the invention there is provided an assembly in which one or both of the set of first connectors and second connectors is formed into a connector assembly. A connector assembly is a very convenient way of working with the sets of connectors.

In one embodiment of the invention there is provided an assembly in which the connector assembly comprises at least two sets of connectors, each at a differing orientation. In this way, connector assemblies may be used to form a variety of types of assembly. Furthermore, connector assemblies of this type allow for the interconnection of more than two components, or two types of components, together

In another embodiment of the invention there is provided an assembly in which the at least two sets of connectors in the connector assembly are opposed to each other.

In a further embodiment of the invention there is provided an assembly in which connectors within a set are spaced-apart with respect to each other and staggered with respect to the opposing set of connectors. This allows for efficient use of space within the connector assembly, as the staggered connectors can intersperse with each other

In an alternative embodiment of the invention there is provided an assembly in which connectors within a set are spaced-apart with respect to each other and in line with the opposing set of connectors.

In one embodiment of the invention there is provided an assembly further comprising at least two joining brackets and at least one corner bracket adapted to connect the joining brackets to each other. In this way, a stable frame for the assembly may be formed.

In another embodiment of the invention there is provided an assembly in which the at least one joining bracket in which the set of connectors are distributed along substantially the full length of at least one edge thereof. In this way, connectors may be brought into engagement all along the length of the joining bracket, providing a strong stable engagement between components.

In a further embodiment of the invention there is provided an assembly in which the at least one structural component comprises at least one connector assembly disposed along a plurality of edges thereof. In this way, connections may be made at a plurality of edges of the structural component, allowing for a great variety of assemblies of the formed according to the invention.

In another embodiment of the invention there is provided an assembly as claimed in any preceding claim in which the at least one joining bracket comprises at least one set of connectors on a plurality of edges thereof. In this way, connections may be made at a plurality of edges of the joining bracket, allowing for a great variety of assemblies of the formed according to the invention.

In one embodiment of the invention there is provided an assembly wherein the joining bracket comprises a mounting rail. The mounting rail may be used to mount accessories and other components on the joining brackets. For example, mounting rails may be used to mount hinge on to door-type joining brackets.

In another embodiment of the invention there is provided an assembly in which the mounting mail comprises a T-shaped projection. This is a particularly convenient shape of mounting rail, providing stability to any accessories mounted thereon.

In a further embodiment of the invention there is provided an assembly in which the cross-bar of the T-shape is knurled. In this way, accessories mounted thereon will not slide easily along the mounting rail, ensuring that accessories remain in their desired location.

In one embodiment of the invention there is provided an assembly further comprising an accessory component, wherein the accessory component comprises at least one set of first connectors or second connectors, and the accessory component is secured to the set of connectors on a structural component. In this way, accessory components may be mounted within an assembly according to the invention, away from the frame work of that assembly. In some cases, the accessory components may be adapted to have further components or articles mounted thereon.

According to a further embodiment of the invention, there is provided a female connector assembly suitable for use as the first or second connector in an assembly according to the invention, the female connector assembly comprising at least one set of aligned recesses, each having a locking mechanism to project into the recess. Such female connector assemblies are very useful in forming assemblies according to the invention.

In another embodiment of the invention there is provided a female connector assembly further comprising two opposing sets of female connectors. In this way, one set of female connectors may be used to connect a structural component, such as a panel, to a joining bracket, while the opposing set of female connectors may be used to connect to an accessory bracket so as to provide a manner of including accessories on the assembly.

According to a further embodiment of the invention, there is provided a male connector assembly suitable for use as the first or second connector in the assembly of the invention, the male connector assembly comprising a set of aligned projecting fingers. Such a male connector assembly is very convention for use in forming simply erected assemblies.

In a further embodiment of the invention there is provided a male connector assembly further comprising at least two sets of male connectors.

In one embodiment of the invention there is provided a male connector assembly in which the at least two of the sets of male connectors are mutually orthogonal. In this way, the male connector assemblies are useful in providing corner arrangements with joining brackets.

### DETAILED DESCRIPTION OF THE INVENTION

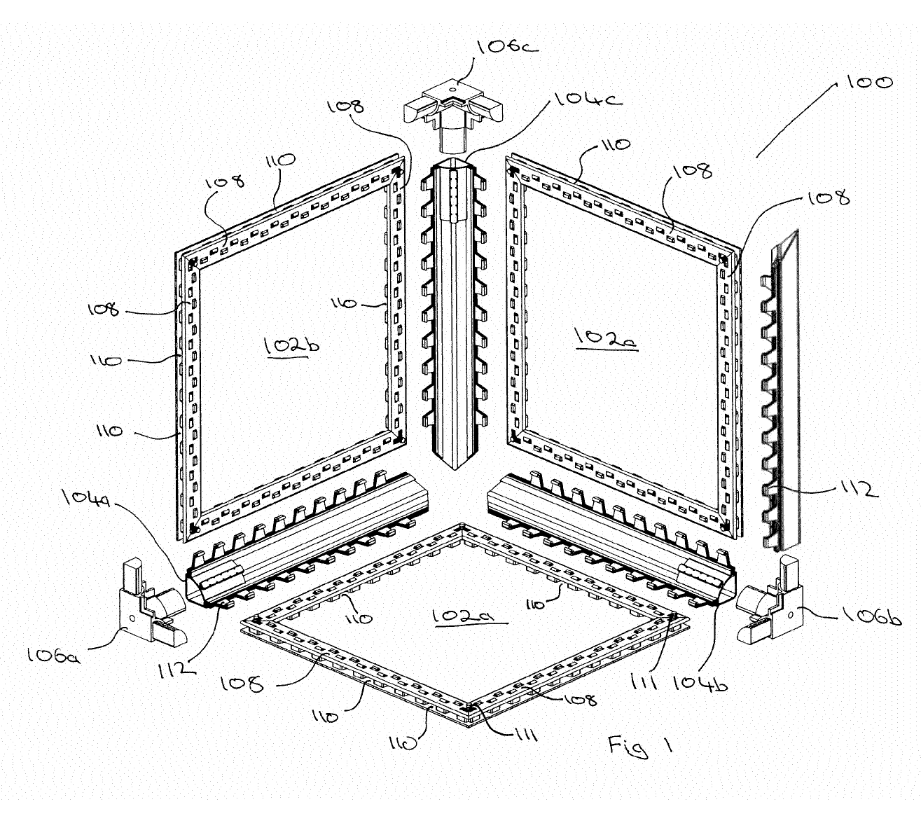

The invention will now be more clearly understood from the following description of an embodiment thereof given by way of example only with reference to the accompanying drawings in which: FIG. 1 is an exploded perspective view of a sample assembly according to the invention;

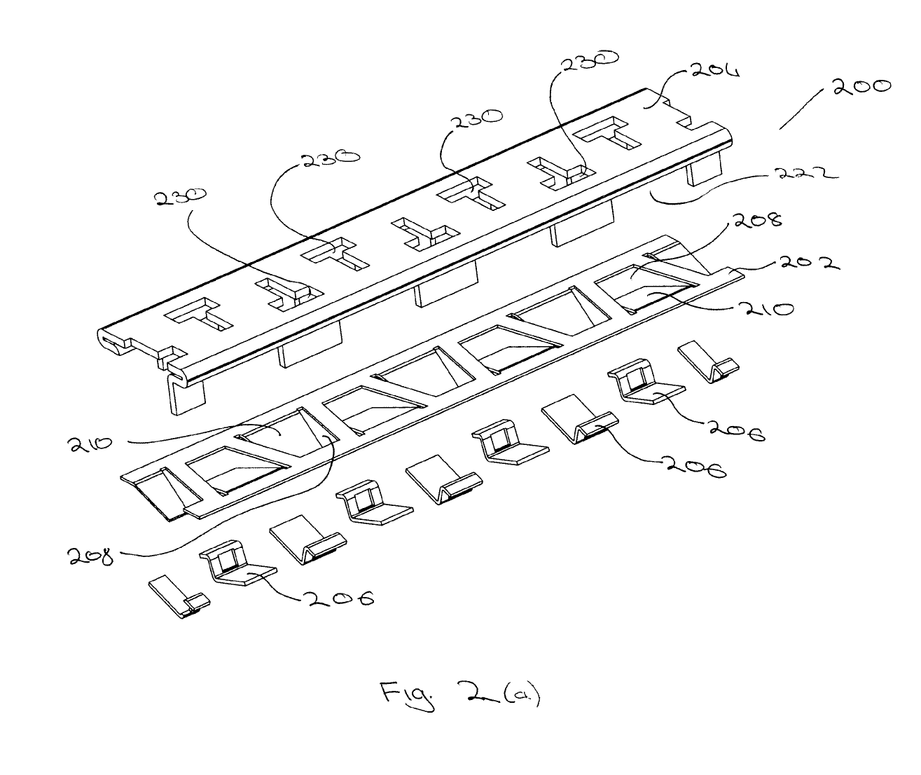

FIG. 2(a) is a perspective exploded view of an embodiment of a female connector assembly for use in the invention;

FIG. 2(b) is a perspective view of the female connector assembly of FIG. 2(a);

FIGS. 2(c) and (d) are perspective and end views respectively of a portion of the female connector assembly;

FIGS. 2(e) and (f) are side and perspective end views of a locking clip for use in the female connector assembly of FIG. 2(a);

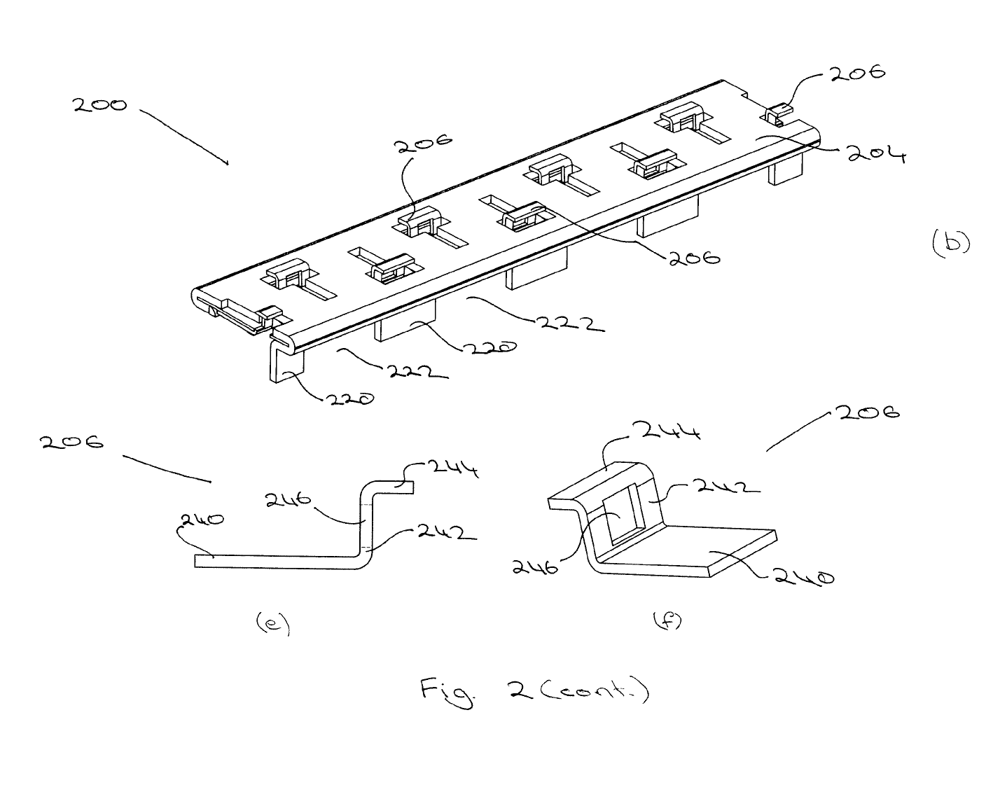

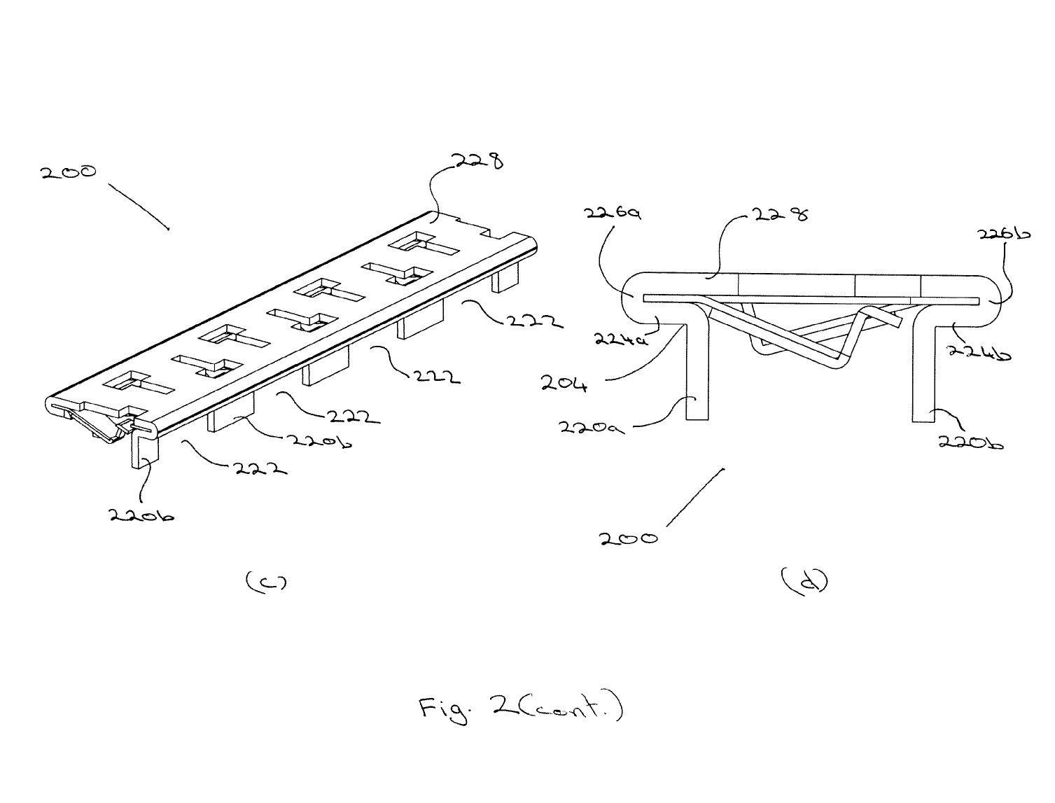

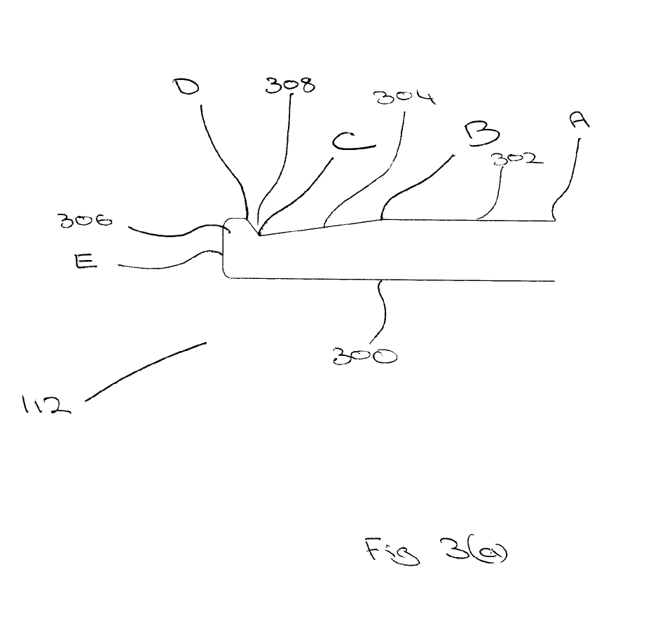

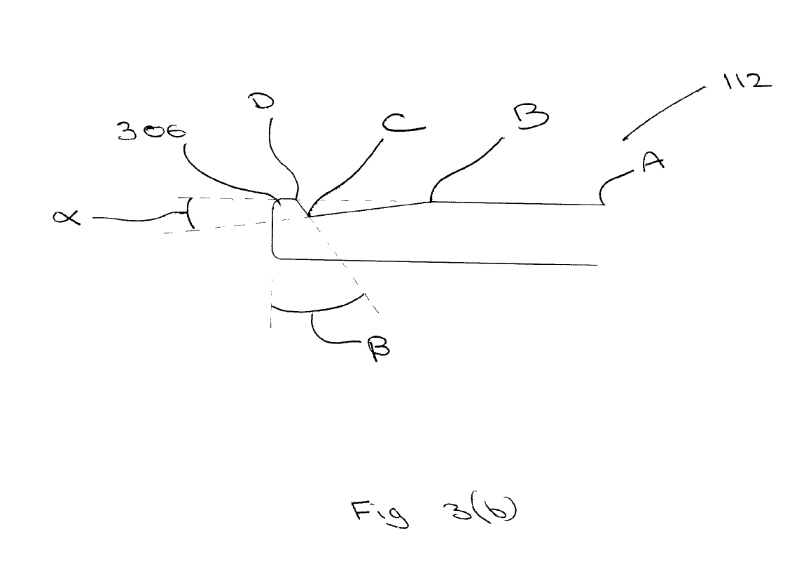

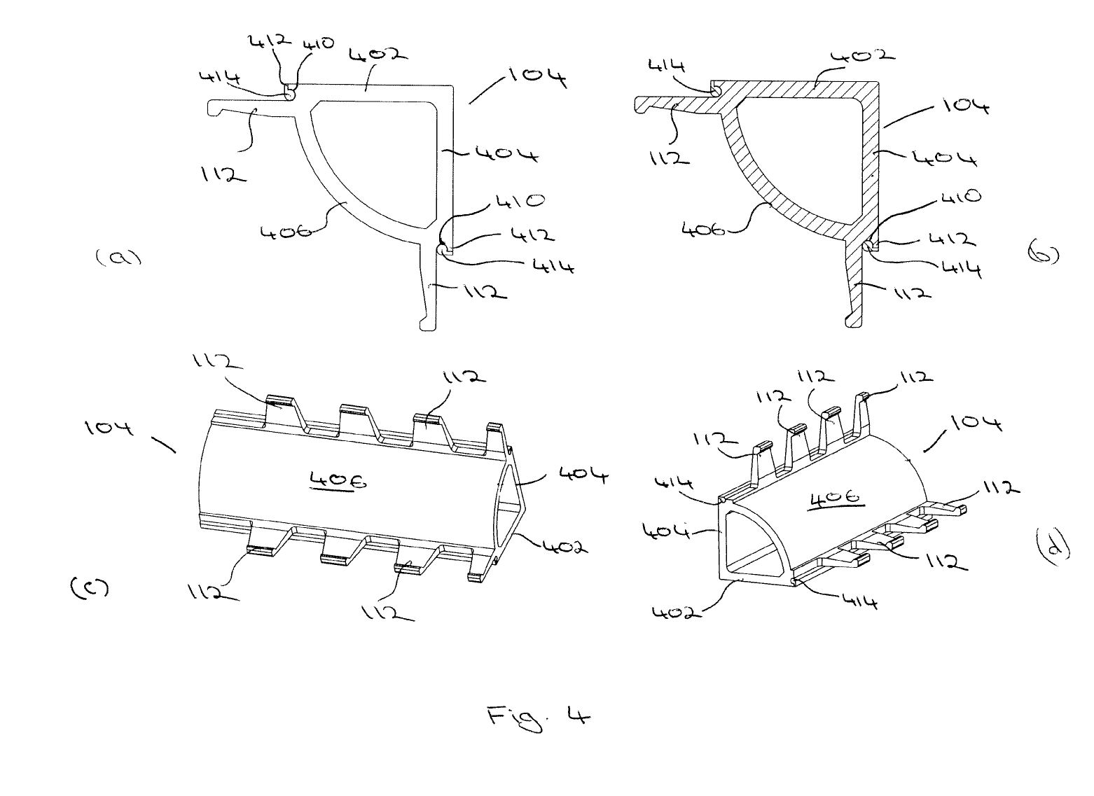

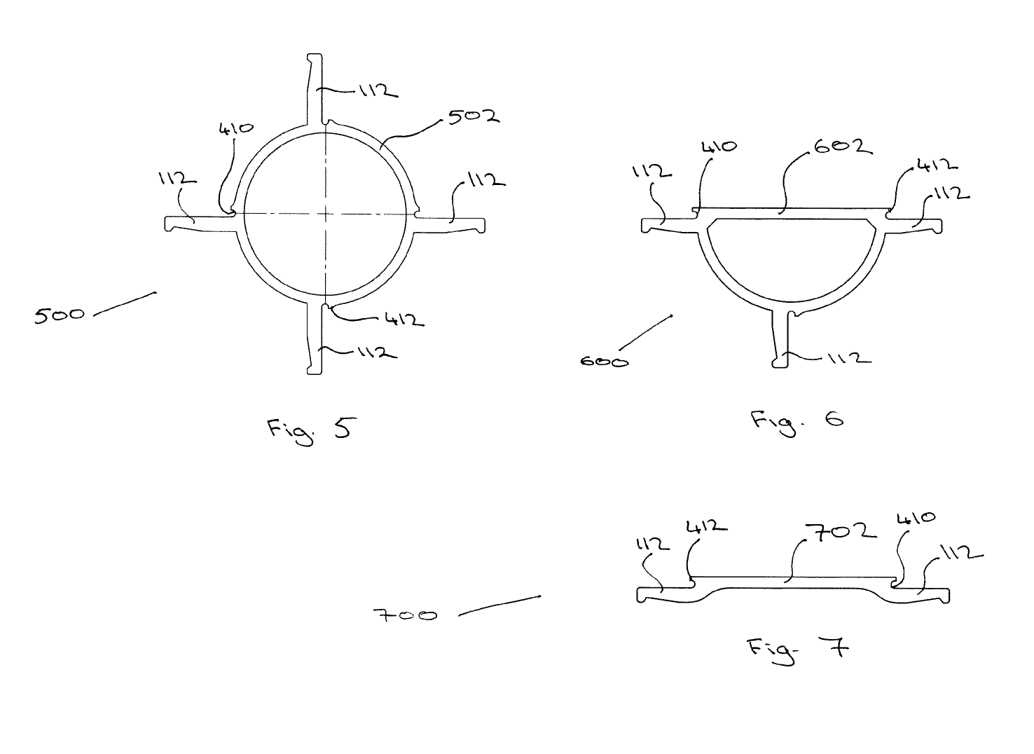

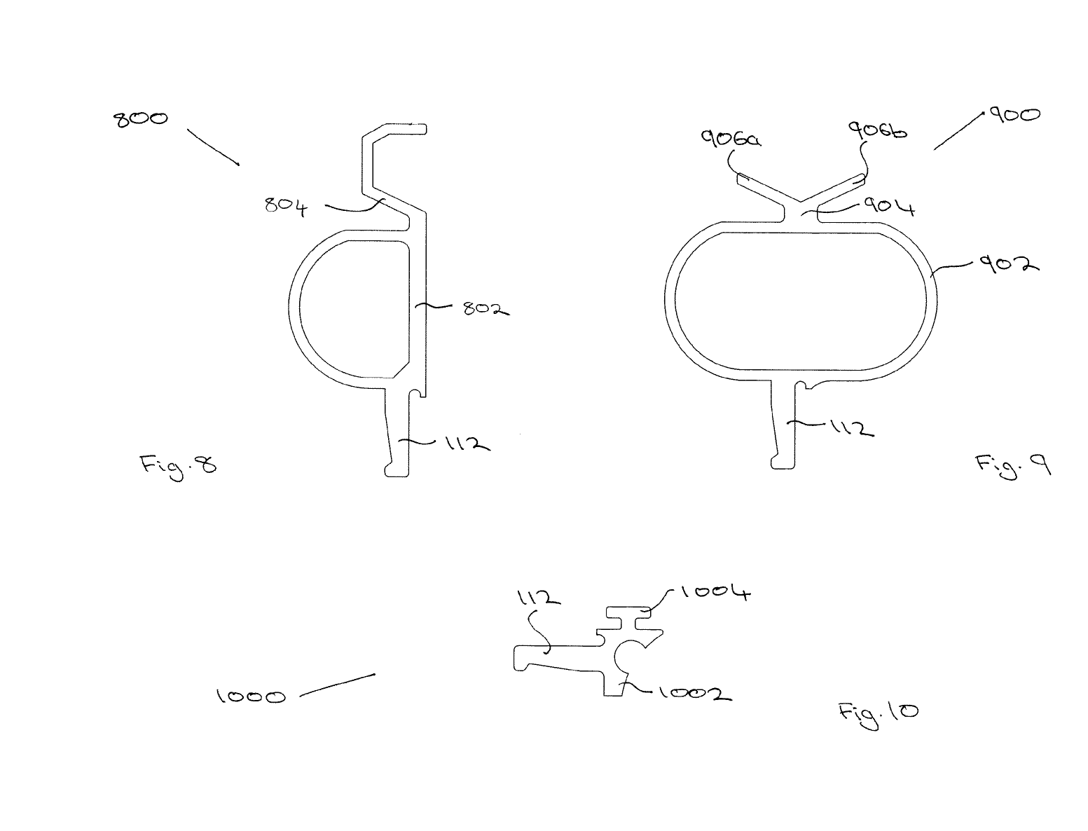

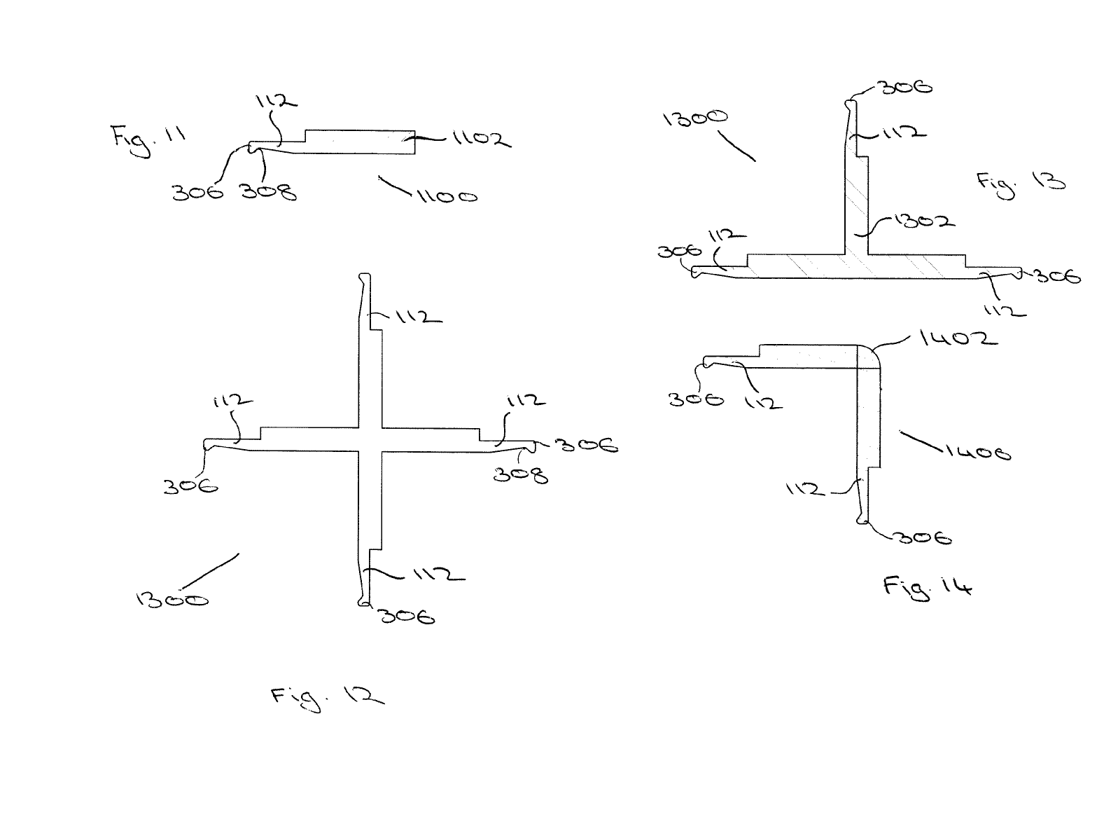

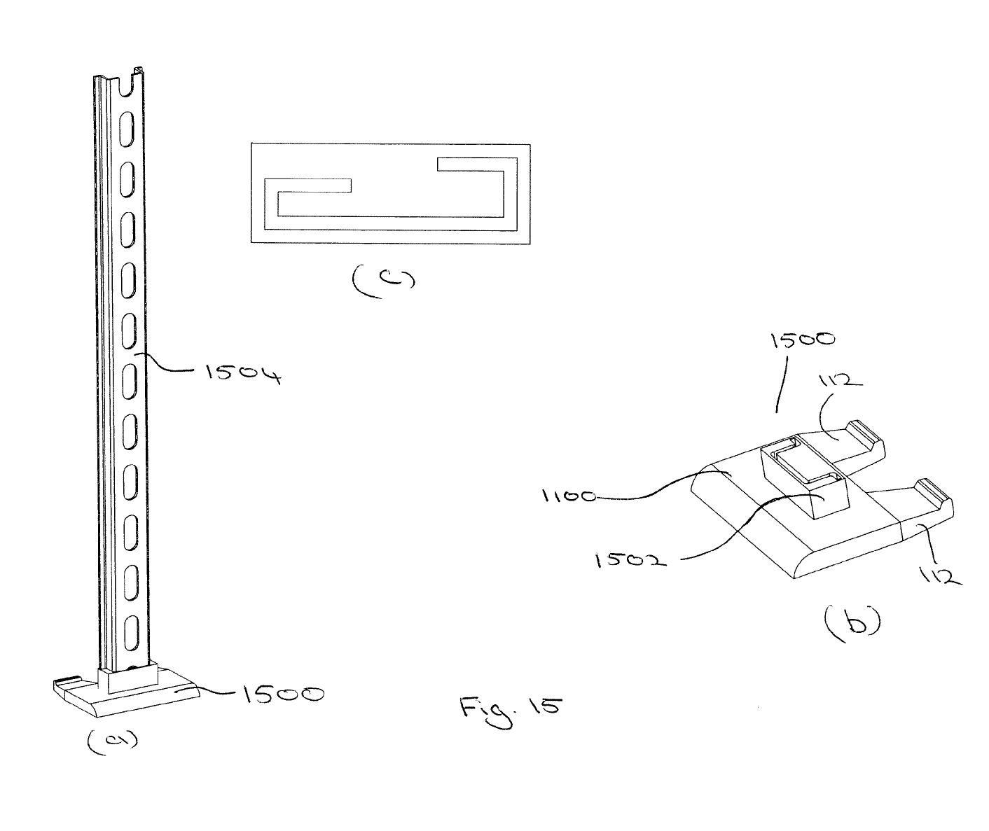

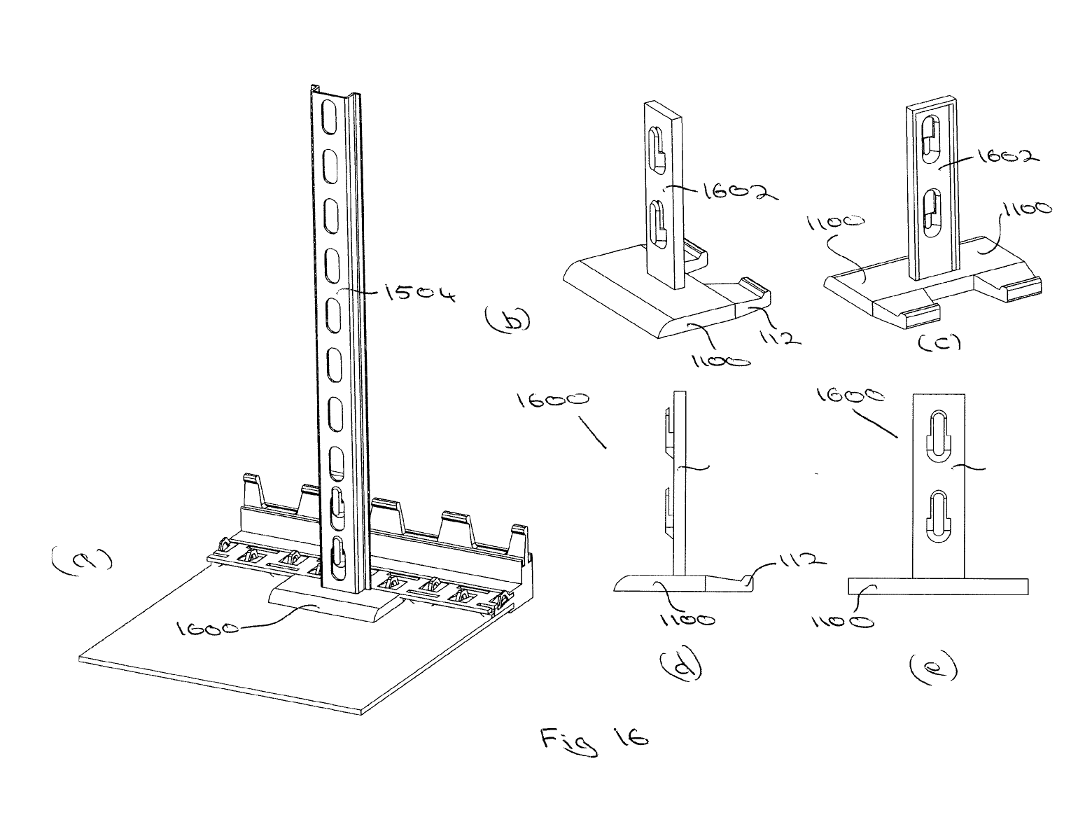

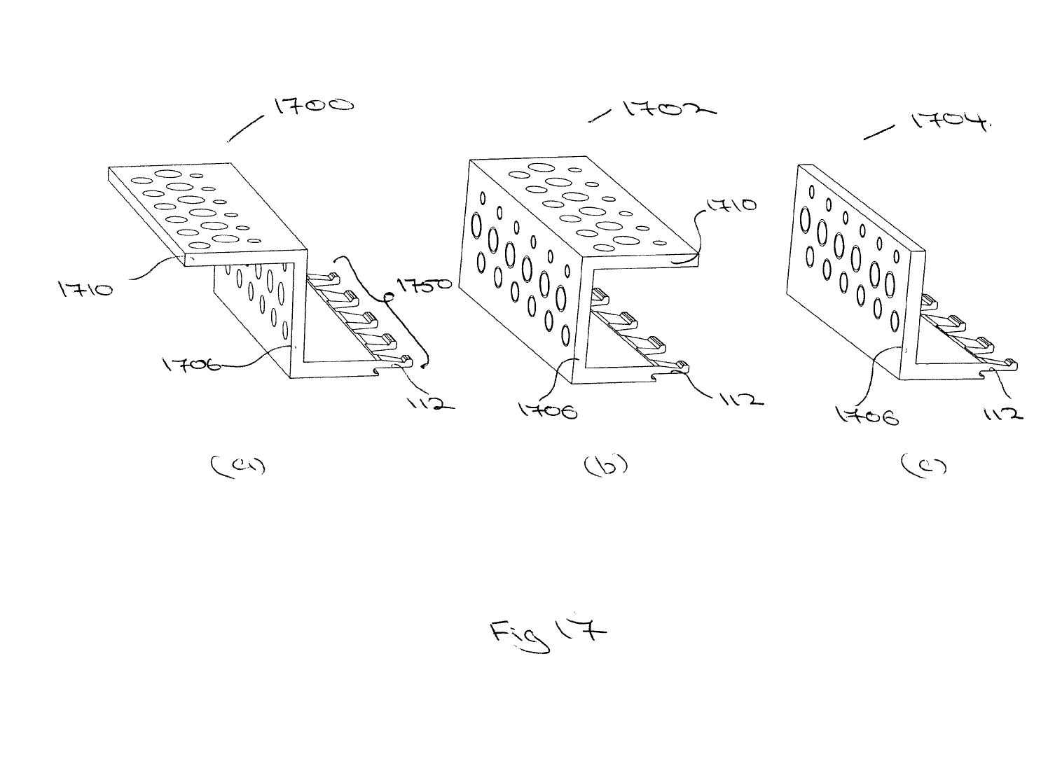

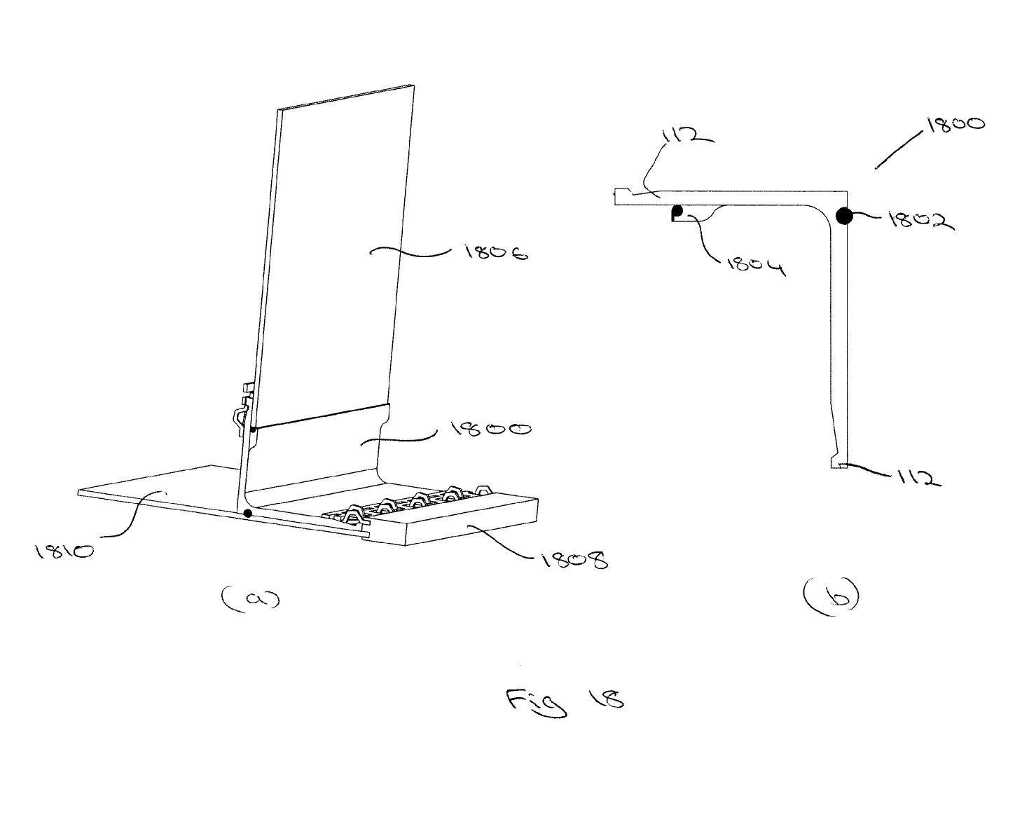

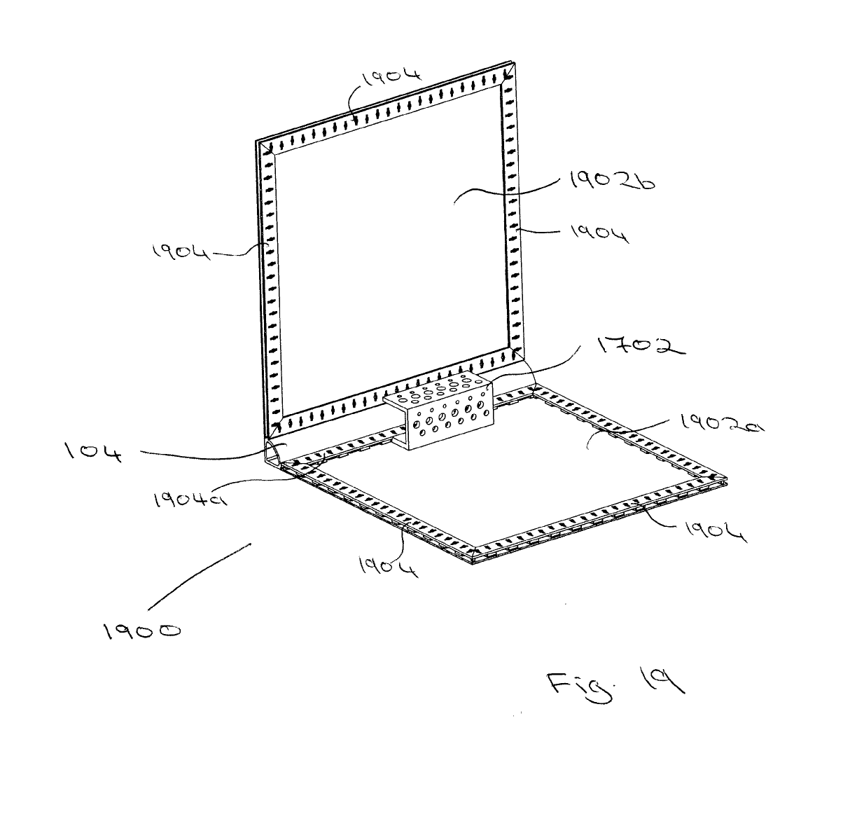

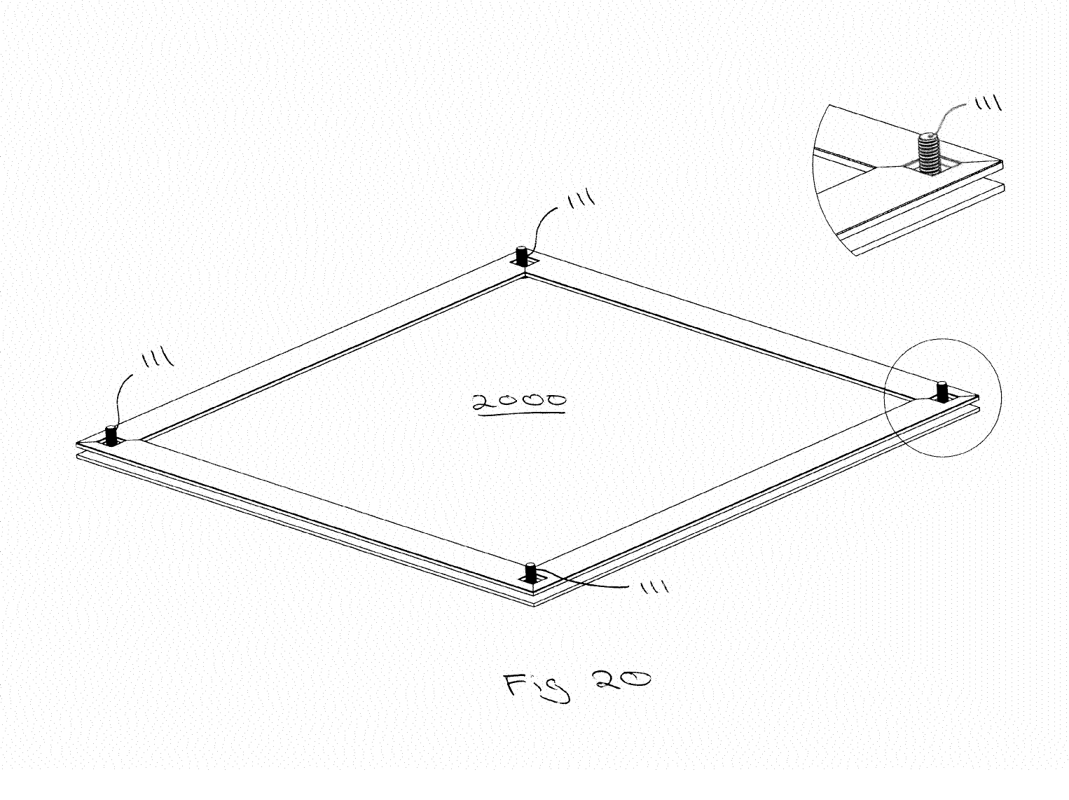

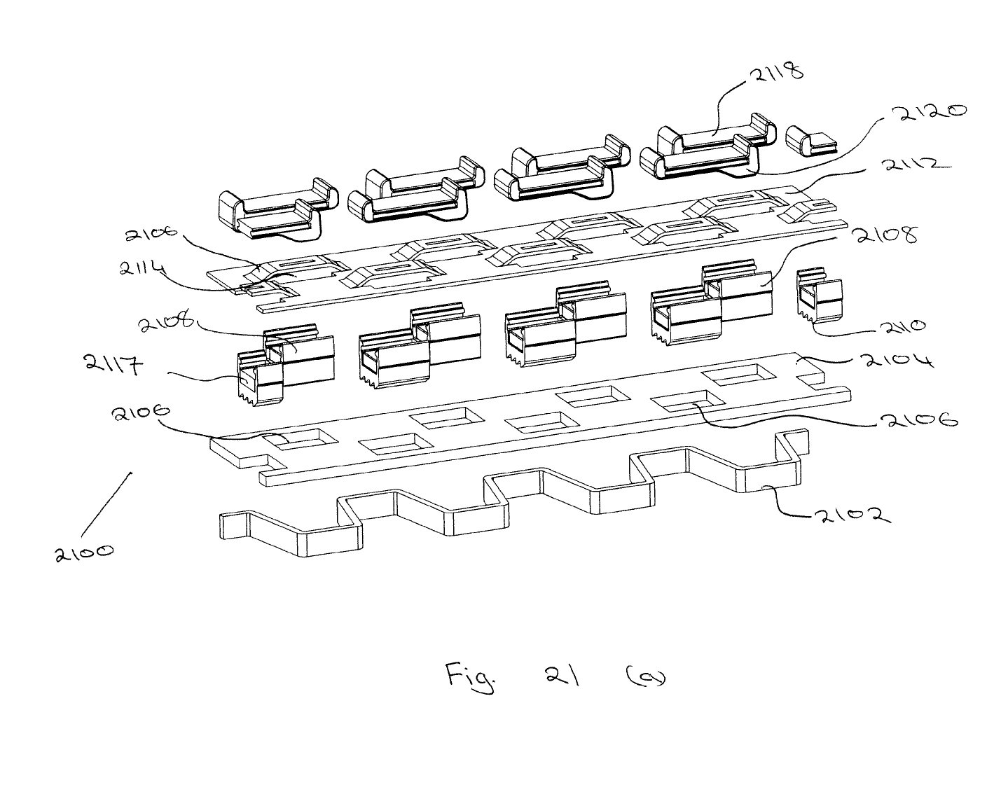

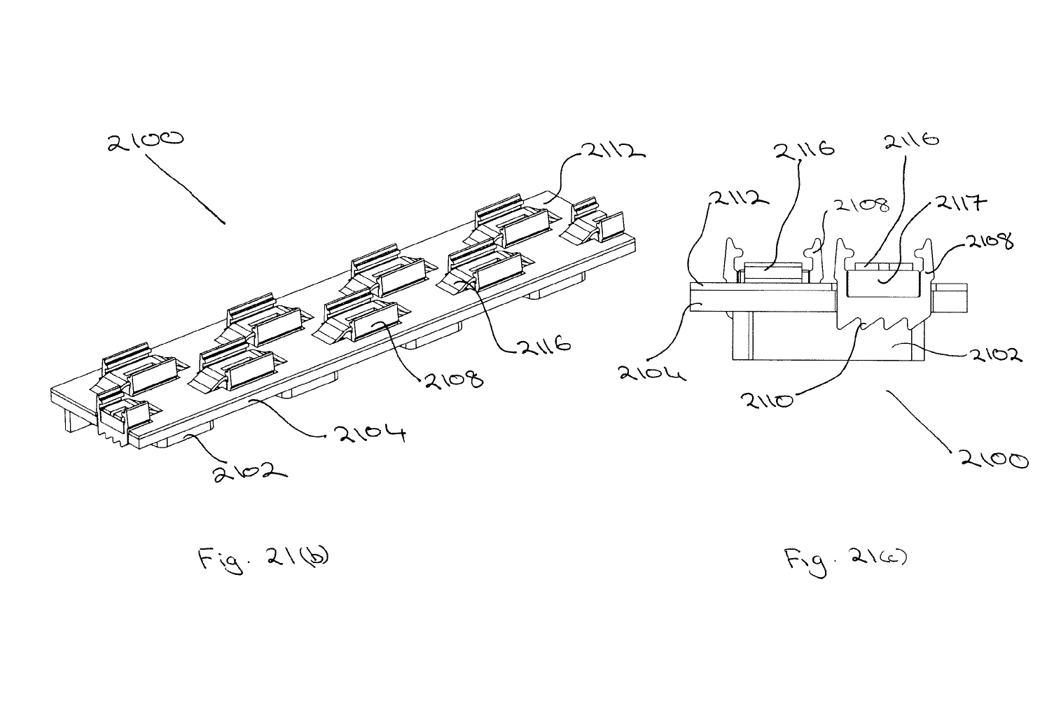

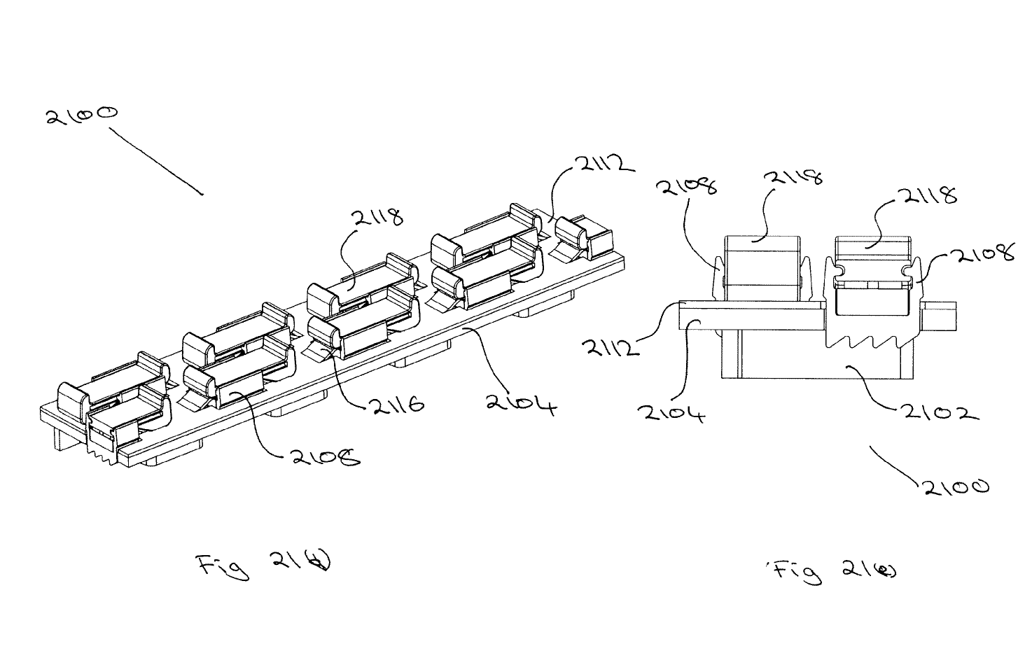

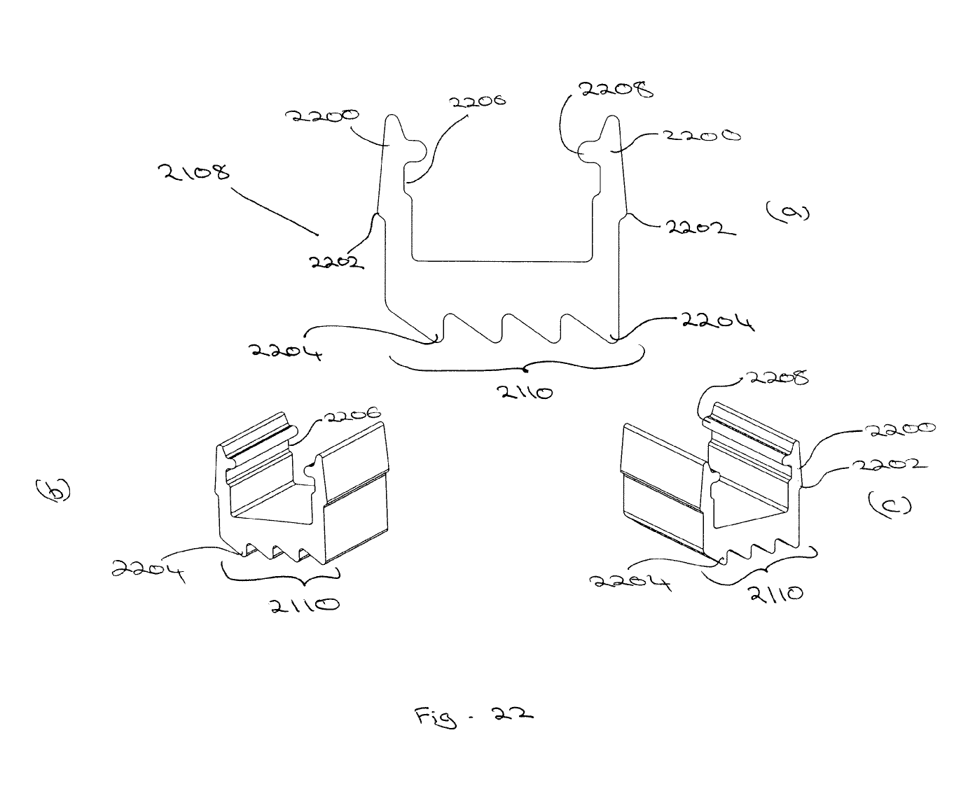

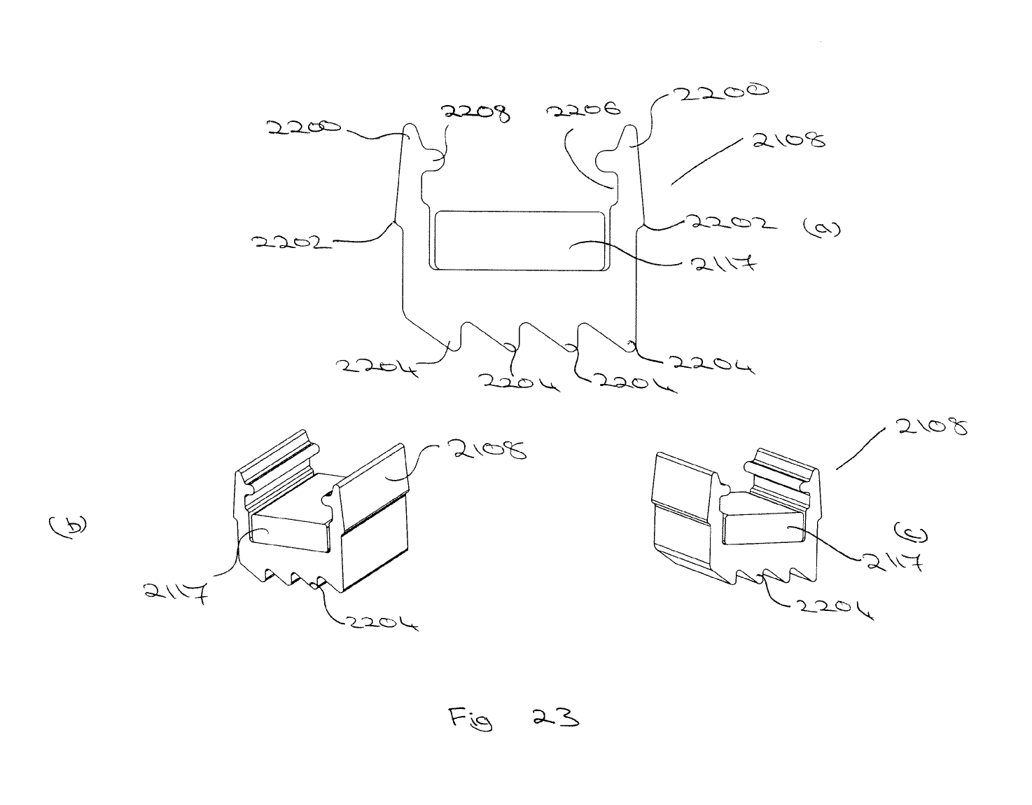

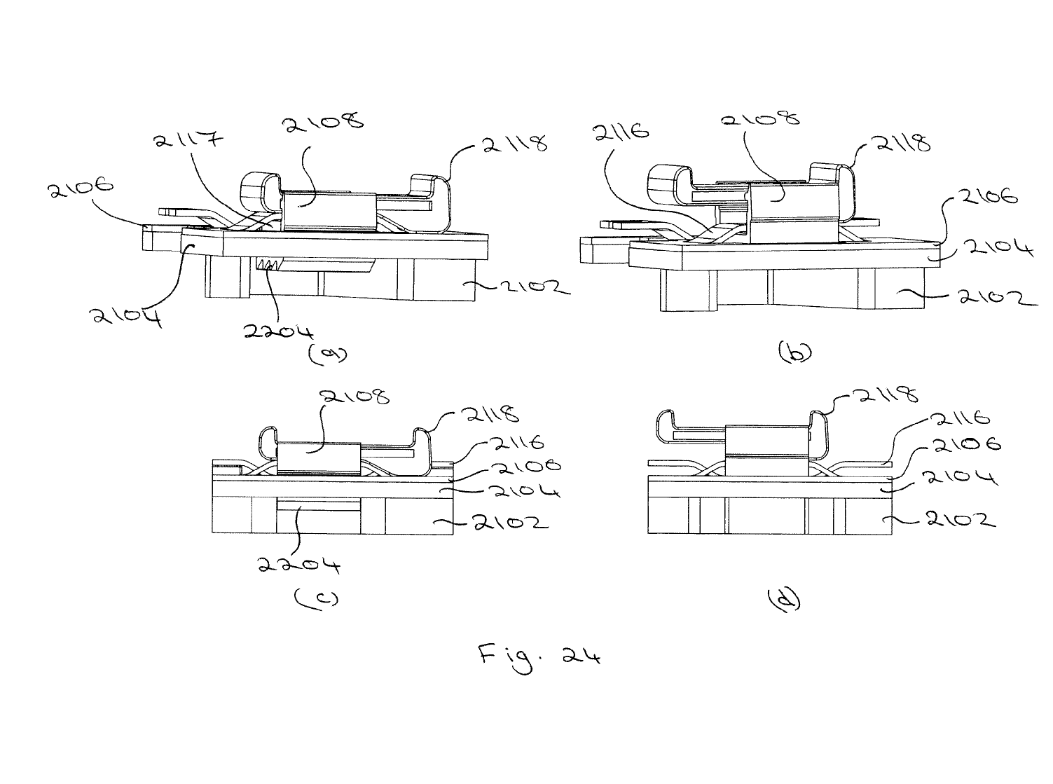

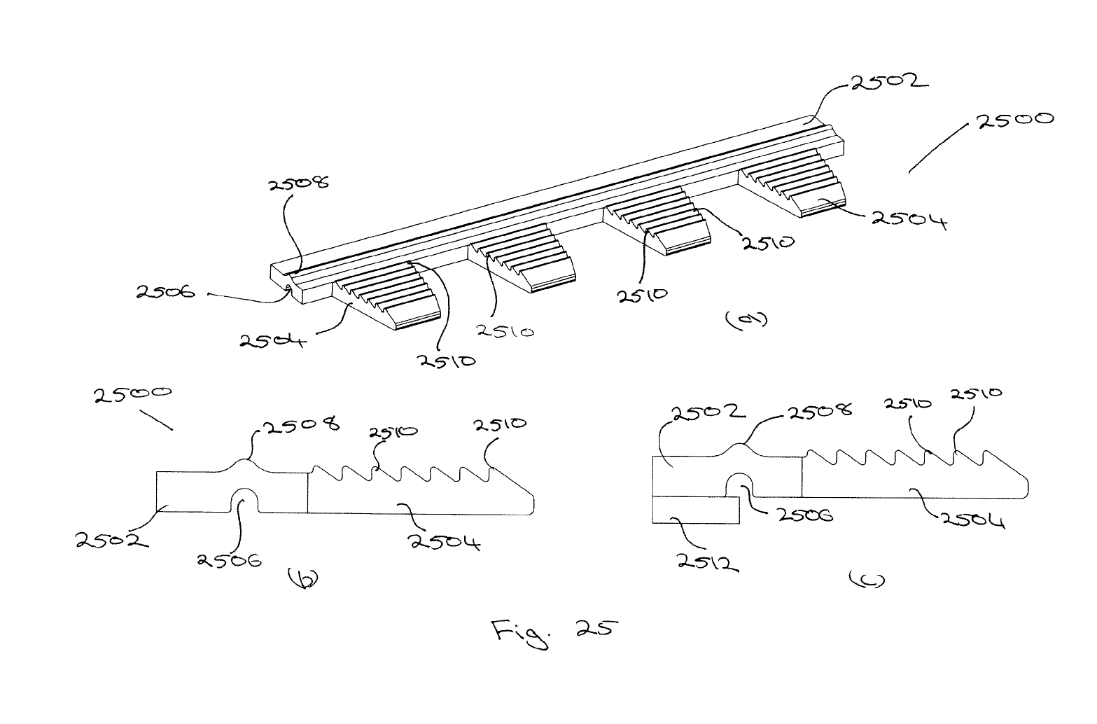

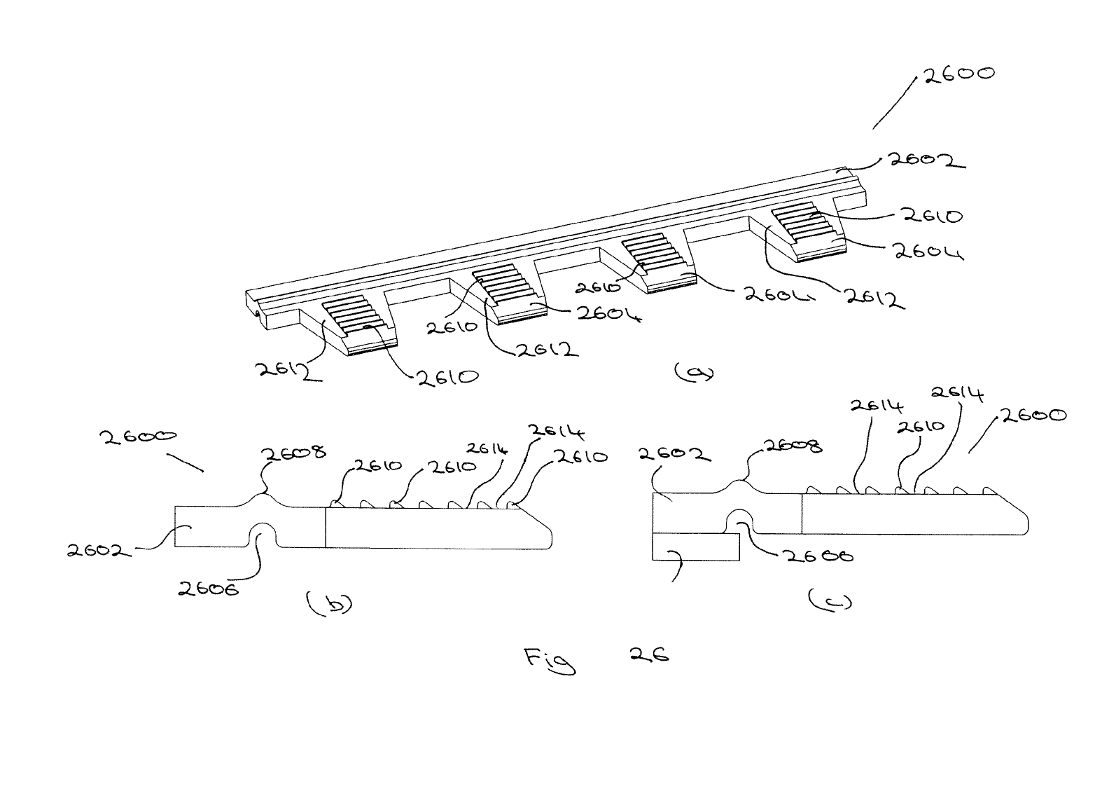

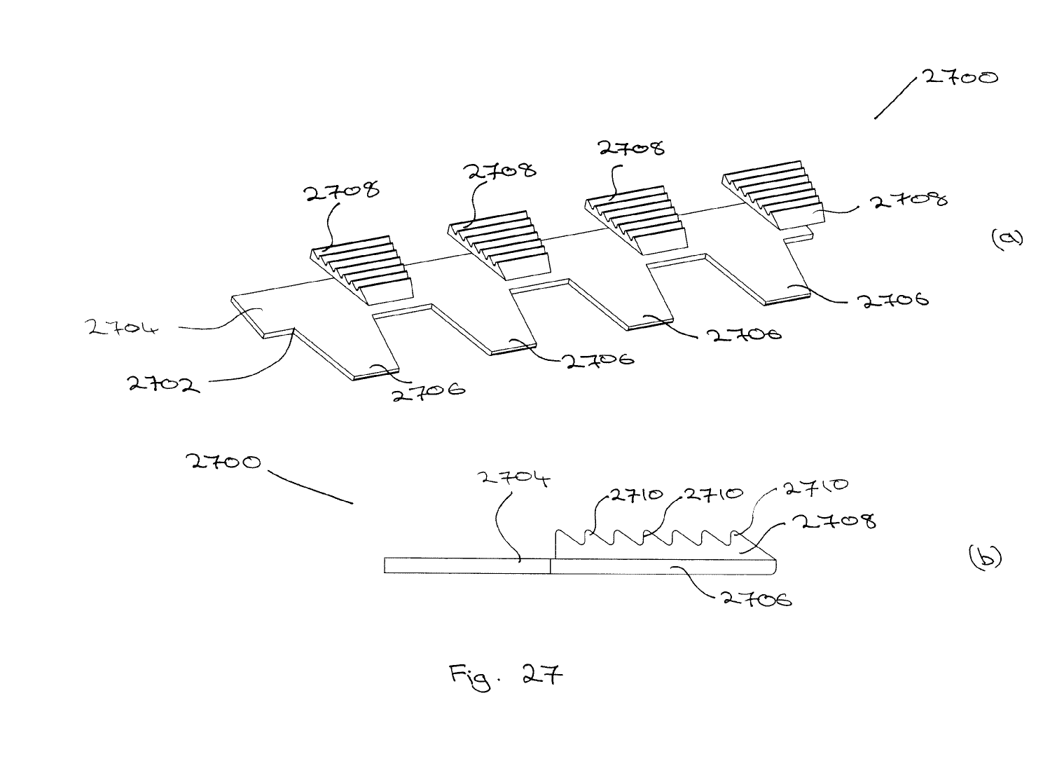

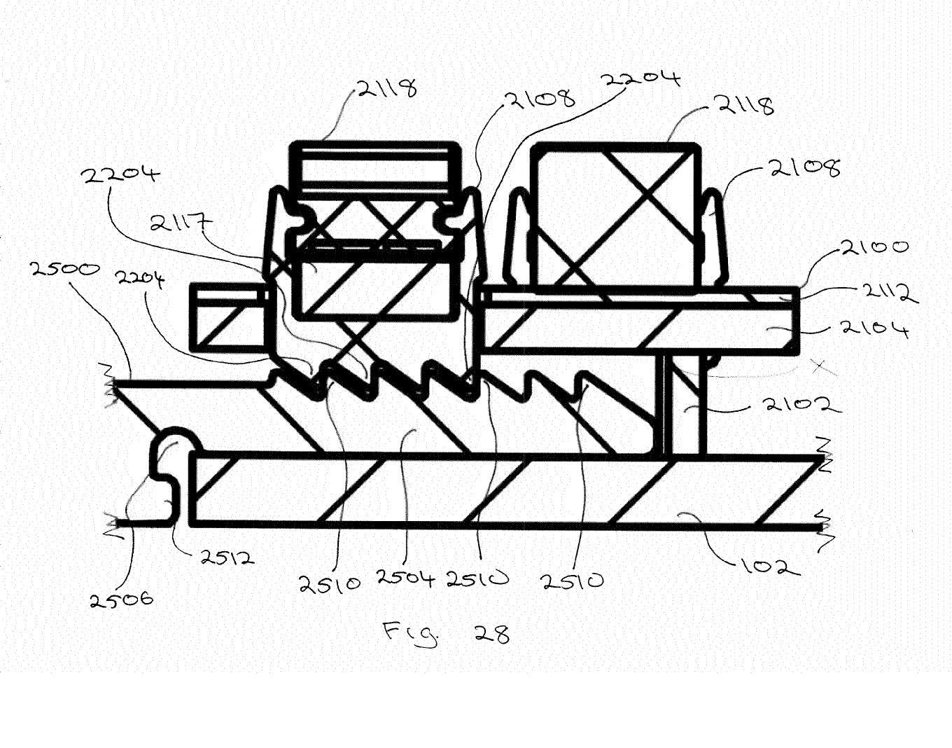

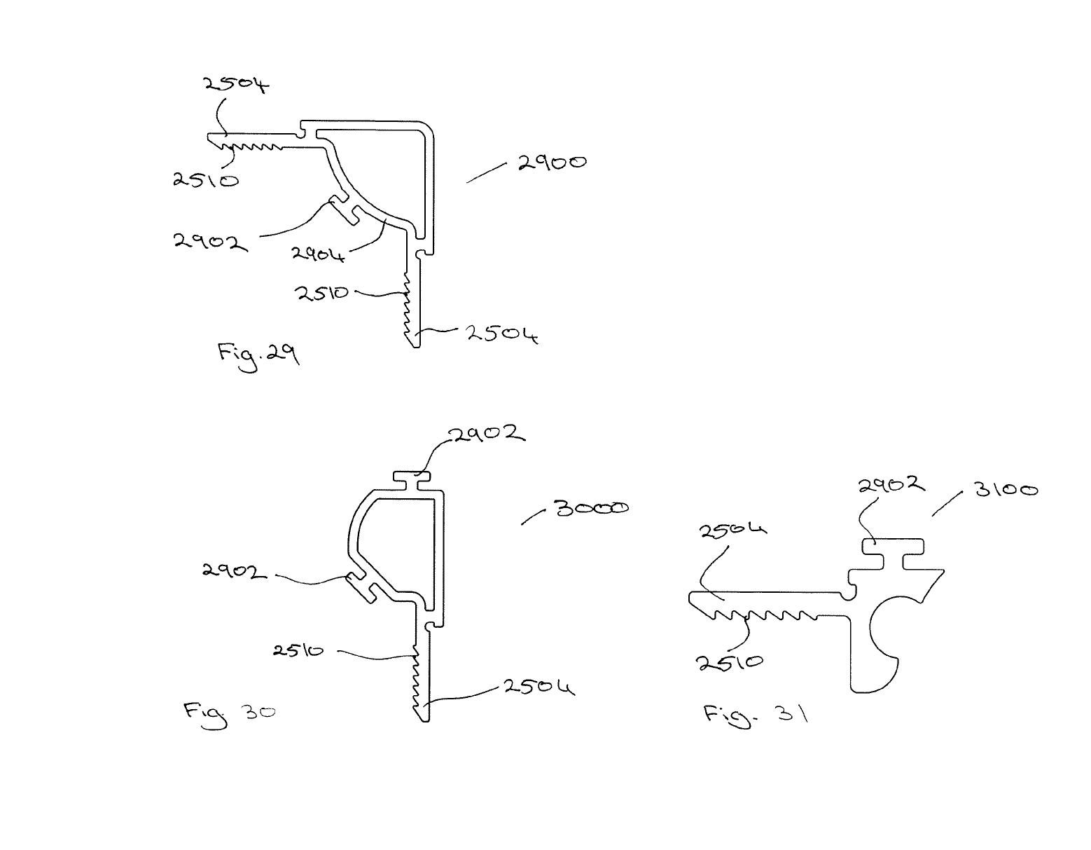

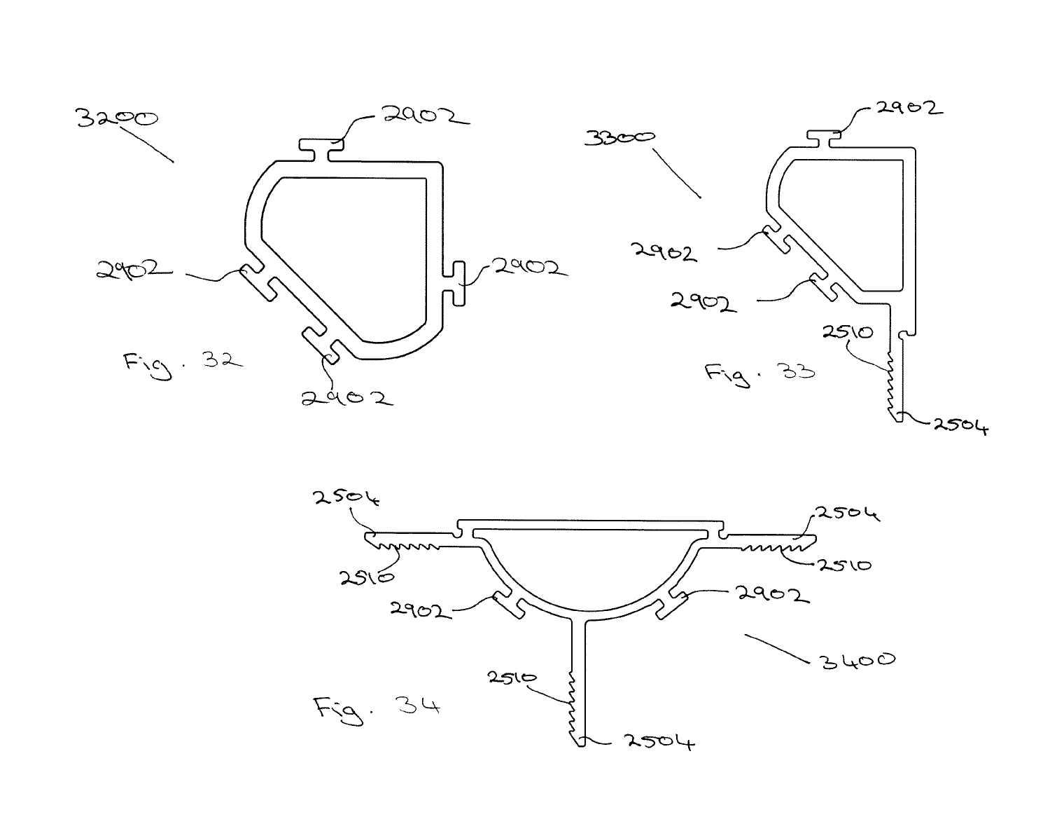

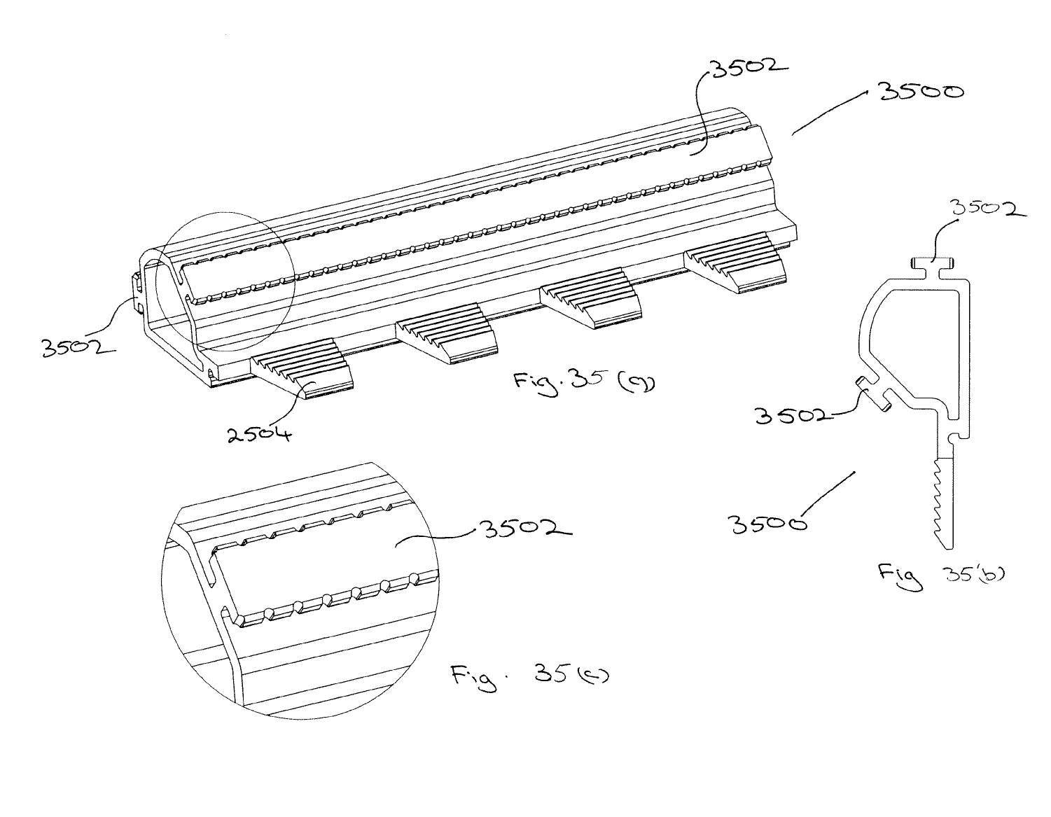

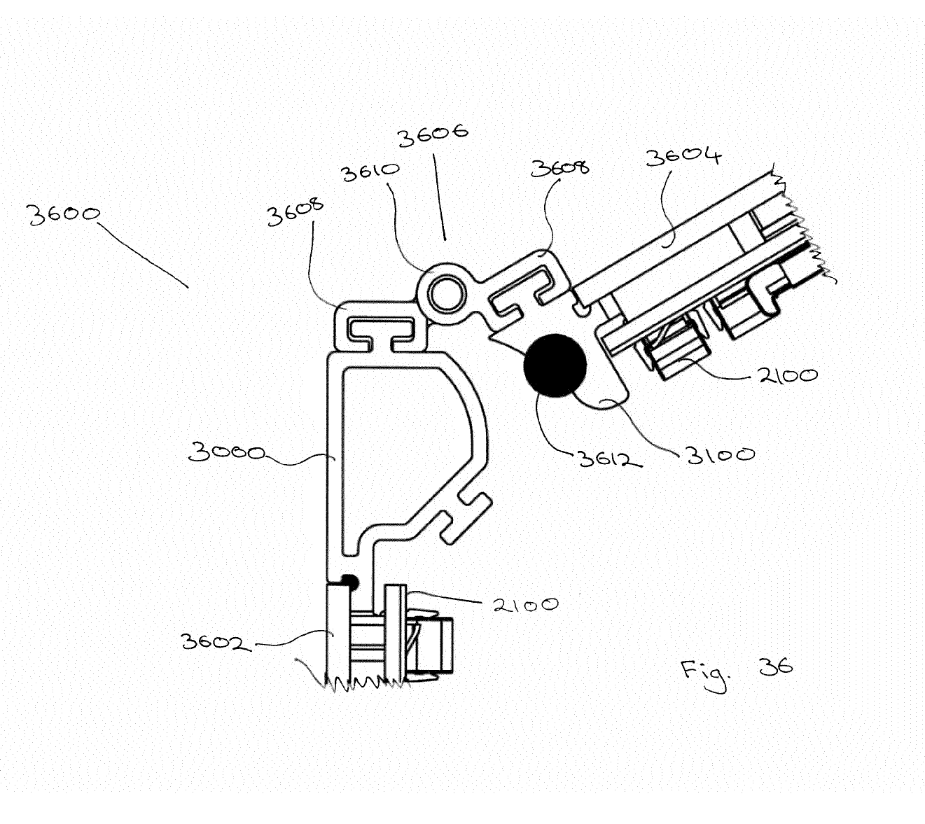

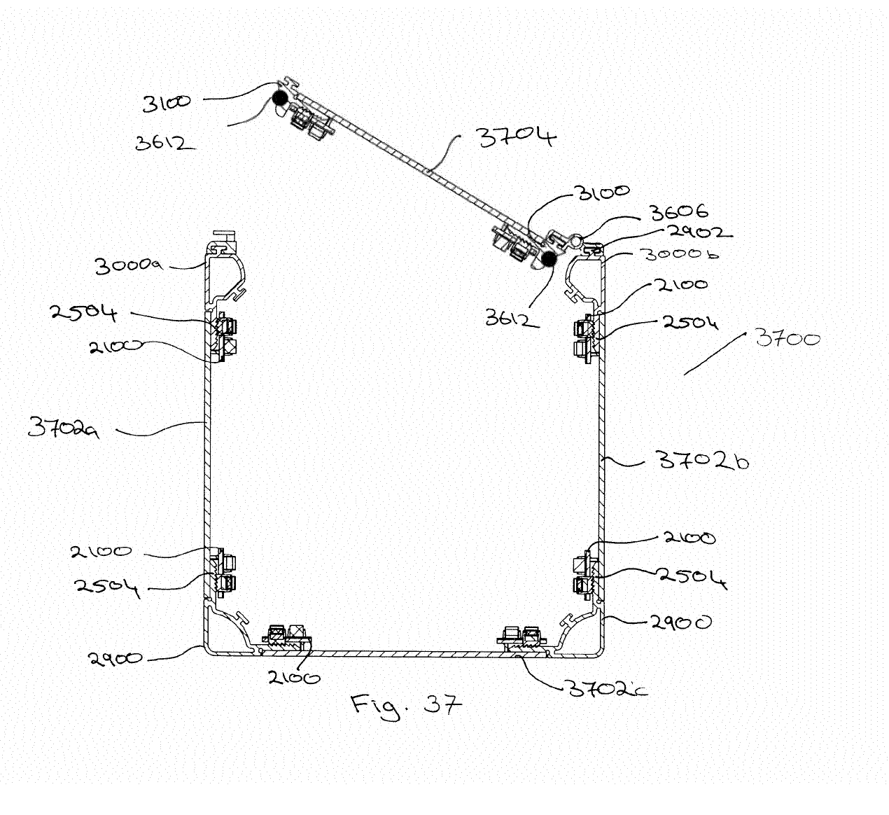

FIG. 3(a) is a side view of a the projecting finger of male connector for use in the invention;

FIG. 3(b) is a side view of the male connector of FIG. 3(a) showing angles of taper;

FIGS. 4(a), (b), (c) and (d) are end, cross-section, isometric and perspective views of the right-angled joining brackets shown in FIG. 1;

FIG. 5 is an end view of a four-way joining bracket;

FIG. 6 is an end view of a three-way joining bracket;

FIG. 7 is an end view of a straight joining bracket;

FIG. 8 is an end view of a single door jamb joining bracket;

FIG. 9 is a cross-section view of a double door jamb joining bracket;

FIG. 10 is an end view of a door seal joining bracket;

FIG. 11 is a cross-section view of a terminating compact joining bracket;

FIG. 12 is a cross-section view of a four-way compact joining bracket;

FIG. 13 is a cross-section view of a T-shaped compact joining bracket;

FIG. 14 is a cross-section of a right angle compact joining bracket;

FIG. 15(a) is a perspective view of a DIN rail mounting bracket and DIN rail;

FIG. 15(b) is perspective view of a DIN rail mounting bracket;

FIG. 15(c) is the profile of a G-type DIN rail;

FIG. 16(a) is a perspective view of an alternative DIN rail mounting joining bracket and DIN rail;

FIGS. 16(b), (c), (d) and (e) are front perspective, rear perspective, side and front views respectively of the alternative DIN rail mounting joining bracket shown in FIG. 16(a);

FIG. 17(a), (b) and (c) are perspective views of Z-shaped, C-shaped and L-shaped mounting joining brackets respectively;

FIGS. 18(a) and (b) are perspective and side views of a back plate mounting bracket for use in an assembly according to the invention;

FIG. 19 is a perspective view of an assembly according to the invention;

FIG. 20 is a perspective view of a grounding panel component;

FIG. 21(a) is an exploded perspective view of the sliding sawtooth female connector assembly;

FIG. 21(b) is a perspective view of the sliding sawtooth female connector assembly without the release slider;

FIG. 21(c) is an end view of the sliding sawtooth female connector assembly without the release slider;

FIG. 21(d) is a perspective view of the sliding sawtooth female connector assembly with the release slider;

FIG. 21(c) is an end view of the sliding sawtooth female connector assembly with the release slider;

FIGS. 22(a), (b) and (c) are end, left perspective and right perspective views respectively of the sawtooth locking block;

FIGS. 23(a), (b) and (c) are end, left perspective and right perspective views respectively of the sawtooth locking block with spring insert;

FIGS. 24(a) and (b) are perspective views of a portion of the sliding sawtooth female connector assembly in a locked and unlocked position respectively;

FIGS. 24(c) and (d) are side views of a portion of the sliding sawtooth female connector assembly in a locked and unlocked position respectively;

FIGS. 25(a) and (b) are perspective and end views respectively of a male connector assembly for use with the female connector assembly shown in FIGS. 22, 23 and 24;

FIG. 25(c) is an end view of the male connector assembly shown in FIG. 25(a) and (b) further comprising a flange partially covering an O-ring recess;

FIGS. 26(a) and (b) are perspective and end views respectively of an alternative embodiment of male connector assembly for use with the female connector assembly shown in FIGS. 22, 23 and 24;

FIG. 26(c) is an end view of the male connector assembly shown in FIG. 26(a) and (b) further comprising a flange partially covering an O-ring recess;

FIGS. 27(a) and (b) are exploded perspective and side views respectively of a further embodiment of male connector assembly;

FIG. 28 is a cross-section view of the engagement between the top-hat female connector assembly shown in FIG. 21 and the male connector assembly shown in FIGS. 25 and 26;

FIG. 29 is an end view of a right angle joining bracket comprising the male connector assembly of FIG. 25;

FIG. 30 is an end view of a single door jamb joining bracket comprising the male connector assembly of FIG. 25;

FIG. 31 is an end view of a door seal joining bracket comprising the male connector assembly of FIG. 25;

FIG. 32 is an end view of an accessory bracket;

FIG. 33 is an end view of a large door jamb joining bracket comprising the male connector assembly of FIG. 25;

FIG. 34 is an end view of a three-way joining bracket comprising the male connector assembly of FIG. 25;

FIGS. 35(a) and (b) are perspective and end views of a further embodiment of single door jamb joining bracket comprising a knurled T-shaped mounting rail;

FIG. 36 is a top view of a portion of an exemplary assembly according to the invention;

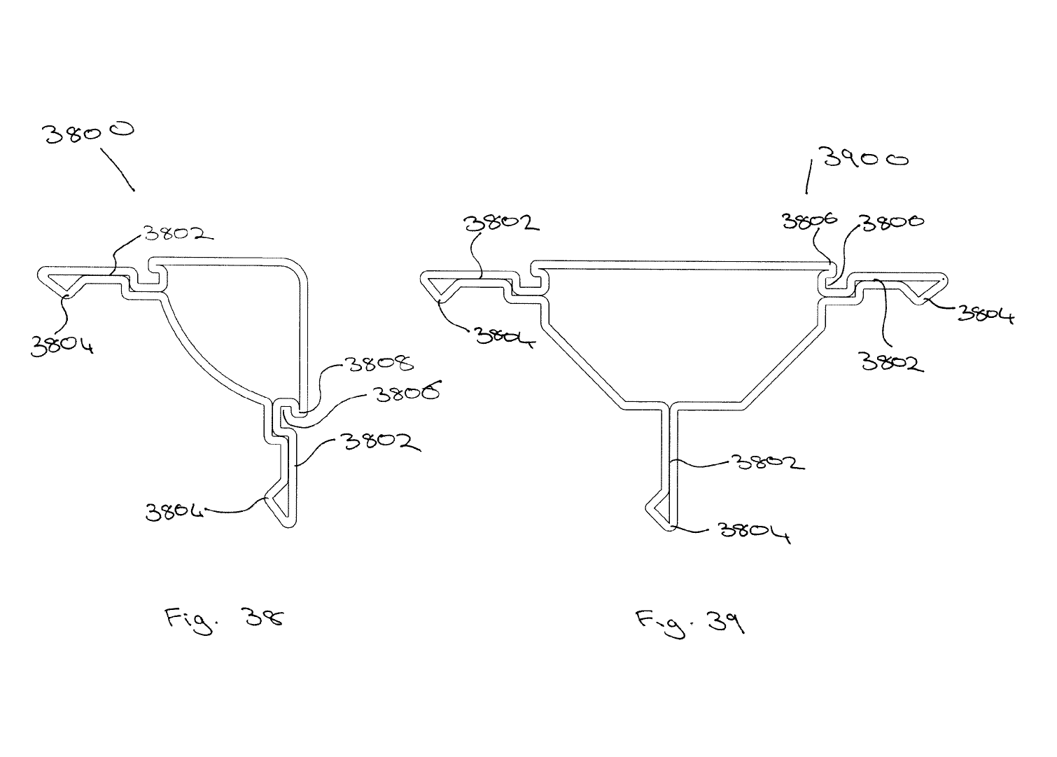

FIG. 37 is a top view of a cross-section of a square box assembly formed according to the invention;

FIG. 38 is a roll-formed right angle joining bracket;

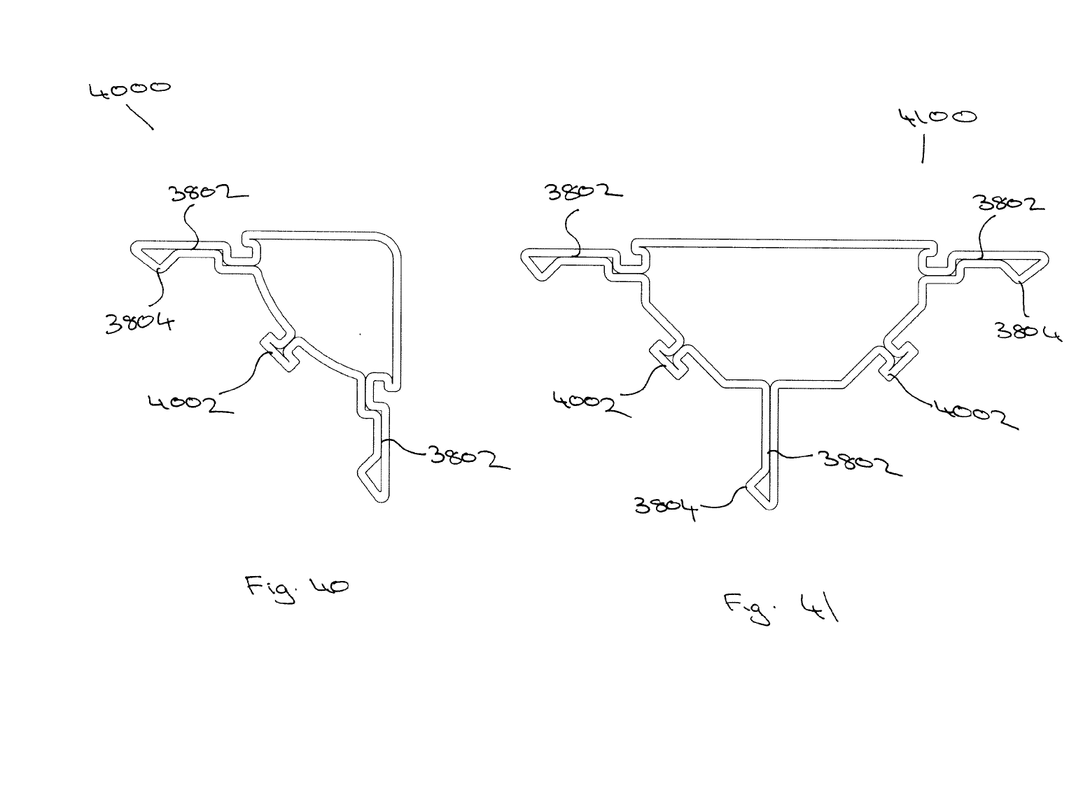

FIG. 39 is a roll formed three-way joining bracket;

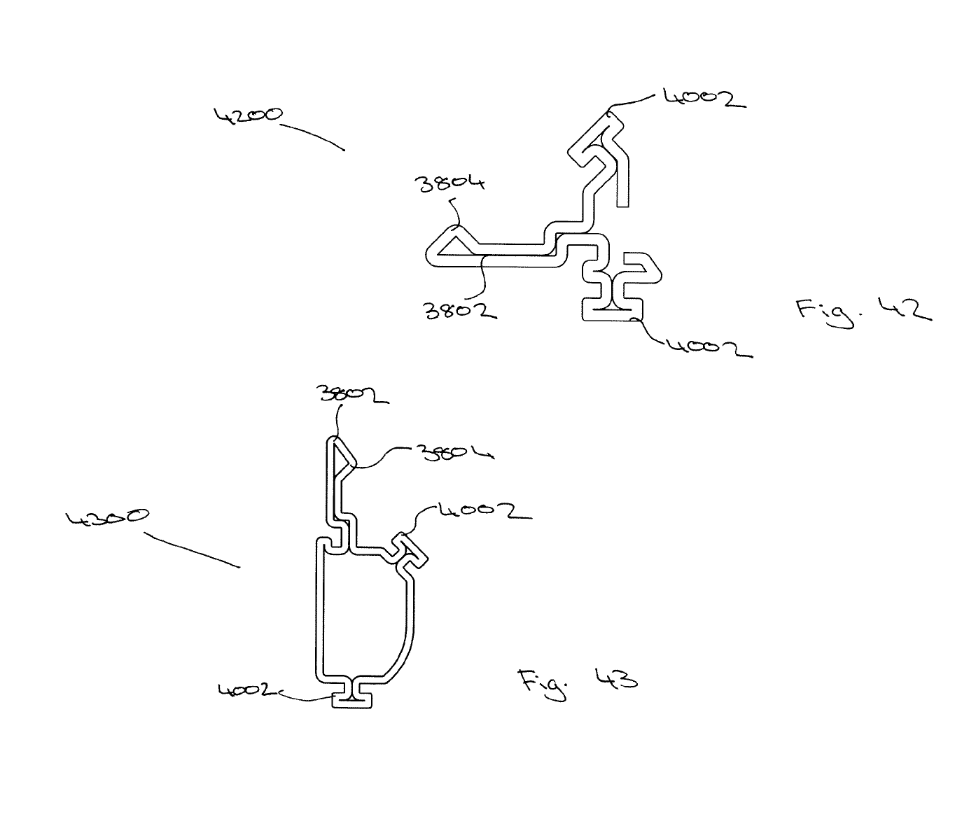

FIG. 40 is a roll formed right angle joining bracket including a roll formed T-shaped mounting rail;

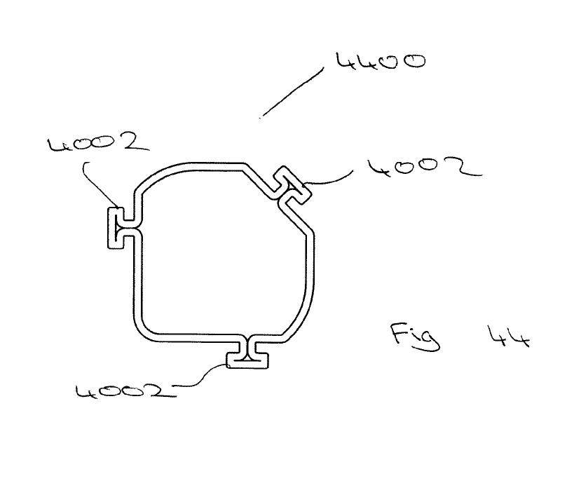

FIG. 41 is a roll formed three-way joining bracket including roll formed T-shaped mounting rails;

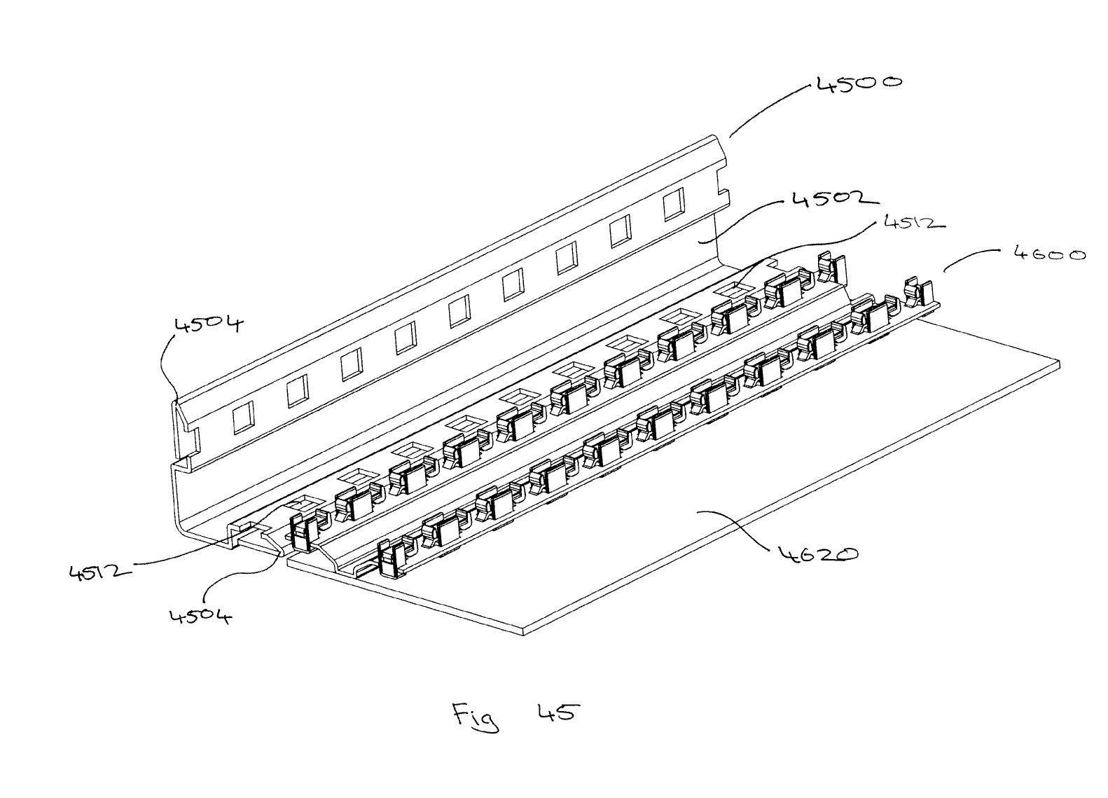

FIG. 42 is a roll formed door seal joining bracket incorporating a roll formed T-shaped mounting rail;

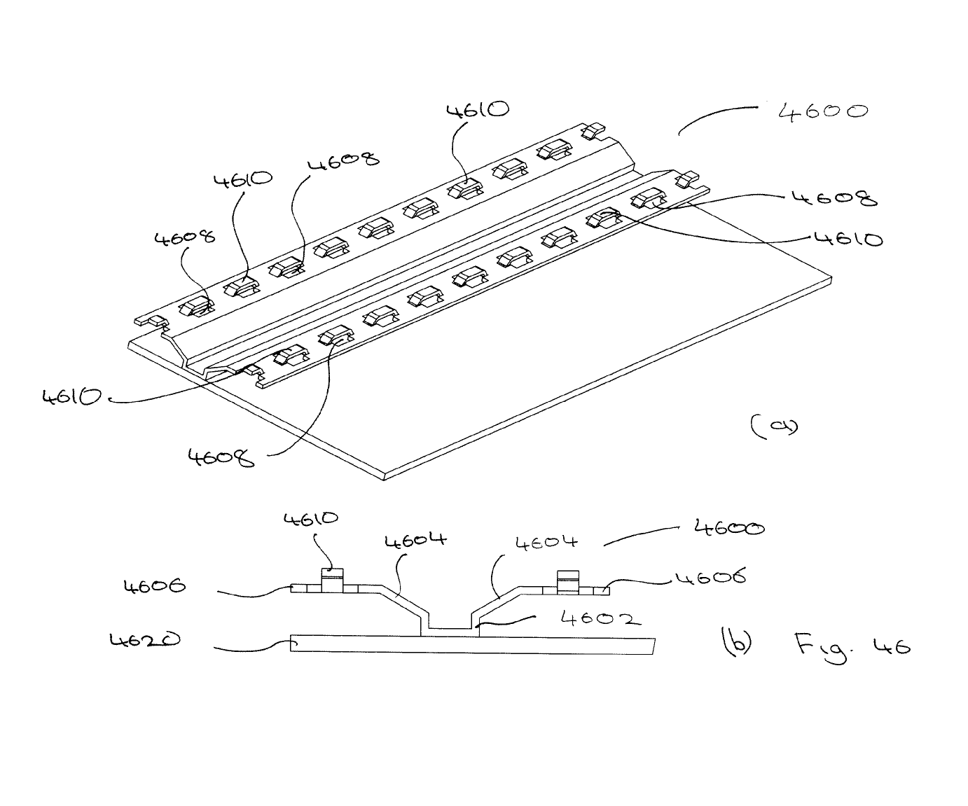

FIG. 43 is a roll formed door jamb joining bracket incorporating roll formed T-shaped mounting rails;

FIG. 44 is a roll formed accessory bracket;

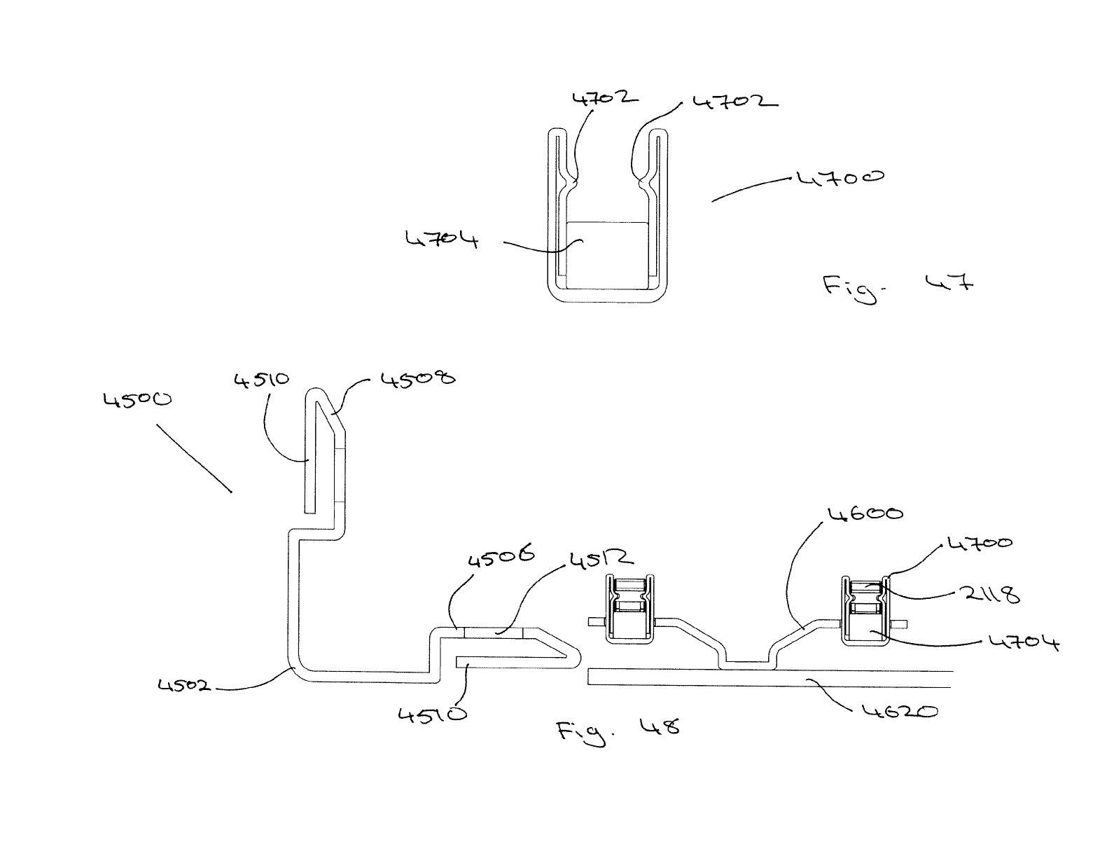

FIG. 45 is a perspective view of a further embodiment of right angle joining bracket incorporating a male connector assembly and a panel having a complementary female connector assembly affixed thereto;

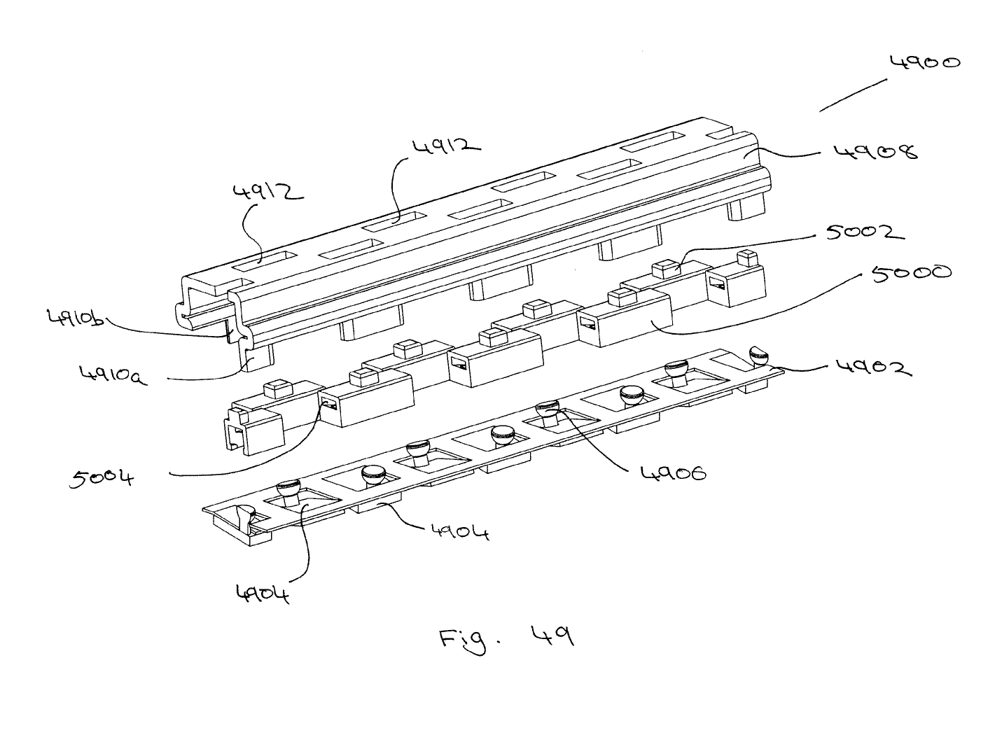

FIGS. 46(a) and (b) are perspective and end views respectively of the panel and a portion of the female connector assembly shown in FIG. 45;

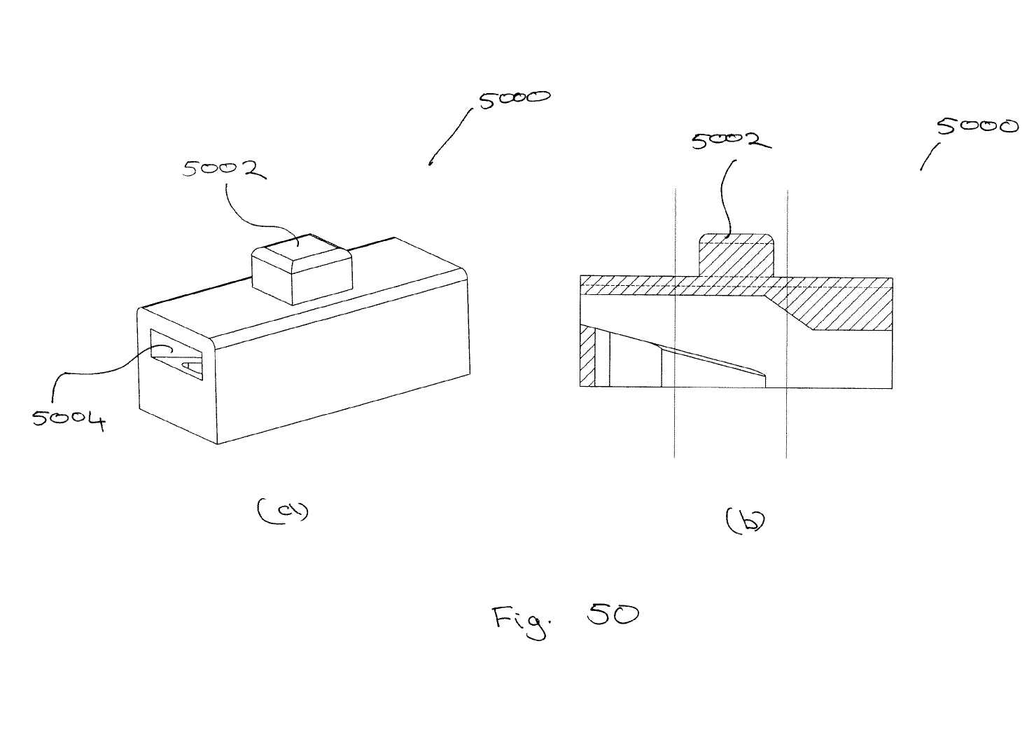

FIG. 47 is an end view of a locking block for use in the female connector assembly of FIG. 45;

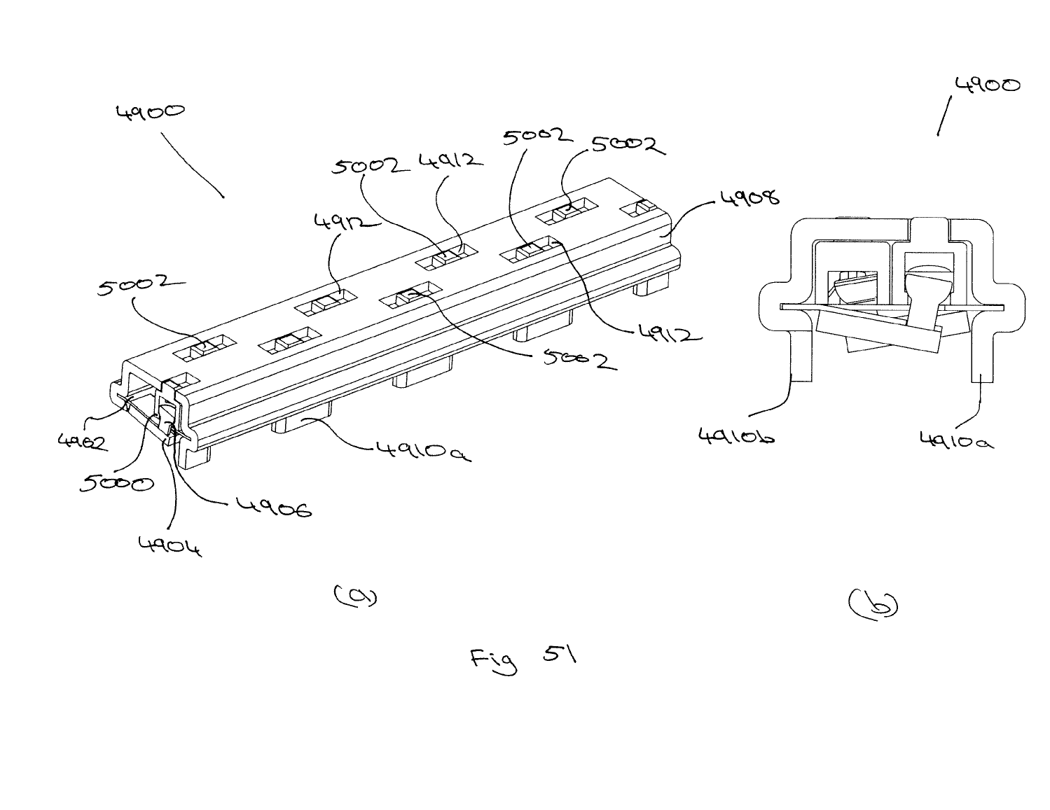

FIG. 48 is an end view of the components shown in FIG. 45;

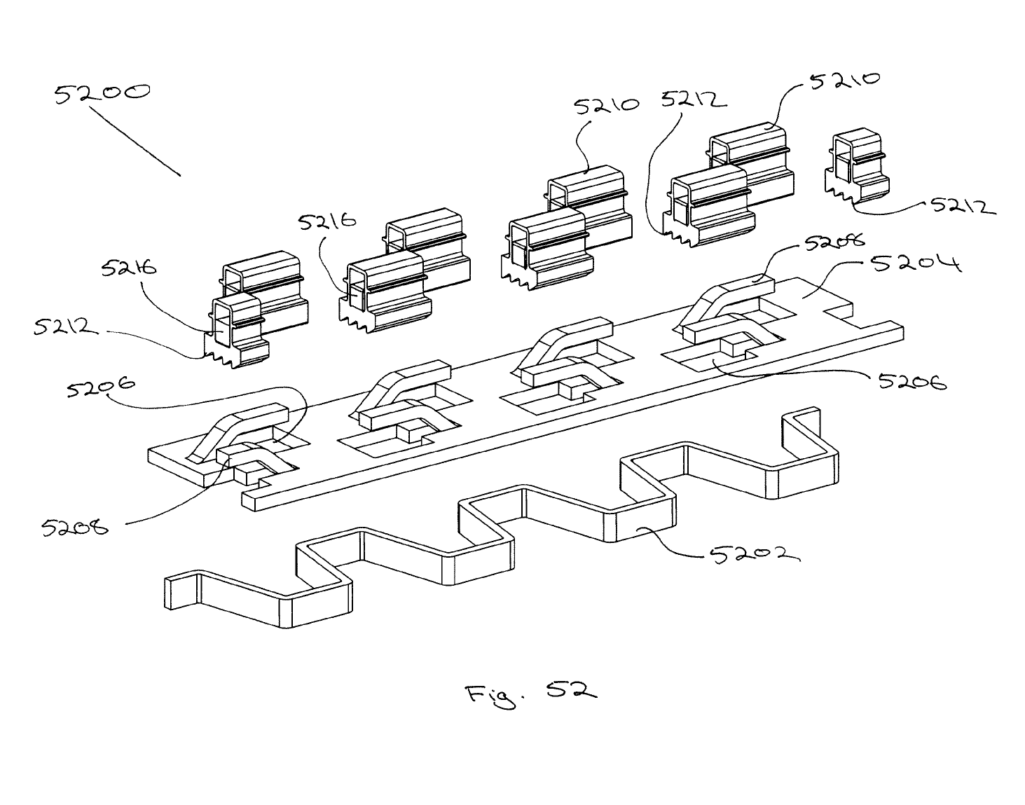

FIG. 49 is an exploded perspective view of a further embodiment of female connector assembly;

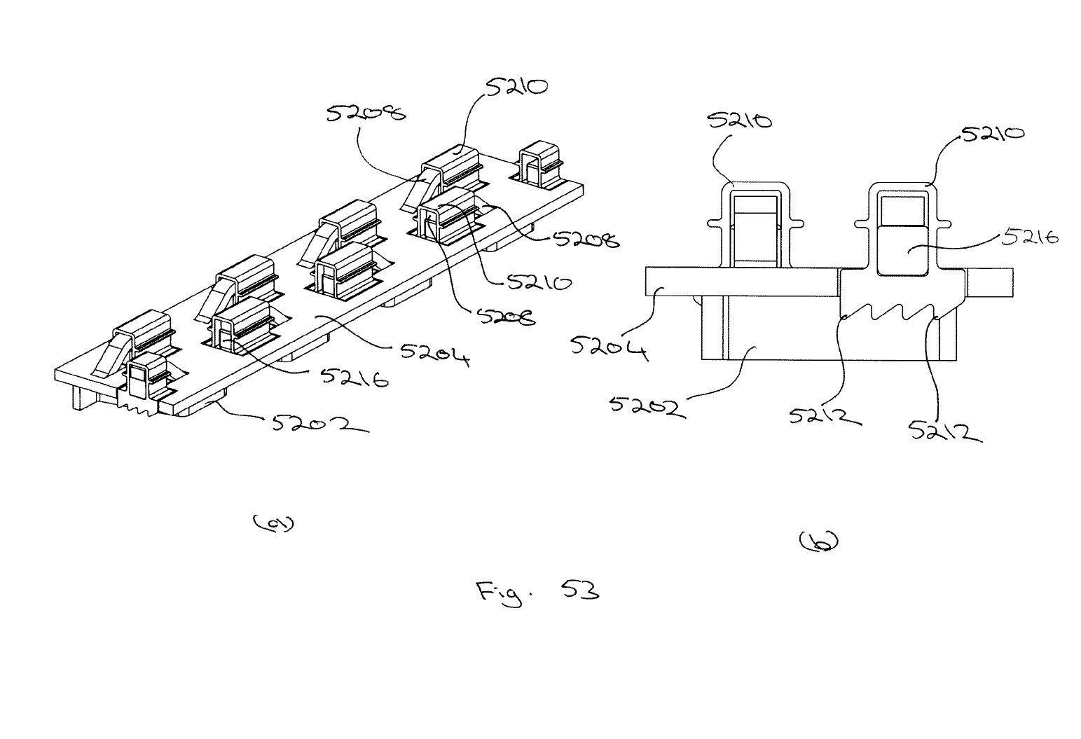

FIGS. 50(a) and (b) are perspective and side cross section views respectively of a release block for use with the female connector assembly of FIG. 49;

FIGS. 51(a) and (b) are perspective and end views respectively of the assembled female connector assembly of FIG. 49;

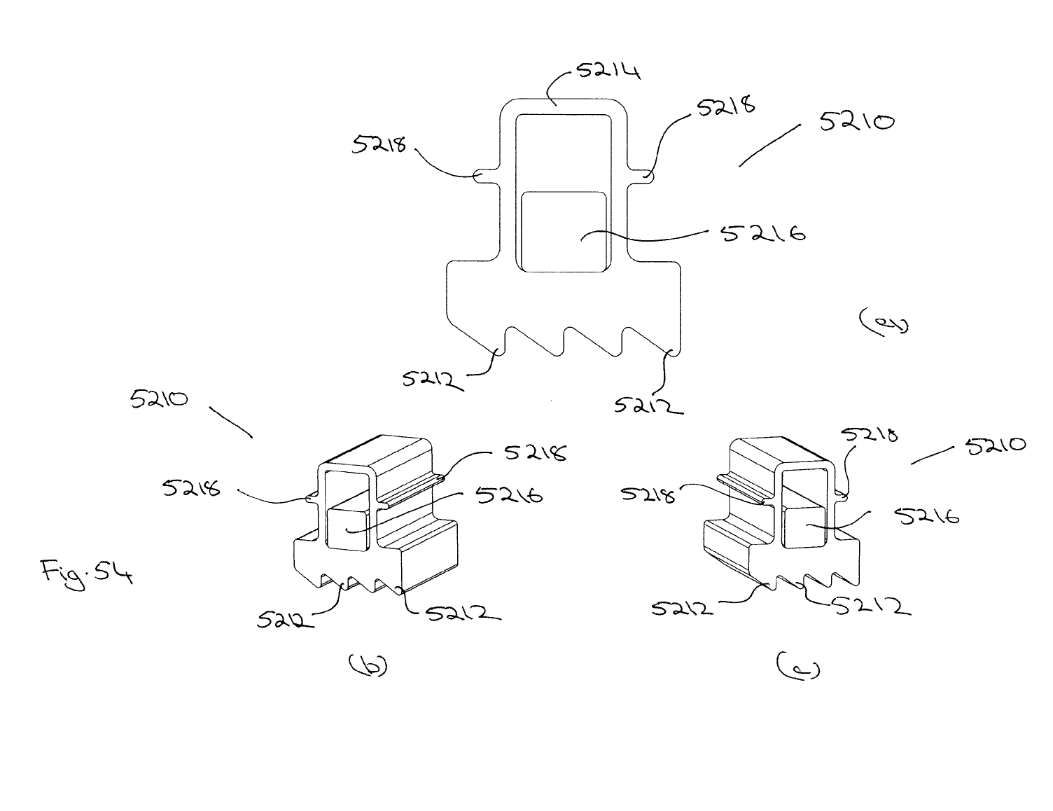

FIG. 52 is an exploded perspective view of a further embodiment of female connector assembly for use within assemblies according to the invention;

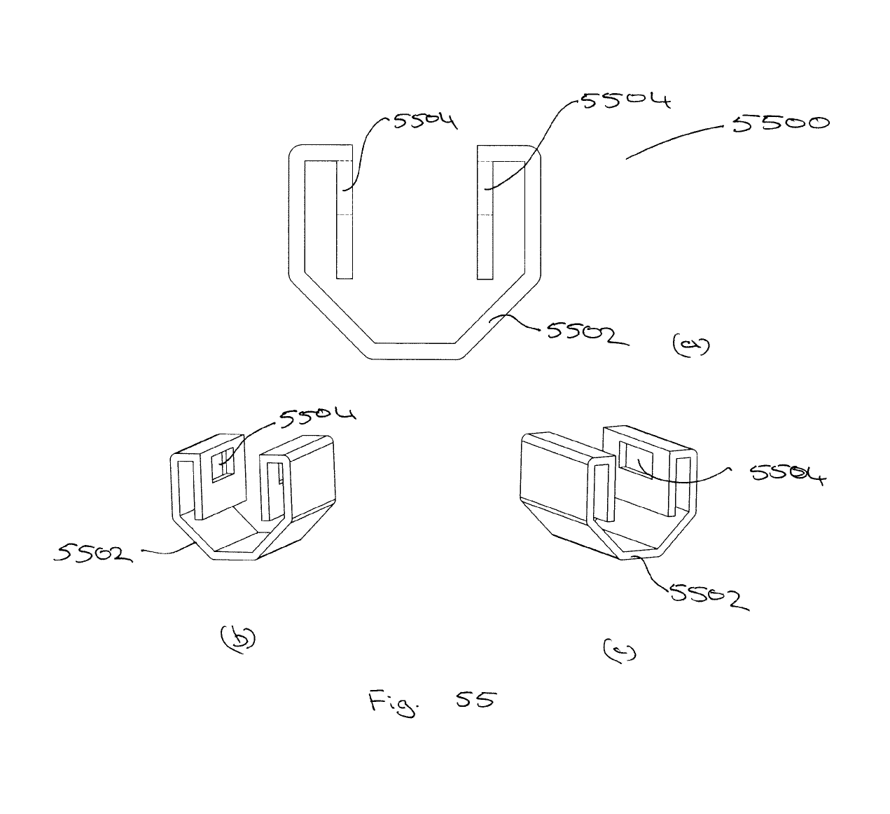

FIGS. 53(a) and (b) are perspective and end views respectively of the female connector assembly shown in FIG. 52;

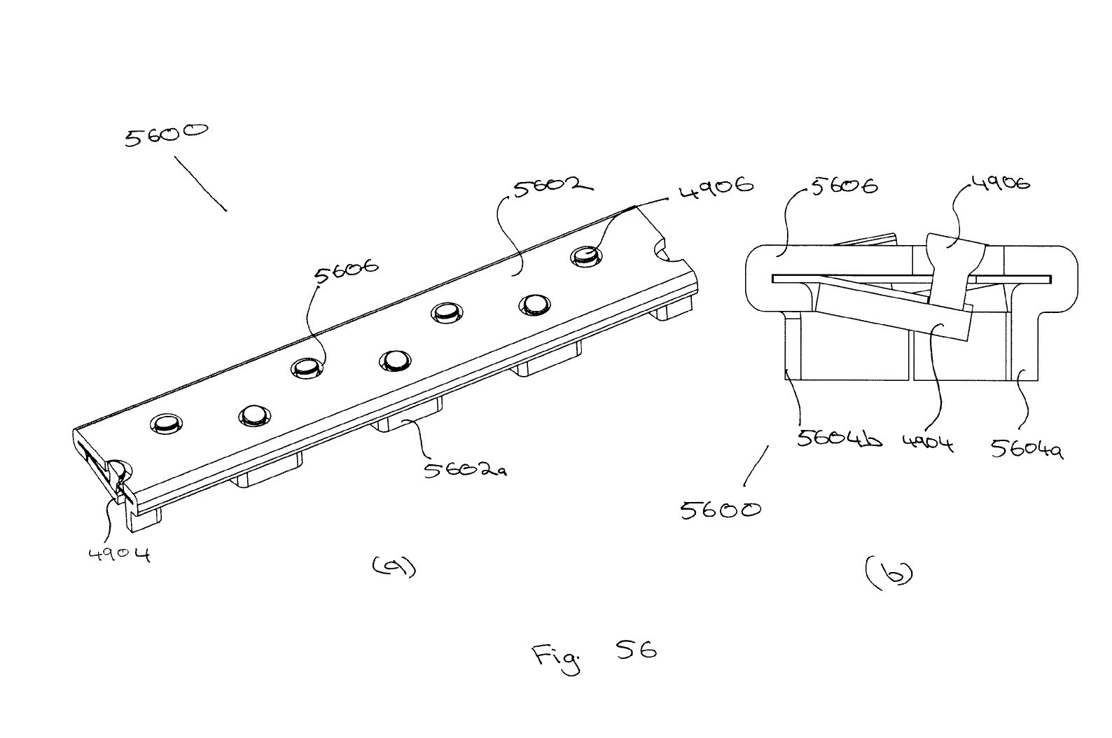

FIGS. 54(a), (b) and (c) are end and perspective views respectively of the locking block for use in the female connector assembly shown in FIGS. 52 and 53;

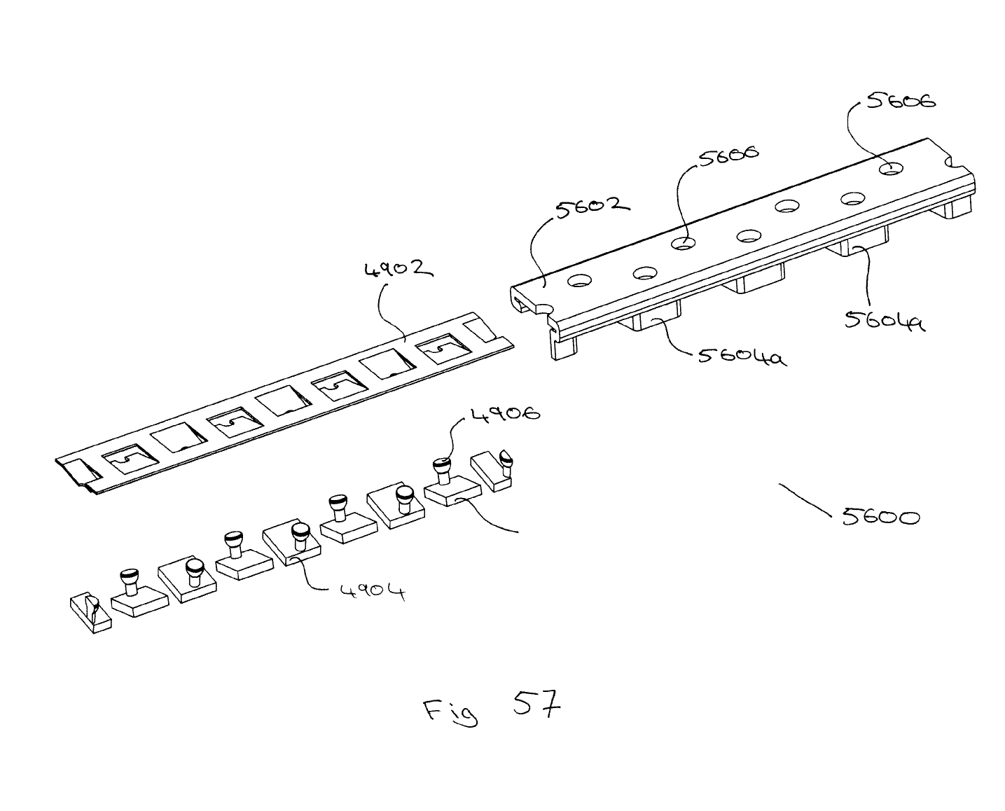

FIGS. 55(a), (b) and (c) are end and perspective views respectively of a locking block for use in the female connector assembly shown in FIGS. 45 and 48;

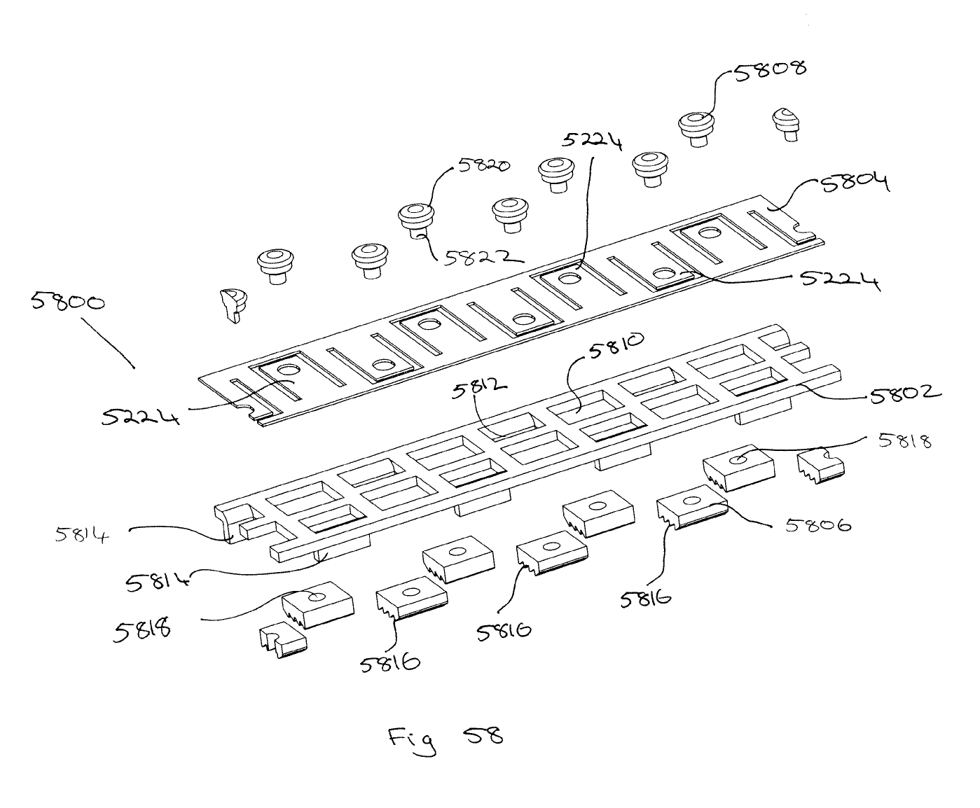

FIGS. 56(a) and (b) are perspective and end views respectively of a further example of a female connector assembly for use in assemblies according to the invention;

FIG. 57 is a perspective exploded view of the female connector assembly shown in FIG. 56;

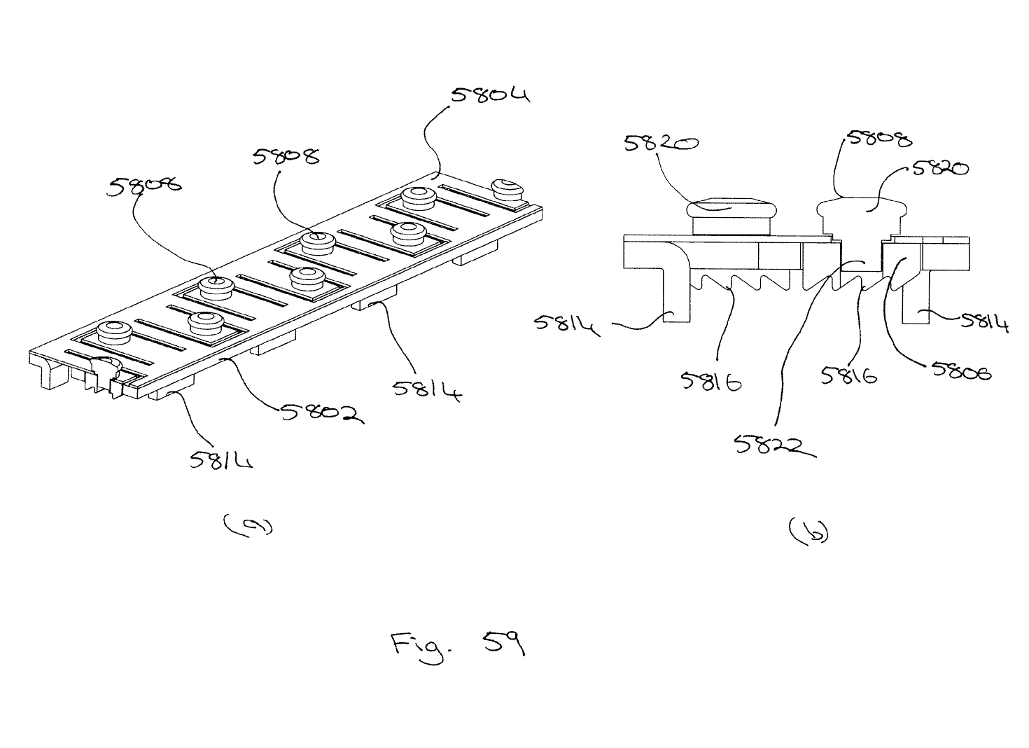

FIG. 58 is an exploded perspective view of another example of a female connector assembly for use in assemblies according to the invention;

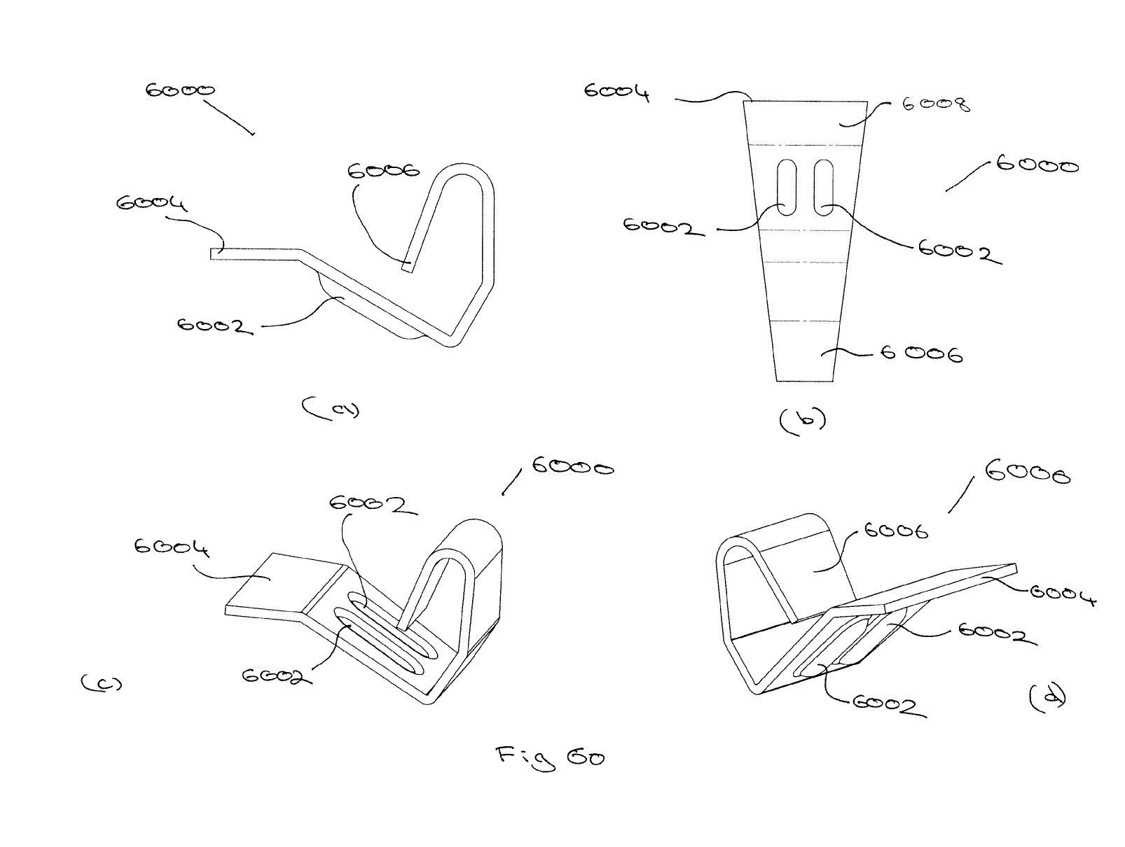

FIGS. 59(a) and (b) are perspective and end views respectively of the female connector assembly shown in FIG. 58;

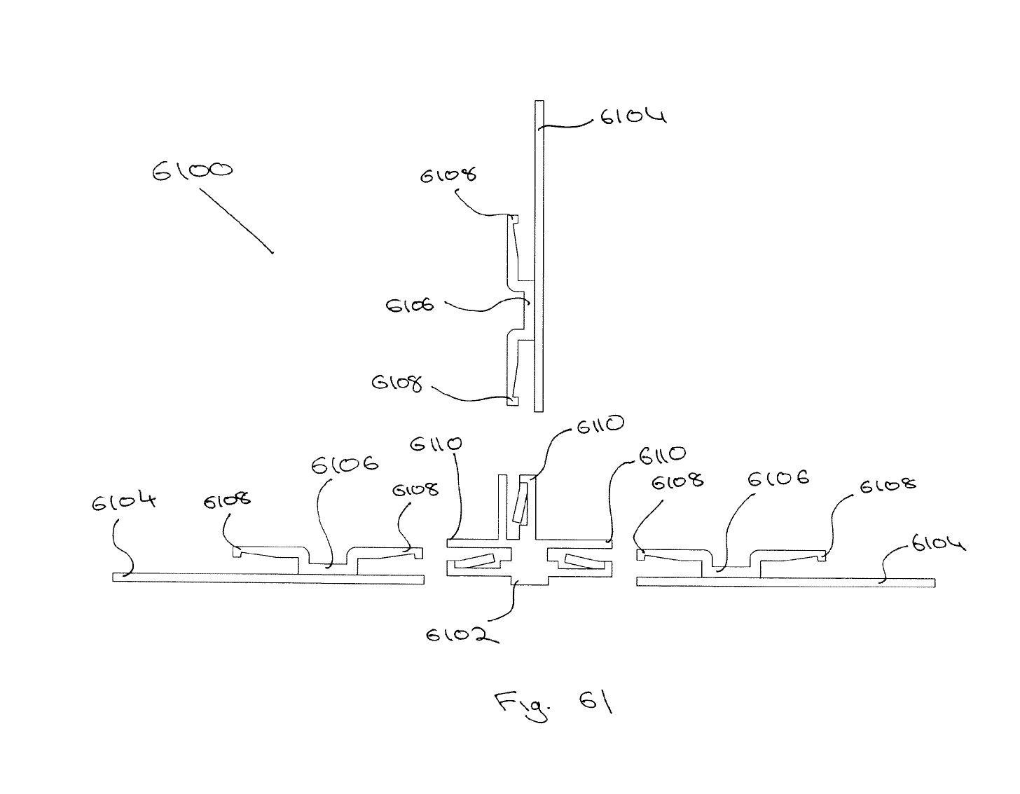

FIGS. 60 are side, flat pattern, and perspective views respectively of an alternative embodiment of flap for use with the top-hat female connector assembly shown in FIG. 2;

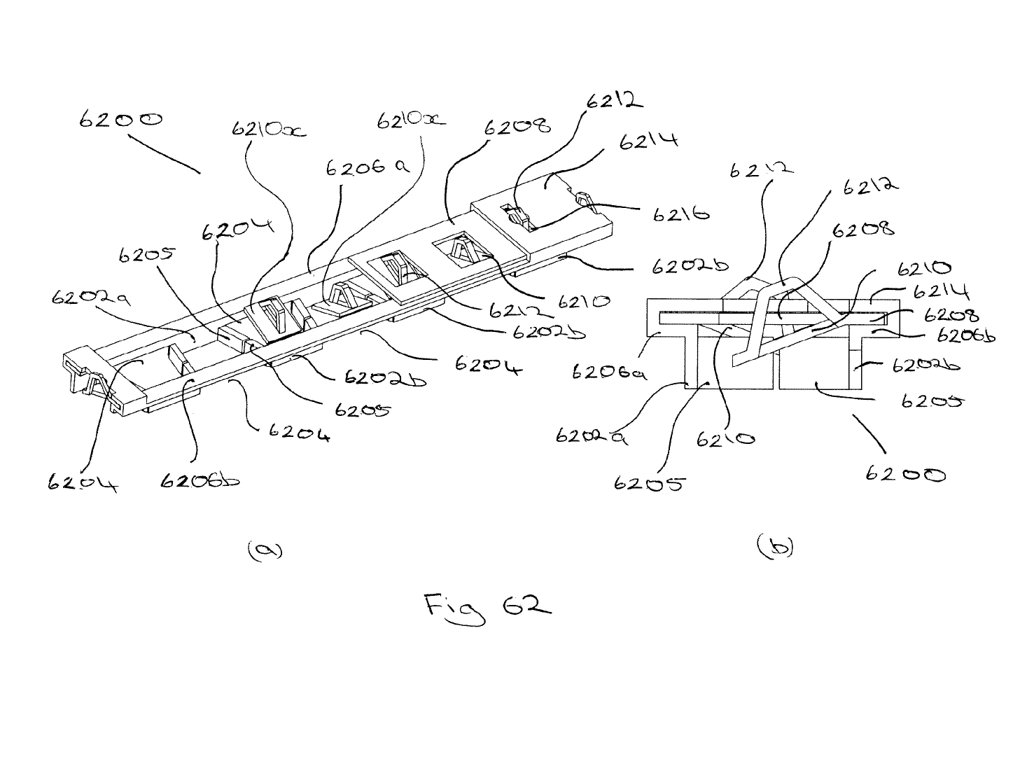

FIG. 61 is a top view of an exemplary assembly comprising a joining bracket having a female connector assembly and a structural component comprising a male connector assembly;

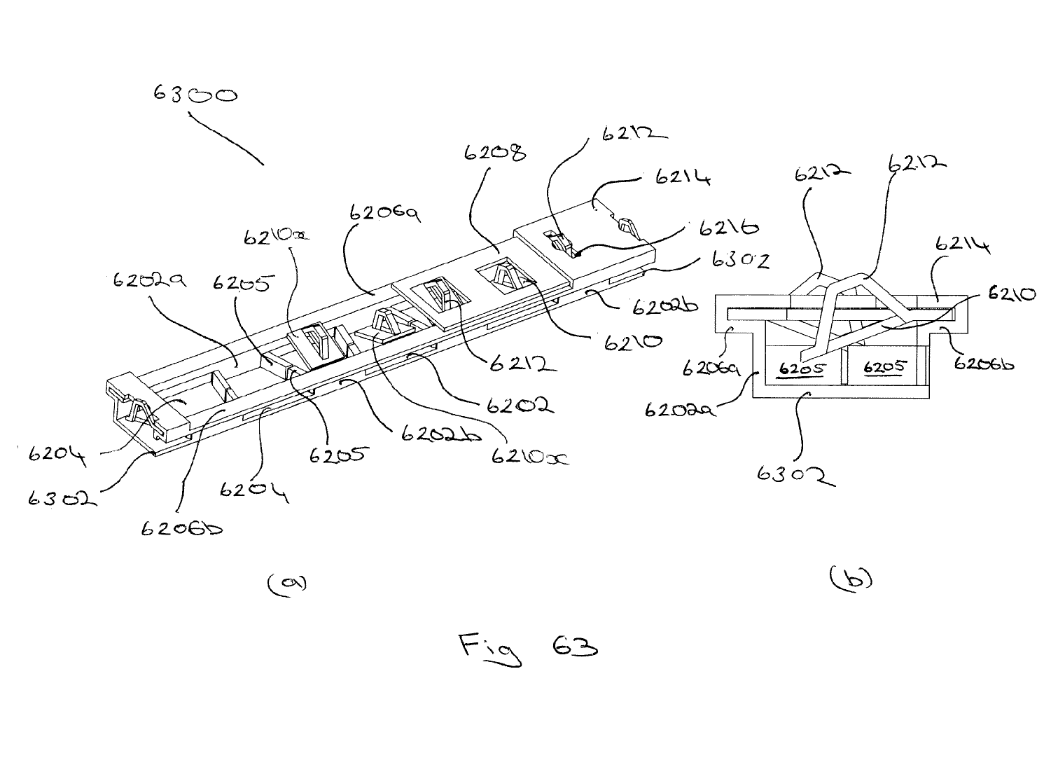

FIG. 62(a) is a partially cut-away perspective view of a releasable sheet;

FIG. 62(b) is an end view of the releasable sheet shown in FIG. 24(a);

FIG. 63(a) is a partially cut-away perspective view of an alternative embodiment of releasable sheet;

FIG. 63(b) is an end view of the alternative embodiment of releasable sheet shown in FIG. 25(a);

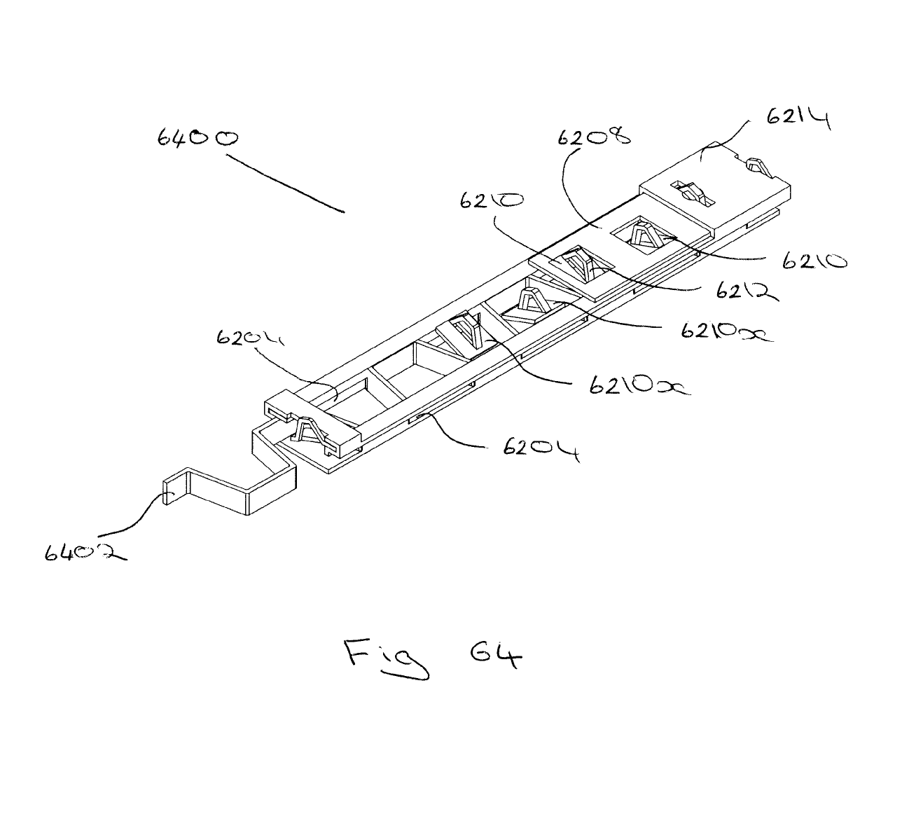

FIG. 64 is a partially cut-away perspective view of a further embodiment of releasable sheet;

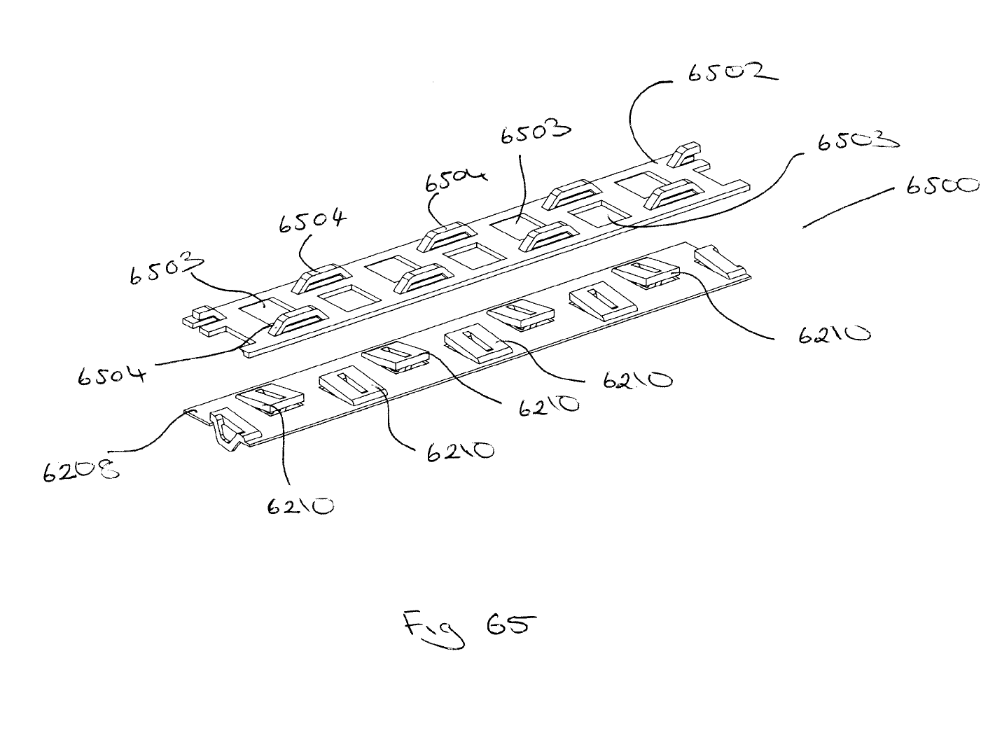

FIG. 65 is an exploded perspective view of a releasable sheet assembly;

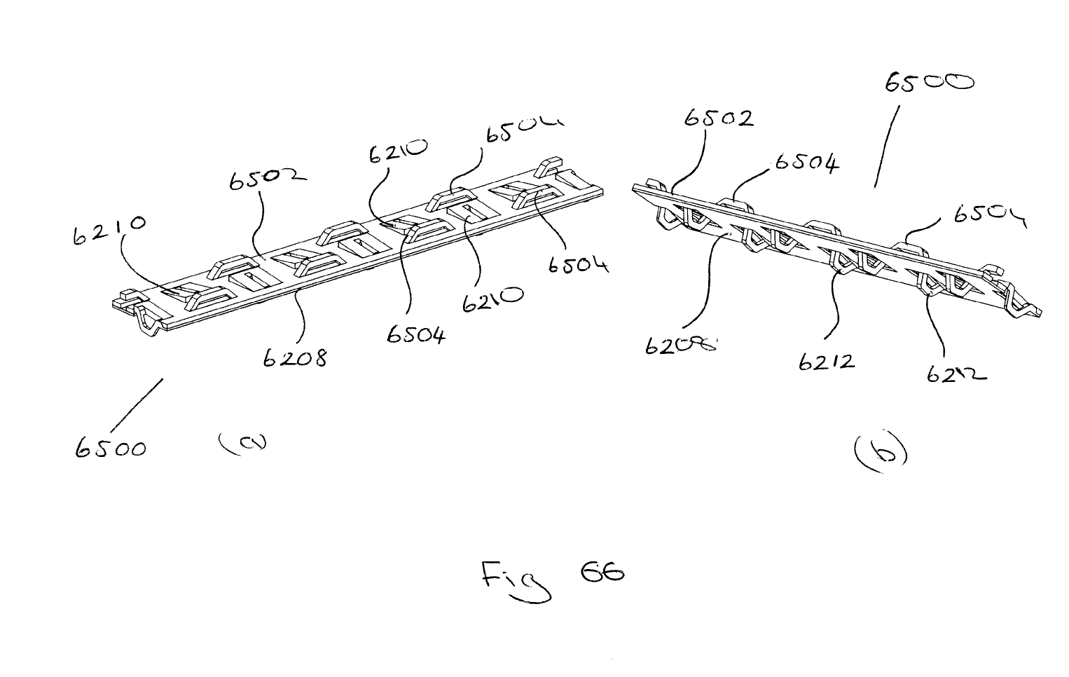

FIGS. 66(a) and (b) are top and bottom perspective views respectively of the releasable sheet assembly of FIG. 65;

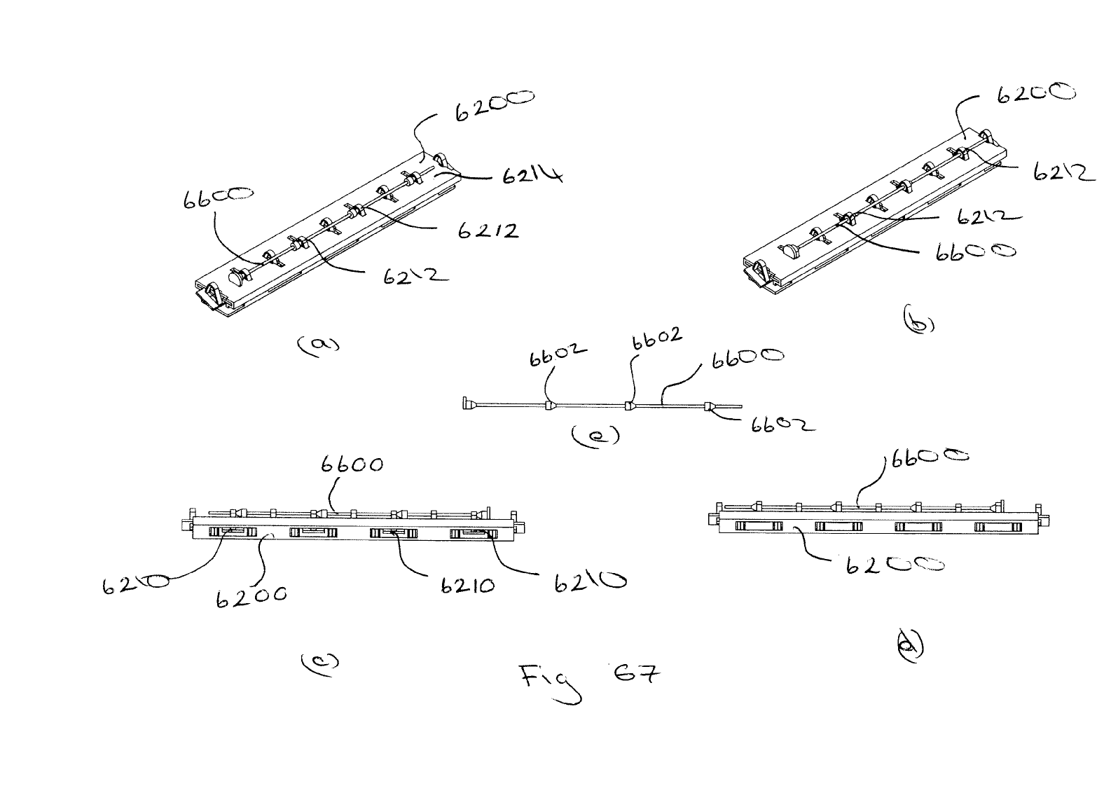

FIGS. 67(a) and (b) are perspective and front views respectively of a releasable sheet with a release wand in a disengaged position;

FIGS. 67(c) and (d) are perspective and front views respectively of the releasable sheet shown in FIGS. 67(a) and (b) with a release wand in the engaged position;

FIG. 67(e) is a front view of the release wand; and

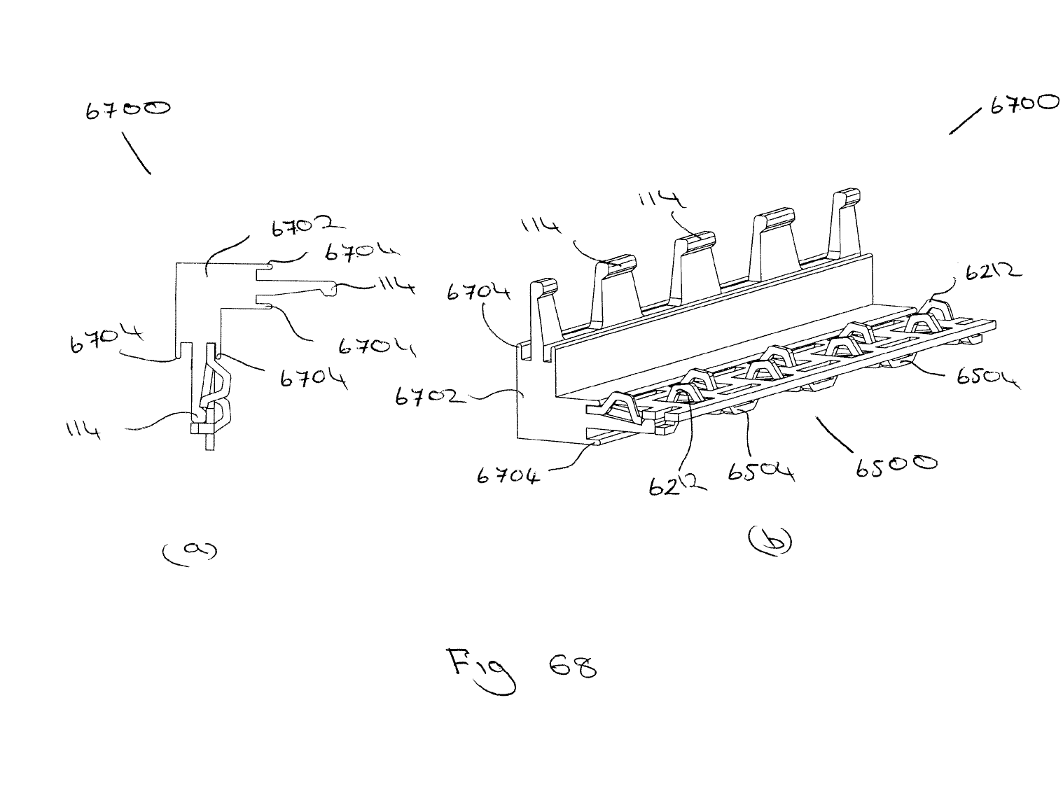

FIGS. 68(a) and (b) are side and perspective views of an L-shaped bracket in engagement with a releasable sheet as shown in FIG. 65.

Referring to the drawings, and initially to FIG. 1 thereof, there is shown an exploded assembly indicated generally by the reference numeral 100. The assembly 100 comprises three components types—structural components in the form of three panels 102a, 102b, 102c that will form the base and two adjoining sides of the assembly 100; joining brackets in the forms of three right-angled joining brackets 104a, 104b, 104c; and corner brackets in the form of three tri-corner corner brackets 106a, 106b, 106c.

Each panel 102 has a female connector assembly 108 disposed along each edge of one face thereof. Each female connector assembly 108 comprise an opposed pair of sets of female connectors, wherein each female connector 110 comprises a recess. The sets of female connectors 110 are formed by a plurality of female connectors in the same orientation. One of the sets has female connectors 110 opening outwardly at the edge of the panel 102 and the second set is opposed to the first set such that the female connectors 110 face inwardly toward the opposite edge of the panel 102. An earthing pin 111 is located at each corner of the panel 102.

The right-angled joining brackets 104 comprise a quadrant of a cylinder, having two straight sides at right angles to each other, and an arcuate surface joining them. A set of spaced-apart male connectors 112 extend from the end of each straight side. The width of the male connectors 112 narrows slightly as they extend from the body and have a bulbous head portion at their distal ends.

The corner brackets 106 comprise three mutually orthogonal quadrant shaped projections, adapted to fit into the ends of the right-angled joining brackets 104.

To form the assembly 100, the set of male connectors on the joining brackets are bought into engagement with the set of female connectors 110 on the outside edges of the panel. The corner brackets 106 are fitted into the ends of the joining brackets 104 so as to form a three sided assembly, each side being orthogonal to the other two.

It will be understood that the joining brackets and corner brackets form a frame for the assembly, these brackets may therefore be referred to as frame brackets or frame components.

It will be understood that the term structural component refers to components such as walls, floor, lids, covers, door and other panel-like components.

Referring now to FIGS. 2(a), (b), (c), (d), (e) and (f) in which like parts have been given the same reference numerals as before, there is shown an embodiment of a top-hat female connector assembly 200. The top-hat female connector assembly 200 comprises a baseplate 202, a top plate 204 and a plurality of locking clips 206, which locking clips 206 are comprised within a locking mechanism. There is one locking clip 206 for each female connector in the set comprised within the top-hat female connector 200. The baseplate 202 comprises a flat plate having a series of trapezial apertures 208 cut therefrom, each having a trapezial flap 210 extending from the base of the trapezial aperture 208. The baseplate 202 is formed from spring steel such that the trapezial flaps 210 act as hinges. The baseplate 202 is typically formed from stainless spring steel 304.

The top plate 204 comprises a pair of spaced-apart, parallel upright walls 220a, 220b. Each wall 220a, 220b comprises spaced-apart recesses 222, with the recesses 222 on one wall 220 being staggered in relation to the recesses 222 on the opposing wall 220. The recesses 222 are formed by breaks in the walls 220.

Each of the walls 220a, 220b have a flange 224a, 224b projecting outwardly and orthogonally from the top thereof. The top plate 204 further comprises side portions 226a, 226b extending upwardly and orthogonally from the flanges 224, and a cover portion 228 that extends between the side portions 226. This construction causes the cross-section of the top plate 204 to resemble the shape of a top hat. The cover portion 228 of the top plate 204 comprises a series of T-shaped through-holes 230, wherein the cross-bars of the Ts are in line with the side edge of the top plate 204 and the upright of the Ts are orthogonal to the side edge of the top plate 204. There is a T-shaped through-hole 230 for each recess 222 formed in the side walls, with the uprights of the Ts facing toward the recesses 222.

When the top-hat female connector assembly 200 is assembled, the baseplate 202 rests on top of the flanges 224a, 224b, such that its side edges abut the inside of the side portions 226. In this way, the edge portions of the base plate 202 are sandwiched between the flanges 224 and the cover portion 228 of the top plate 204.

The locking clips 206 comprise three portions—a base portion 240, an upright portion 242 and a handle portion 244 and may be formed from a single plate. The upright portion 242 extends orthogonally from one end of the flat base portion 240. The handle portion 244 extends from the opposite end of the upright portion 242, and is parallel to the base portion. The upright portion 242 comprises a square through-hole 246 located centrally therein. A corner 248 is formed at the intersection between the flat base portion 240 and the upright portion 242.

When assembled, the locking clips are welded to the trapezial flaps 210 such that the base portion lies along the trapezial flaps 210, with the upright portion extending upwardly from the end of the trapezial flaps 210. The bias of the trapezial flaps 210 causes the corner 248 to project into the recess 222.

Referring now to FIGS. 3(a) and (b), in which like parts have been given the same reference numerals as before, there is shown a side view of the male connector 112.

The male connector 112 comprises a projecting finger. The male connector 112 a proximal portion, between points A and B; and a distal portion between points B and E. The male connector 112 comprises a straight, flat lower face 300 and a parallel proximal upper face 302. At point B, the distal portion begins to taper gently so as to reduce the thickness of the male connector, creating a distal upper face 304. The tapering continues until point C, after which the distal portion begins to thicken steeply to point D, where the thickness is equal to that at point B. Thereafter the male connector 112 terminates in a head portion 306, comprising a rectangular end having rounded corners. The tapering between points B, C and D forms a notch 308 at point C, having a shallow entry from point B to point C, and a steep exit from point C to point D. The angle a represents the angle made between the proximal upper face 302 and the distal upper face 304. a typically has a value of 8°. The angle β represents the angle made between the flat end of the head portion 116 (at point E), which is orthogonal to the proximal upper face 302, and the surface between points C and D. 6 typically has a value of 38°. This sloped surface between points C and D lessens the precision required at insertion

Referring now to FIGS. 4 (a), (b), (c) and (d) the right-angle joining bracket 104 previously described in relation to FIG. 1 is shown in more detail. The right-angle joining bracket 104 comprises a body in the shape of a closed quadrant, having two straight sides 402, 404 at right angles to each other, and an arcuate surface 406 joining them. A set of male connectors 112 project from the body at each end of the curved portion thereof, in line with the straight sides 402, 404 adjacent thereto. Adjacent the base of each male connector 112 is a recess 410 and adjoining retaining projection 412. Together the recess 410 and adjoining retaining projection 412 form a cradle for the reception of an O-ring 414. In this way, the joining bracket 104 may be used, in combination with suitable O-rings, to form water-tight joins between pieces of an assembly.

The O-ring 414 comprises a small tab 416 that extends over the retaining projection 412. This tab allows for variation in the thickness of the sheet/panel/plate connected thereto, and ensures moisture will not pass through the connection between joining bracket and structural component.

In use, the male connectors 112 shown in FIG. 3, for example as part of the joining bracket 104 shown in FIG. 4 may be used in conjunction with the top-hat female connector assembly 200 shown in FIG. 2. To secure the joining bracket 104 and to the top-hat female connector assembly 200, the male connectors 112 are inserted into the recesses 222 along one side of the top-hat female connector assembly 200. As the projecting fingers of the male connectors 122 are pushed into the recesses 222, the head portions 306 of the male connectors 112 contact the corners 248 of the locking clips 206 and them upwards, against their bias, until the head portions 306 have progressed beyond the end of the corners 248, at which time the locking clips 206 will return to their biased orientation such that the corners 248 will engage the notch portion 308 of the male connector 112. Thus any attempts to remove the male connectors 122 from the top-hat female connector assembly 200 will cause the corners 248 of the locking clip 206 to push into the leg of the male connectors, and will thus prevent disengagement of the male and female connectors. Referring now to FIGS. 5, 6 and 7 there is shown, in cross-section, a selection of alternative embodiments of joining brackets 500, 600, 700, having male connectors 112 for use in assemblies according to the invention. FIG. 5 shows a four-way joining bracket comprising a circular main body 502 having four male connectors 112 formed projecting therefrom, each male connector 112 being disposed 90° from neighbouring male connectors 112. Adjacent the base of each male connector is a recess 410 and adjoining retaining projection 412. Together the recess 410 and adjoining retaining projection 412 form a cradle for the reception of an O-ring. In this way, the joining bracket 500 may be used, in combination with suitable O-rings, to form water-tight joins between pieces of an assembly.

FIG. 6 shows a three-way joining bracket 600 comprising a closed semi-circular main body 602, having thee male connectors 112 projecting therefrom, one at each corner of the closed semi-circle and a final male connector 112 located substantially at the mid-point of the semi-circular arc of the body 602. A cradle comprising a recess 410 and adjoining retaining projection 412 is located beside each male connector in the three-way joining bracket 600.

It will be noted in both FIGS. 5 and 6, the recess 410 defines the axis of symmetry for the bodies, and the legs of the male connectors 112.

FIG. 7 shows a straight joining bracket 700 comprising a narrow straight main body 702 with a male connector 112 at each end. Each male connector 112 is supplied with a cradle comprising a recess 410 and adjoining retaining projection 412 such that O-rings may be fitted therein and so allow water tight connections can be made.

The invention further comprises a number of joining brackets for forming assemblies comprising doors. Referring now to FIG. 8 in which like parts have been given the same reference numerals as before, there is shown a door side bracket 800 having a D-shaped main body 802 with a male connector 112 projecting from one corner of the D-shape, substantially in line with the spine of the D-shape. The door side bracket 800 further comprises a furrow formed by a furrow wall 804 projecting from the end of the spine opposite the male connector 112, at an angle of 25°. The furrow wall is then cranked to be parallel to the spine of the D-shape and finally is cranked again so as to be heading in the opposite direction of the first part of the furrow wall, an so forming a second furrow, on the other side of the furrow wall.

Referring now to FIG. 9 in which like parts have been given the same reference numerals as before, there is shown a double door jamb bracket 900 having two spaced apart parallel sides bridged at each end by a semi-circular portion, to form a body 902 having a shape similar to a racing track. A male connector 112 projects from the middle of one of the straight sides, with the axis running through the recess 410. A pair of furrows are formed on the opposing side by a double furrow wall 904 comprising a thick portion that bifurcates into a pair of furrow walls 906a, 906b, each making an angle of 25° with the straight side from which the double furrow wall 904 projects.

Referring now to FIG. 10 in which like parts have been given the same reference numerals as before, there is shown a door side joining bracket 1000 comprising a door side bracket body 1002. The door side body 1002 comprises first side from which a male connector 112 projects orthogonally, adjacent one edge thereof. The door side body 1002 further comprises a second side, orthogonal to the first side and extending therefrom adjacent the male connector 112. The second side is parallel to, but extends in the opposite direction as the male connector 112. The second side has a mounting rail 1004 thereon. The mounting rail 1004 is substantially T-shaped with a short vertical bar of the T-shape projecting from the second side such that the horizontal bar of the T-shape is parallel to the second side. The door side body 1002 further comprises a third side that curves inwardly from the free end of the second side. Finally, the door side body 1002 comprises a short fourth side, parallel to the second side and connecting the free ends of the first side and the third side. The third side further comprises an arcuate cavity therein. This arcuate cavity is used for press-fit securing a rubber or like side to the third side of the door side bracket 1000.

Referring now to FIGS. 11, 12, 13 and 14 there is shown, in cross-section or end view, a selection of compact joining brackets 1100, 1200, 1300, 1400 having male brackets 112 for use in assemblies according to the invention. FIG. 11 shows a terminating joining bracket 1100 comprising a body 1102 that narrows in a stepped manner on one edge to form the projecting finger with a male bracket 112 that tapers to a notch portion 308 before terminating in a head portion 306.

FIG. 12 shows a cross-shaped compact joining bracket 1200 comprising four male connectors 112. The structure of the cross-shaped joining bracket 1200 corresponds to four of the termination joining brackets 1100 as shown in FIG. 11, connected together at their non-connector ends.

FIG. 13 shows a T-shaped compact joining bracket 1300 comprising three male connectors 112 connected together in a T-shaped arrangement, similar to a straight joining bracket 700 with a termination joining bracket 1100 connected to the middle thereof and projecting orthogonally therefrom.

FIG. 14 shows the right-angle joining bracket, 1400 comprising a pair of male connectors 112 at right angles to each other. The right-angle joining bracket 1400 has a rounded corner 1402.

Referring now to FIGS. 15(a) and (b), in which like parts have been given the same reference numerals as before, there is shown a DIN rail mounting bracket 1500 which comprises a portion of standard terminating joining bracket 1100, having a pair of male connectors, with a DIN rail mounting 1502 fitted thereto. The DIN rail mounting bracket 1500 may be connected internally within an enclosure according to the invention and a DIN rail 1504 fitted therein, as shown in FIG. 15(a). It will be understood that a number similar brackets may be provided, each adapted to mount a different type of DIN rail, for example the G-type DIN rain as illustrated in FIG. 15(c).

Referring now to FIGS. 16(a), (b), (c), (d) and (e), in which like parts have been given the same reference numerals as before, there is shown an alternative DIN rail mounting joining bracket 1600 which comprises a standard terminating joining bracket 800 with an upright DIN rail mounting bracket 1604 thereon.

Referring now to FIGS. 17(a), (b) and (c), in which like parts have been given the same reference numerals as before, there are shown Z-shaped 1700, C-shaped 1702 and L-shaped 1704 mounting brackets. Each mounting bracket comprises a set 1750 of male connectors 112 having an orthogonal backplate 1706 having a plurality of rows of circular apertures therein which may be used to screwing or bolting articles (not shown) thereto. The Z-shaped mounting joining bracket 1700 and C-shaped mounting joining bracket 1702 each further comprise a top plate 1710, orthogonal to the backplate 1706 and comprising further apertures for reception of screws, nuts etc. In the Z-shaped mounting joining bracket 1700 the top plate 1710 extends rearwardly from the top of the backplate 1706 and in the C-shaped mounting joining bracket 1702 it extends forwardly therefrom.

Referring now to FIGS. 18(a) and (b), in which like parts have been given the same reference numerals as before, there is shown a backplate mounting bracket indicated generally by a reference numeral 1800. The backplate mounting bracket 1800 comprises an L-shaped bracket wherein each leg of the L-shape terminates in a male connector 112. The backplate mounting bracket 1800 comprises a recess fitted with a seal 1802 on the outside of the first leg of the L-shape adjacent the corner of the L-shape. The backplate 1800 further comprises a lip 1804 on the inside of the second leg of the L-shape. In use, the backplate mounting bracket 1800 is used to mount a backplate 1806 in an enclosure, which backplate 1806 is spaced apart from a wall (not shown) of a structure on which the enclosure comprising the backplate 1806 is mounted. The first leg of the backplate joining bracket 1800 is engaged with a terminating female connector assembly 1808, and which may abut against the wall (not shown) of the structure. In this way, the terminating female connector assembly 1808 will be outside the enclosure formed by the components. The backplate 1808 and base 1810 of the enclosure are formed from any of the structural components described herein.

Referring now to FIG. 19 in which like parts have been given the same reference numerals as before, there is shown a sample assembly according to the invention, indicated generally by the reference numeral 1900 The assembly comprises a base panel 1902a and an upright panel 1902b connected together orthogonally by a right-angled joining brackets 104. A female connector assembly 1904, comprising inward and outward facing female connectors, has been fitted along the edges of one face of both panels 1902. A C-shaped mounting joining bracket 1702 has been brought into engagement with the inward facing female connectors of the female connector assembly 1904a whose outward facing female connectors engage the right-angled joining bracket 104 on the base panel 1902a. In this way, components may be secured to the C-shaped mounting joining bracket 1702.

Referring now to FIG. 20, in which like parts have been given the same reference numerals as before, there is shown an exemplary structural component, in this case a panel 2000 having an earthing pin 111 projecting upwardly at each corner thereof.

It will be understood from the foregoing description and accompanying drawings that an assembly according to the invention may be formed from a selection of structural components such as panels; joining brackets; corner brackets; and accessory components such as mounting brackets, wherein the above-mentioned components and brackets are fitted with a complementary sets of male and female connectors. It will be understood further that there are a wide number of possible designs for implementing the complementary sets of male and female connectors. A number of exemplary connector designs, which would also work with the assembly of the invention, will now be described.

Referring now to FIGS. 21 (a), (b), (c), (d) and (e), and FIGS. 22 and 23, in which like parts have been given the same reference numerals as before, there is shown an alternative embodiment of female connector assembly, the sliding sawtooth female connector assembly indicated generally by the reference number 2100. The sliding sawtooth female connector assembly 2100 comprises a corrugated wall 2102 in the form of a flat based corrugation wherein the sides of the corrugations are at an angle of 23.5±2° to the base thereof. The corrugated wall 2102 is arranged so as to provide a series of interspersed recesses on each side. The sliding sawtooth female connector assembly 2100 further comprises an elongate baseplate 2104 having a series of spaced-apart rectangular through-holes 2106 that are arranged on the baseplate 2104 so as to be located over one of the recesses of the corrugated wall 2102 below. The sliding sawtooth female connector assembly 2100 further comprises a plurality of sawtooth locking blocks 2108, each comprising a substantially U-shaped block having a set of sawtooth serrations 2110 on the underside thereof.

The sawtooth locking blocks 2108 are adapted to fit through the through holes 2106 in the baseplate 2104 and so protrude below the baseplate 2104 into the recesses formed by the corrugated wall 2102. The sawtooth locking blocks 2108 are further adapted to engage with a top plate 2112 having a plurality of bridged through-holes 2114 in line with the through holes 2106 of the baseplate 2104. The bridged through-holes 2114 are bridged by flat-topped arches that are stamped from the material of the top plate 2112. The arches 2116 rest in the sawtooth locking blocks 2108, on a cuboid rubber spring insert 2117. Finally, the sliding sawtooth female connector assembly 2100 comprises a plurality of release sliders 2118. Each release slider 2118 comprises an elongate body having a boss 2120 on its underside at one end, the boss 2120 having an inclined face which is inclined towards the opposite end of boss. The release slider 2118 further comprises a small groove running lengthways along each side thereof, and a curved tab at each end of the slider 2118.

The sawtooth locking blocks 2108 comprise a U-shaped body having a pair of side walls 2200. The outer face of each sidewall 2200 has a lip 2202 approximately halfway up such that the upper half of the side walls is wider than the lower half. This acts to prevent the sawtooth locking block 2108 from falling through the through-holes 2106 in the baseplate 2104.

The underside of the U-shaped body comprises a set of sawtooth serrations, each sawtooth serration 2204 has one substantially vertical side and one side sloped at approximately 45°, with a rounded apex.

The main channel inside the U-shaped body has a substantially square base, however the inside face of each sidewall 2200 has a small recess 2206 below a protrusion 2208 above which the side walls 2200 terminate in a tapering portion. The cuboid rubber spring insert 2117 sits inside the U-shaped body on the square base and extendable words to approximately the bottom of the small recess 2206.

When assembled, the sawtooth locking blocks 2108, including spring inserts 2117, are inserted in the through holes 2106 in the baseplate 2104, with the lips 2202 preventing the sawtooth locking blocks 2108 from passing all the way through. The top plate 2112 is placed over the sawtooth locking blocks 2108 such that the top plate 2112 rests on the baseplate 2104 and the arches 2116 of the bridged through-holes 2114 rest on the spring inserts 2117 in the sawtooth locking blocks 2108, such that the arches 2116 are below the small recesses 2206 on the inside of the side walls 2202 thereof. The release sliders 2118 are fitted into the sawtooth locking blocks 2108 such that the protrusions 2206 on the inside of the walls of the sawtooth locking blocks 2108 engage the grooves in the sides of the release sliders 2118. The inclined face of the boss 2112 on the underside of the release slider 2118 is sloped so as to be complementary to the slope of the arches.

In use, the release sliders are slidable between locked and unlocked positions. In the locked position, the boss 2120 rests on the top plate 2112, and the sawtooth serrations 2204 on the underside of the sawtooth locking blocks 2108 project into the recess in corrugated wall 2102 below the base plate 2104. In the unlocked position, the release slide 2117 has been slid across such that the boss 2120 now rests on top of arches 2116, the sawtooth locking blocks 2108 having pulled upwards, compressing the spring insert 2117. In the unlocked position, the sawtooth locking blocks 2108 do no project below the base plate 2104.

It will be understood that sliding sawtooth female connector assembly 2100 may be provided with or without the release mechanism. If the release mechanism is not fitted, the sawtooth locking blocks 2108 will always project into the recesses so as to engage with a suitable male connector.

Referring now to FIGS. 25(a), (b) and (c), in which like parts have been given the same reference numerals as before, there is shown a fully serrated male connector assembly indicated generally by the reference numeral 2500. The fully serrated male connector assembly 2500 comprises an elongate backplane 2502 having a plurality of, in this case four, male connectors 2504 projecting from one side thereof. An O-ring recess 2506 is located in the underside of the backplane 2502. This O-ring recess 2506 forms a corresponding bump 2508 on the top side of the backplane 2502.

Each male connector 2504 tapers slightly in width as it extends from the backplane, giving it a trapezial shape. The underside of the male connector 2504 is substantially flat, while the top side of each male connector 2504 comprises a series of sawtooth serrations 2510, extending fully across the projecting finger of the male connector 2504. Each sawtooth serration 2510 comprises an inclined face inclining downwardly followed by a substantially vertical face, with rounded intersections between each face. The inclined faces ramp downwardly toward the distal end of the male connector. This arrangement of serrations can be formed using press-stamping, roll forming or extrusion. onto the male connectors 2504. The distal end of the male connector 2504 is slightly tapered in height, so as to ease entry into the recess of a suitable female connector.

In FIG. 25(c), a flange 2512 has been fitted below the underside of the backplane 2502 such that the flange extends approximately halfway across the O-ring recess 2506. In this way, the flange ensures that an O-ring (not shown) pressed into the O-ring recess 2506 will remain in place.

Referring now to FIGS. 26(a), (b) and (c), in which like parts have been given the same reference numerals as before, there is shown a partially serrated male connector assembly indicated generally by the reference numeral 2600. The partially serrated male connector assembly 2600 is identical in structure to the fully serrated male connector assembly 2500 except for the arrangement of the serrations on the male connectors. The partially serrated male connector assembly 2600 comprises an elongate backplane 2602 having a plurality of spaced-apart male connectors 2604 projecting from one side thereof. An O-ring recess 2606 is located in the underside of the backplane 2602. This O-ring recess 2606 forms a corresponding bump 2608 on the top side of the backplane 2602.

Each male connector 2604 tapers slightly in width as it extends from the backplane, giving it a trapezial shape. The underside of the male connector 2604 is substantially flat, while the top side of each male connector 2604 comprises a series of sawtooth serrations 2610, extending across a central portion of the projecting finger of the male connector 2504, such that there is a flat portion 2612 either side of the serrations 2610.

Each sawtooth serration 2610 comprises a substantially vertical face followed by an inclined face inclining downwardly, with rounded apex between each face. The inclined faces ramp downwardly toward the distal end of the male connector. There is a flat space 2614 between each serration 2610. This arrangement of serrations must be press-stamped on to the flat top-side of the male connectors 2604. The distal end of the male connector 2604 is slightly tapered in height, so as to ease entry into the recess of a suitable female connector.

In FIG. 26(c), a flange 2612 has been fitted below the underside of the backplane 2602 such that the flange extends approximately halfway across the O-ring recess 2606. In this way, the flange ensures that an O-ring (not shown) pressed into the O-ring recess 2606 will remain in place.

Referring now to FIGS. 27(a) and (b), in which like parts have been given the same reference numerals as before, there is shown an alternative embodiment of fully serrated male connector assembly—the two-part fully serrated male connector assembly indicated generally by the reference numeral 2700. The two-part fully serrated male connector assembly 2700 comprises an elongate flat baseplate 2702 having a backplane portion 2704 and a plurality of spaced-apart trapezial fingers 2706 projecting from one side thereof. Each finger 2706 has a serrated top sheet 2708 of the same shape and size affixed thereto. The combination of trapezial finger and serrated top sheet 2708 form a male connector 2710 having a serrated topside. The serrated top-sheet 2708 comprises a series of saw-tooth serrations 2710, each having an inclined face inclining downwardly followed by a substantially vertical face, with rounded intersections between each face. The inclined faces ramp downwardly toward the distal end of the male connector. As there is no space between adjacent sawtooth serrations, these serrations may be referred to as contiguous sawtooth serrations.

This male connector assembly 2700 does not comprise an O-ring recess however it will be clear to the person skilled in the art that such an O-ring recess could be simply incorporated into this embodiment.

The sawtooth serrations 2510, 2610, 2710 of the male connector assemblies described in relation to FIGS. 25, 26 and 27 are complementary in shape to those 2204 on the underside of the sawtooth locking blocks 2108 of the female connector assembly 2100.

In use, the any of the male connector assemblies described herein may be used to connect with the female connector assembly described in relation to FIGS. 21, 22, and 23. When the projecting fingers of the male connectors 2504, 2604, 2710 are pushed into the recesses of the female connector assembly 2100, the rounded apexes of the serrations 2510, 2610, 2710 on the topside thereof will move past the rounded apexes of the serrations 2204 on the underside of the sawtooth locking blocks 2108, with the inclined faces of one set of serrations moving easily over the complementarily inclined faces of the other set of serrations. However, if an attempt is made to withdraw the male connectors 2504, 2604, 2710 the vertical sides of the two sets of serrations will push against each other and it will not be possible to remove the male connectors 2504, 2604, 2710.

This is illustrated in FIG. 28, in which like parts have been given the same reference numerals as before. A top hat female connector assembly 2100 has been affixed to a panel 102, typically by welding. A male connector assembly 2500 has been brought into engagement with the top hat female connector assembly 2100. The male connectors 2504 have been pushed into the recesses of the top hat female connector assembly 2100. The male connector 2504 has been pushed as far as it can go into the recess of the female connector assembly 2100. In this way, the two serrations 2510 adjacent the distal end of the male connector do not engage the sawtooth locking block 2108, while the remaining serrations 2510 abut against the serrations 2205 on the sawtooth locking blocks 2108. It will also be noted that the flange 2512 adjoining the O-ring recess 2506 on the male connector assembly 2500 extends very nearly to the panel 102. It is clear that, with an O-ring fitted in this location, a watertight seal could be made between the male connector assembly 2500 and the panel 102. As such it is clear that a watertight seal could be made between the joining bracket comprising the male connector assembly 2500 and the structural component that is the panel.

The male connector assemblies have been described as comprising a backplane having a number of projecting fingers. It will be understood by the person skilled in the art the backplane may correspond to the body portions of the joining brackets described herein.

Referring now to FIGS. 29 and 34, in which like parts have been given the same reference numerals as before, there is shown some exemplary basic joining brackets comprising the fully serrated male connector assembly 2500 of FIG. 25. FIG. 29 shows a serrated right angle joining bracket indicated generally by the reference numeral 2900 substantially similar in shape to the right angle joining bracket 104 shown in FIGS. 1 and 4, except that that the male connector 112 having a notch and bulbous end for engagement with a leaf spring type flap has been replaced with a male connector 2504 having a plurality of sawtooth serrations 2510 thereon. The serrated right angle joining bracket 2900 further comprises a T-shaped mounting rail 2902 in the middle of the arcuate surface 2904 of the body thereof. The T-shaped mounting rail 2902 is similar to the mounting rail 1004 described in relation to FIG. 10, and comprises a short bar, corresponding to the upright of the T-shape, projecting orthogonally from the arcuate surface 2904, with a longer bar, corresponding to the crossbar of the T-shape, running across the distal end of the short bar.

FIG. 34 shows a serrated three-way joining bracket, indicated generally by the reference numeral 3400, comprising the fully serrated male connector assembly of FIG. 25. The serrated three-way joining bracket 3400 is substantially similar to the three-way joining bracket 600 described in relation to FIG. 6. Each arcuate surface of the serrated three-way joining bracket 3400 comprises a T-shaped mounting rail 2902 as described in relation to FIG. 29.

Referring now to FIG. 30, in which like parts have been given the same reference numerals as before, there is shown a serrated single door jamb joining bracket indicated generally by the reference numeral 3000, and corresponds to the single door jamb joining bracket 800 described in relation to FIG. 8. The male connector 112 has been replaced by a serrated male connector 2504. The D-shaped body now comprises two straight portions, one connected to the straight back-bone of the D, and the other connected at the base of the male connector 2504. The straight portions are connected by a curved portion. Each straight portion has a T-shaped mounting rail 2902 projecting therefrom.

Referring now to FIG. 33, in which like parts have been given the same reference numerals as before, there is shown a large door jamb joining bracket indicated generally by the reference numeral 3300. The large door jamb joining bracket 3300 is very similar to the serrated single door jamb joining bracket 3000, except that it comprises three T-shaped mounting rails 2902. The inner straight portion of the D-shape now comprises a pair of adjacent T-shaped mounting rails 2902.

Referring now to FIG. 31, in which like parts have been given the same reference numerals as before, there is shown a serrated door seal joining bracket indicated generally by the reference numeral 3100, and corresponds to the door seal joining bracket 1000 described in relation to FIG. 10.

Referring now to FIG. 32, in which like parts have been given the same reference numerals as before, there is shown an accessory bracket, indicated generally by the reference numeral 3200. The accessory bracket 3200 has a pair of orthogonal wall, whose distal ends are joined by a partially curved wall. Each wall comprises a T-shaped mounting rail 2902.

In relation to FIGS. 29 to 34, it will be understood that similar joining brackets comprising the partially serrated male connector assembly 2600 of FIG. 26 or two-part fully serrated male connector assembly 2700 of FIG. 27 are also comprised within the invention.

Referring now to FIGS. 35(a), (b) and (c), in which like parts have been given the same reference numerals as before, there is shown an alternative embodiment of single door jamb joining bracket, the knurled single door jamb joining bracket indicated generally by the reference numeral 3500. The knurled single door jamb joining bracket 3500 comprises a T-shaped mounting rail 3502 wherein the side edges of the cross-bar of the T-shape are knurled along the length thereof. To form the knurls, a series of small partially circular nicks have been made along the side of the cross-bar. These knurled edges aid in keeping accessories mounted on the knurled T-shaped mounting rail 3502 in place, and reduces or eliminates any unwanted sliding of accessories along the rail 3502.

Referring now to FIG. 36, in which like parts have been given the same reference numerals as before, there is shown a portion of an assembly according to the invention. The assembly, indicated generally by the reference numeral 3600, comprises a pair of panels hingedly connected together. The first panel 3602 provides a wall of an assembly, while second panel 3604 provides a door. Each panel 3602, 3604 has a number of top-hat female connector assembly 2100 affixed to each edge thereof (only one visible). The first panel 3602 is connected to a single door jamb joining bracket 3000 by engagement of the male connector assembly thereof (not shown) with one of the top-hat female connector assembly 2100. The second panel 3604 is connected to a serrated door seal joining bracket 3100 by engagement of the male connector assembly thereof (not shown) with one of the top-hat female connector assembly 2100. The single door jamb joining bracket 3000 and serrated door seal joining bracket 3100 are connected together by a hinge accessory, indicated generally by the reference numeral 3606. The hinge accessory 3606 comprises a pair of T-shaped channel bodies 3608 joined together by a central hinge portion 3610. The T-shaped channel bodies 3608 are shaped in a complementary manner to the T-shaped mounting rails 2902 such that the T-shaped channel bodies 3608 fit snugly over the T-shaped mounting rails 2902. The serrated door seal joining bracket 3100 is fitted with a rubber seal 3612 in the arcuate cavity of the third side thereof. This seal 3612 ensures an enclosure comprising such a door is sealed when the door is shut.

Referring now to FIG. 37, in which like parts have been given the same reference numerals as before, there is shown the top view of a slice taken from a square box assembly according to the invention. The assembly, indicated generally by the reference numeral 3700, comprises two side walls 3702a, 3702b, a rear wall 3702c and a door 3704. Each of the side walls side walls 3702a, 3702b, 3702c and door 3704 comprise a panel having a top-hat female connector assembly 2100 running down each side edge. The rear wall 3702c is connected to each side wall 3702a, 3702b by a serrated right angle joining bracket 2900. The opposite edge of each side walls 3702a, 3702b is connected to a single door jamb joining bracket 3000a, 3000b. The door 3704 is connected to a pair of serrated door seal joining brackets 3100, one each side The single door jamb joining bracket 3000b has a hinge accessory 3606 mounted on its T-shaped mounting rail 2902, wherein the hinge accessory 3606is also mounted on the T-shaped mounting rail 2902 of the serrated door seal joining bracket 3100. The other single door jamb joining bracket 3000a has a door latch accessory 3706 mounted on its T-shaped mounting rail 2902. In use, the door 3704 is hinged and may open and close as required. When closed, the rubber seal 3612 of the serrated door seal joining brackets 3100 will rest against the single door jamb joining brackets 3000 to seal off the enclosure.

Referring now to FIGS. 38 to 44 there is shown an exemplary set of roll formed joining brackets for use in assemblies according to the invention. FIG. 38 shows a roll formed right angle joining bracket, indicated generally by the reference numeral 3800 corresponding to the right angled joining bracket 104 shown in FIGS. 1 and 4. In the case of these roll formed joining brackets, the male connector assembly 3802 is formed from a plurality of projecting fingers each comprising a double layer of material having one flat layer and the second layer forming a triangular lug 3804 at the distal end of the projecting finger. The proximal end of each projecting finger comprises an O-ring recess 3806 which is partially closed off by a roll formed flange 3808.

Referring now to FIG. 39, there is shown a roll formed three-way joining bracket indicated generally by the reference numeral 3900. The roll formed three-way joining bracket 3900 comprises three male connector assemblies 3802 similar to those used in the right angle joining bracket 3800, with a central male connector assembly 3802 and a pair of side male connector assemblies 3802, each orthogonal to the central male connector assembly 3802.

Referring now to FIGS. 40 and 41, there is shown again an alternative roll formed right angle joining bracket indicated generally by the reference numeral 4000 and an alternative roll formed three-way joining bracket indicated generally by the reference numeral 4100. These alternative roll formed joining brackets 4000, 4100 are substantially similar to the joining brackets shown in FIGS. 38 and 39. The roll formed right angle joining bracket 4000 and the roll formed three-way joining bracket 4100 each include a roll formed T-shaped mounting rail 4002 on their arcuate surfaces.

Referring now to FIG. 42, in which like parts have been given the same reference numerals as before, there is shown a roll formed door seal joining bracket, indicated generally by the reference numeral 4200. The roll formed door seal joining bracket 4200 incorporates a single male connector assembly 3802 and a pair of roll formed T-shaped mounting rails 4002. These components are in a similar orientation to previously described door seal joining brackets.

Referring now to FIG. 43, in which like parts have been given the same reference numerals as before, there is shown a roll formed single door jamb joining bracket, indicated generally by the reference numeral 4300. The roll formed door jamb joining bracket 4300 comprises a single male connector assembly 3802 and a pair of roll formed T-shaped mounting rails 4002, in a similar orientation to the door jamb joining brackets described previously herein.

These roll formed joining brackets provide male connector assemblies that may be used to engage with at least the top-hat female connector assembly 200 described herein in relation to FIG. 2.

Referring now to FIG. 44 is a roll formed accessory bracket indicated generally by the reference numeral 4000. The roll formed accessory bracket 4400 is very similar to the accessory bracket 3200 shown in, and described herein in relation to, FIG. 32. The roll formed accessory bracket 4400 has roll formed T-shaped mounting rails 4002 projecting from each non-curved wall thereof.

It will be apparent that a wide variety of complementary connector assemblies may be used with the assembly of the invention. A number of suitable complementary connector assemblies are described hereafter. IT will be understood by the person skilled in the art that a roll formed male connector having sawtooth serrations may be formed in a manner similar to the formation of the two-part fully serrated male connector assembly 2700 as shown in, and described herein in relation to FIG. 27. A flat projecting finger may be roll formed and then a suitably shaped serrated top sheet may be affixed thereto.

Referring now to FIGS. 45, 46, 47 and 48, in which like parts have been given the same reference numerals as before, there is shown an alternative embodiment of a roll formed right angle joining bracket, indicated generally by the reference numeral 4500. The alternative right angle joining bracket comprises a right angled main body portion 4502 with each side of the right angle extending into a male connector assembly 4504. The male connector assembly 4504 is stepped up slightly from the arms of the right angled portion 4502. The projecting finger of the male connector assembly 4504 comprises a flat upper face 4506 which extends into a downwardly inclined face 4508 with a flat lower face 4510 extending rearwardly from the end of the inclined face 4508. The flat lower face 4510 is inset from the adjoining arm of the right angled body 4502. The flat upper face comprises a series of spaced-apart square through holes 4512.

The alternative female connector assembly, indicated generally by the reference numeral 4550 comprises a main body having a central square-based channel 4602; with a wing 4604 extending upwardly in an inclined manner from each side wall of the square-based channel 4602. The wing 4604 terminates in a flat portion 4606 having a plurality of spaced-apart through-holes 4608 therein, wherein each through-hole 4608 is bridged by an arch 4610. The female connector assembly 4600 is affixed to a panel 4620. The female connector assembly 4600 is welded to the panel 4620 along the underside of the square-based channel 4602. Each through-hole 4608 in the female connector assembly 4600 is fitted with a locking block 4700. The locking block 4700 comprises a U-shaped channel having a protrusion 4702 thereon. The locking block 4700 is fitted with a rubber spring insert 4704, which sits snugly in the base of the U-shaped channel. The locking block is further fitted with a release slider 2118, as herein described in relation to FIG. 21. The locking block 4700, including rubber spring insert 4704 and release slider 2118, are fitted in the arched through-holes 4608 in the female connector assembly in a similar manner as hereinbefore described in relation to FIG. 21.

In use, the projecting fingers of the male connector assembly 4504 of the alternative right angle joining bracket 4500 is brought into engagement with the female connector assembly 4600. Unlike previous female connector assemblies, there are no clearly defined recesses in the female connector assembly 4600, however, the male connector assembly 4504 is inserted such that the square through-holes 4512 are in line with the through-holes 4608 in the female connector assembly 4600. As the inclined face 4700 of the projecting fingers is inserted, the locking block 4700 is upwards by the projecting fingers, and so compressing the rubber spring insert 4704. As the male connector assembly 4504 is inserted further into the female connector assembly 4600, the locking blocks 4700 are pushed further upward until such time as the square through holes 4512 of the male connector assembly 4504 are directly underneath the locking blocks 4700. At this point, the locking blocks 4700 will be pushed down into the square through holes 4512, by the re-expansion of the rubber spring insert 4704, thus locking the projecting fingers of the male connector assembly 4504 in place. The engagement between the connector assemblies may be released by pushing the release sliders across and thus lifting the locking blocks 4700 from the square through holes 4512. This arrangement has the advantage of locking the male connector assembly 4504 is place in three directions, preventing it from moving forward, backward or from side to side.

It will be understood that the protrusion 4702 on the inside of the side walls of the locking block 4700 may be provided in a number of ways, including the roll formed manner shown here. For example, a small hinged tab may be cut from the inside side walls that can be adjusted to project outwardly and so form a protrusion.

Referring now to FIG. 55, in which like parts have been given the same reference numerals as before, there is shown an alternative embodiment of locking block for use the female connector assembly 4600 shown in FIGS. 45, 46 and 49 and described in relation thereto. The alternative locking block, indicated generally by the reference numeral 5500, comprises a roll-formed truncated V-shaped channel 5502 having sides extend straight up from the ends of the inclined sides of the V. The straight sides then fold inwards to provide straight inner walls that extend downwardly into the locking block 5500 as far as the point at which the straight outer walls begin. The inner walls are slightly spaced apart from the inner walls. The inner walls each have a rectangular aperture 5504 therein, adjacent the top thereof.

Referring now to FIGS. 49, 50 and 51, in which like parts have been given the same reference numerals as before, there is shown a further embodiment of a female connector assembly for use with assemblies according to the invention. The button female connector assembly, indicated generally by the reference numeral 4900, comprises a base plate 4902, a plurality of locking clips 4904, each having an upstanding button 4906, a plurality of release blocks 5000 and a cover sheet 4908. The base plate 4902 comprises a flat plate having a series of square flaps formed therein, wherein the flaps remain attached to the base plate at one edge thereof so that they are effectively hinged at this edge. The side at which the flap is hinged alternates between neighbouring flaps. Each flap has a locking clip 4904 affixed thereto, such that the button 4906 of each locking clip is located towards the end of the flap distal from its hinge.

The release blocks 5000 comprise a substantially cuboid body having a square stud 5002 projecting centrally from the upper face thereof, a small rectangular aperture on one end face thereof and a larger aperture at the opposite face extending through the underside of the body. The release block 5002 is partially hollow.

The roll formed top sheet 4908 comprises a pair of side walls 4910a, 4910b, having a number of spaced-apart recesses defined therein, which recesses will act as the recesses in the female connector assembly 4900. The recesses on one wall are staggered with respect to the recesses on the opposing wall.

The release block 5000 is adapted to receive the button 4906 of the locking clips 4904, and has inclined surfaces therein, such that as the release block slides across the button, it will either push the button down further below the base plate or allow the button to lift closer to the base plate.

The top plate comprises a number of elongate apertures running along the longitudinal axis of the top plate. The apertures 4912 are just wide enough to receive the square stud 5002 on top of the release block 5000. The apertures 4912 are arranged in two rows running along the longitudinal axis of the top plate with the apertures in each row being staggered with reference to the apertures in the other row.

When assembled, the top plate 4908 extends upwardly from the side walls 4910 around the side edges of the base plate 4902 and then upward to cover the release blocks with the studs of the release block fitting through the apertures 4912.

In use, by sliding the studs 5002 within the apertures 4912 in the top plate 4908, the position of the button and consequently, the locking clips 4904, can be varied. The buttons 4906 may be pushed down so as to cause the locking clips 4904 to push down into the recesses below the base plate, thus allowing them to engage with any male connector that may be inserted into these recesses. If the button is allowed to be in a raised position, the locking clips 4904 will not project significantly below the base plate and will not extend into the recesses of the female connector assembly 4900, thus allowing any male connection assembly to be inserted and removed freely. When the stud 5002 is in a central location within the apertures 4912 of the top plate 4908, the button is in a “floating position” wherein it may move freely according to the spring bias of the flaps formed in the base plate. It will be understood that this female connector assembly 4900 will work with a male connector assembly wherein the projecting fingers of the male connectors have a bulbous head portion, for example, the roll formed male connector assemblies that are part of the joining brackets shown in FIGS. 38 to 43.

FIGS. 55(a), (b) and (c) are end and perspective views respectively of a locking block for use in the female connector assembly shown in FIGS. 45 and 48.

Referring now to FIGS. 52 and 53, in which like parts have been given the same reference numerals as before, there is shown a further example of a female connector assembly for use in assemblies formed according to the invention. The hook female connector assembly, indicated generally by the reference numeral 5200, comprises a corrugated base wall 5202. The corrugated wall 5202 is substantially similar to that shown in FIG. 21(a) and described herein in relation to that figure, and comprises flat based corrugations wherein the sides of the corrugations are at an angle of 23.5±2° to the base thereof. The corrugated wall 5202 is arranged so as to provide a series of recesses on each side, the recesses from opposing sides being interspersed with each other. These recesses will form the recesses of the female connector assembly for reception of projecting fingers of a complementary male connector assembly.

The hook female connector assembly 5200 further comprises a base plate 5204 having two rows of staggered, partially arched apertures 5206 running along the length of the elongate base plate 5204. The partial arches 5208 commence with an upwardly inclined portion and terminate in a flat portion parallel to the base plate 5204. The partial arches 5208 may be formed by stamping a suitable shape from the base plate 5204. The hook female connector assembly 5200 further comprises a plurality of locking blocks 5210. The hook locking blocks 5210 have a series of sawtooth serrations 5212 on their underside. The hook locking blocks 5210 are similar in shape to the sawtooth locking blocks 2108 shown in FIG. 21 and described herein in relation to that figure, except that the side walls are closed by a top wall 5214 providing an open-ended hollow tube. A rubber spring insert 5216 is fitted within the hollow tube leaving an empty space thereabove within the hollow tube. The side walls of the hook locking block 5210 each comprise a projecting flange 5218 approximately halfway up

When assembled, the locking blocks 5210 are inserted in the apertures 5206 in the base plate 5204 such that the flat terminating portion of the partial arches 5208 extends through the hollow tube of the locking block 5210 above the rubber spring insert 5216. The flanges 5128 prevent the hook locking blocks from fitting through the apertures 5206. In use, when a serrated male connector assembly, such as that shown and described in relation to FIG. 25, is inserted into the hook female assembly, the locking blocks 5210 are pushed slightly upwards against the bias of the spring insert 5216, wherein the engagement of the complementary sawtooth serrations will prevent the projecting fingers of the male connector assembly 2500 from being removed from the female connector assembly 5200. The hook female connector assembly 5200 is not shown with a release mechanism, however, it will be apparent to the person skilled in the art that a release mechanism may be incorporated therein, in particular using the empty space in the hollow tube between the spring insert 5216 and the top wall of the locking block 5214.

Referring now to FIGS. 56 and 57, there is shown a no release button female connector assembly, indicated generally by the reference numeral 5600. The no-release button female connector assembly 5600 is very similar to the button connector assembly 4900 shown and described in relation to FIG. 49.

The base plate 4902 comprises a flat plate having a series of square flaps formed therein, wherein the flaps remain attached to the base plate at one edge thereof so that they are effectively hinged at this edge. The side at which the flap is hinged alternately between neighbouring flaps. Each flap has a locking clip 4904 affixed thereto, such that the button 4906 of each locking clip is located towards the end of the flap distal from its hinge.

The roll formed top sheet 5602 comprises a pair of side walls 5604a, 5604b, having a number of spaced-apart recesses defined therein, which recesses will act as the recesses in the female connector assembly 5600. The recesses on one wall are staggered with respect to the recesses on the opposing wall.

The cover plate 5602 comprises a number of circular apertures 5606 for reception of the buttons 4906. The circular apertures 5606 are arranged in two rows, running along the length of the cover plate 5602 in a spaced apart manner, with the circular apertures 5606 of one row being approximately halfway between the circular apertures 5606 of the neighbouring row.

When assembled, the cover plate 5602 extends upwardly from the side walls 4910 around the side edges of the base plate 4902 and then covers the top of the baseplate 4902 such that the buttons 4906 fit through the circular apertures 5606

It will be understood that this female connector assembly 56000 will work with a male connector assembly wherein the projecting fingers of the male connectors have a bulbous head portion, for example, the roll formed male connector assemblies that are part of the joining brackets shown in FIGS. 38 to 43.

Referring now to FIGS. 58 and 59, in which like parts have been given the same reference numerals as before, there is shown another example of a female connector assembly for use in assemblies according to the invention. The button serrated female connector assembly, indicated generally by the reference numeral 5800, comprises a base plate 5802, a top plate 5804, a plurality of serrated locking bars 5806, and a plurality of buttons 5808.

The base plate 5802 comprises two rows of through-holes running the length of the elongate plate 5802. Each row comprises alternating large holes 5810 and small holes 5812 with the rows being aligned such that a large hole 5810 in one row is adjacent to a small hole 5812 in the neighbouring row. A side wall portion 5814 projects from the small holes such that the side wall portion is adjacent the side of the base plate 5802. The side wall portion 5814 is formed by folding down a portion of the base plate from the small hole 5812. The locking bars 5806 comprise a plurality of sawtooth serrations 5816 on the underside thereof. The upper face of the locking bars 5806 comprise a circular blind hole 5818 located centrally thereon. The buttons 5808 comprise a circular head 5820 with a narrower cylindrical stem 5822 projecting downwardly therefrom. The top plate 5804 comprises a series of U-shaped apertures punched therethrough forming substantially rectangular flaps 5224 attached at one end to the top plate 5804, with a circular aperture in their distal end. When assembled, the locking bars 5806 are inserted into the large holes 5810 in the base plate 5802. The base plate 5802 is then covered by the top plate 5804 and the stem 5822 of the buttons is inserted through the circular through-hole in the flaps 5224 of the top plate 5804 into the circular blind hole 5818 in the locking bar. In use, the sawtooth serrations 5816 on the underside of the locking bar 5806 will extend below the base plate into the recesses formed by the gaps in the side wall portions 5814. In this way, the serrated button female connector assembly 5800 is suitable for use with the serrated male connection assemblies such as those shown and described herein in relation to FIGS. 25, 26 and 27.

Referring now to FIGS. 60(a), (b), (c), and (d), in which like parts have been given the same reference numerals as before, there is shown an alternative embodiment of flap, indicated generally by the reference numeral 6000 for use with the top-hat female connector assembly 20 shown, and described here in relation to, FIG. 2. IN FIG. 2, the hinged flaps 210 are used to position the locking clips 206 in the recesses for engagement with a projecting finger of a male connector. The locking clips are welded to the flaps to strengthen the locking mechanism and also to provide a lifting device for release. In the alternative embodiment shown in FIG. 60, a locking clip is not used. The rigidity of the flap 6000 is increased by formed pressed depressions 6002. The flap has a proximal end 0004 which will remain connected to the backplate (not shown), and a distal end which is bent back over the body of the flap to form a hook shape, which may be used as a lifting eye to provide a release mechanism. The flap tapers as it moves from proximal to distal end, thus providing added strength.

Referring now to FIGS. 61, in which like parts have been given the same reference numerals as before, there is shown an alternative embodiment of assembly, indicated generally by the reference numeral 6100, comprising a three-way joining bracket 6102 and three panels 6104. Each panel 6104 has a double sided male connector assembly 6106 comprising projecting fingers 6108 similar to that shown in, and described herein in relation to, FIG. 3. The three-way joining bracket 6102 comprises three female connector assemblies 6110 of the type having a flap or leaf spring projecting into the recess of each female connector in the female connector assemblies 6110. The three female connector assemblies 6110 are arranged in the three-way joining bracket 6102 in a similar manner to the three-way joining brackets 600, 1300, 3400 shown and described previously.

It will be noted that the majority of the joining brackets shown in the figures and described herein comprise male connector assembly, while the panels such as wall and doors are fitted with female connector assemblies. This arrangement is preferred as it is easier to manufacture. However, FIG. 61 illustrates that the reverse arrangement is possible. The person skilled in the art will understand the manners in which the joining brackets and panels described herein and shown in the figures may be adapted to comprise the opposite type of connector.

Referring now to FIGS. 62(a) and (b), there is shown a female connector assembly indicated generally by the reference numeral 6200. The female connector assembly 6200 comprises a pair of spaced-apart, parallel upright walls 6202a, 6202b. Each wall 6202a, 6202b comprises spaced-apart recesses 6204, with the recesses 6204 on one wall being staggered in relation to the recesses 6204 on the opposing wall. The recesses 6204 are formed by making partial breaks in the walls and folding in the portions 6205 of the walls 6202a, 6202b on either side of the breaks. A thin portion of the wall 6202a, 6202b at the top remains unbroken, thus maintaining the connectedness of the walls 6202a, 6202b. This construction causes the walls 6202a, 6202b in combination to take on the form of a flat based corrugation. Each side of a trough of the corrugation is formed by a folded-in wall piece from each of the walls 6202a, 6202b and are therefore not connected together. The sides of the troughs of the corrugation are not orthogonal to the bases thereof. The openings of the troughs form the recesses 6204 in the walls 6202a, 6202b and correspond to the recesses of the female connectors in the previously described female connector assemblies.

Each of the walls 6202a, 6202b have a flange 6206a, 6206b projecting outwardly and orthogonally from the top thereof. A leaf spring plate 6208 rests on top of the flanges 6206a, 6206b. The leaf spring plate 6208 comprises a plurality of spaced-apart leaf springs 6210 that slope therefrom into the recesses 6204 formed by the walls 6202a, 6202b. Each leaf spring 6210 mounts a release catch 6212, the release catch comprising a loop connected thereto and projecting upwardly through the opening in the leaf spring plate 6208 formed by the leaf springs 6210. The female connector assembly 6200 further comprises a cover sheet 6214 that extends over the top and sides of the leaf spring plate 6208 and engages the flanges 6206a, 6206b. The cover sheet comprises an elongate aperture 6216, arranged orthogonally to the longitudinal direction of the female connector assembly 6200. The release catch 6212 projects through the aperture 6216, so that that the position of the leaf spring can be adjusted by engaging the release catch 6212.

Referring now to FIGS. 63(a) and (b), in which like parts have been given the same reference numerals as before, there is shown an alternative embodiment of female connector assembly indicated generally by the reference numeral 6300. The female connector assembly 6300 is substantially similar to that shown in FIG. 62, except it comprises a base plate 6302 connected to the lower edges of the walls 6302a, 6302b.

Therefore, in use, when forming a panel from the female connector assembly 6300 and a plate (not shown), the female connector assembly 6300 would be offset from the plate by the base of the female connector assembly 6300. This would not be the case if the female connector assembly 6300 without the base is used. The use of female connector assembly 6300 therefore requires the use of joining brackets adapted to overcome this offset.

Referring now to FIG. 64, in which like parts have been given the same reference numerals as before, there is shown a further embodiment of female connector assembly indicated generally by the reference numeral 6400. The female connector assembly 6400 is substantially similar to that shown in FIG. 263, except that the walls 6202a, 6202b have been replaced by a single corrugated wall 6402 which performs the same function thereas. The corrugated wall 6402 is in the form of a flat based corrugation wherein the sides of the corrugations are at an angle of 23.5±2° to the base thereof.

In use, the female connector assemblies 6200, 6300, 6400 operate in the same way. The openings in the corrugations, on both sides of the female connector assemblies 6200, 6300 6400 form recesses for reception of the male connectors of the male connector assemblies of the joining brackets. The projecting finger of the male connector engages with the leaf springs so that the male connector cannot be removed once engaged. If however, it is desired to disengage the connection between a joining bracket at one of the female connector assemblies 6200, 6300, 6400, it is possible to do so by lifting the release catches, thus lifting the leaf springs, and so disengaging the leaf springs from the projecting finger of the male connectors.

In FIGS. 62, 63 and 64, leaf springs 6210x are shown only for illustrative purposes in the partially cut away figures. In practice, these leaf springs are not separable from their leaf spring plate 6208.

Referring now to FIGS. 65 and 66, in which like parts have been given the same reference numerals as before, there is shown a further female connector assembly, indicated generally by the reference numeral 6500. The assembly comprises a leaf spring plate 6208 as used in the female connector assembly 6200, 6300, 6400 and a top plate 6502. The leaf spring plate 6208 comprises an elongate plate having a number of spaced apart staggered apertures along its length, each aperture having a leaf spring 6210 extending therefrom in a sloped manner. Alternating leaf springs 6210 extend towards opposing side edges of the leaf spring plate 6208. The leaf springs mount release catches 6212 for controlling the leaf springs. The top plate 6502 is of similar dimensions to the leaf spring plate 6208 and comprises a plurality of apertures 6503 positioned to coincide with the leaf springs 6210 of the leaf spring plate 6208 when the two plates are superimposed on each other. In this way, when the two plates are superimposed, the leaf springs 6210 will fit through the apertures 6503.The top plate 6502 further comprises a plurality of arches 6504, each positioned adjacent an aperture 6503 and having a clear span of substantially the same width as the apertures 6503 and the leaf springs 6210.

In use, this female connector assembly 6500 may be welded to a plate to form a panel. Such a weld would be located at the flat plane on the top of the arches 6504.

Referring now to FIGS. 67(a), (b), (c), (d) and (e), in which like parts have been given the same reference numerals as before, there is shown a female connector assembly 6200 as is previously described herein in relation to FIG. 62. The female connector assembly 6200 mounts a release wand 6600. The release wand 6600 comprises an elongate wand having a plurality of stop members 6602 disposed therealong, with the spacing therebetween corresponding to the spacing between release catches of the female connectors of one side of the female connector assembly 6200. Each of the stop members 6602 comprises a cylindrical portion substantially equal in diameter to the area under the release catch 6212 that is accessible above the cover sheet 6214 when the leaf springs 6210 are in the lifted position. The stop members 6602 further comprise a tapered portion that tapers from the cylindrical portion to the wand. In use, the release want 6600 is mounted on the female connector assembly 6200 such that the release wand 6600 extends through all the release catches 6212 corresponding to the female connectors for one side of the female connector assembly 6200, with a stop member located adjacent each release catch. The tapered portion of the stop members 6602 project slightly under the release catches 6212. By pushing on the end of the release wand 6600 the tapered section will force the release catches 6212 upwards until the cylindrical section of the stop members are under the release catches, in which position the leaf springs will also have been lifted clear. If required, it is possible to have a pair of wands installed on one female connector assembly—one for the connectors on one side and the other for those on the other side.

It will be understood that either the release board or release wand 6600 may be used with any of the female connector assemblies described herein in relation to FIGS. 62, 63, 64 and 65. Furthermore, it will be apparent to the person skilled in the art that many of the features of the various female connector assemblies may be used in another embodiment of female connector assembly.

Referring now to FIGS. 68(a) and (b), in which like parts have been given the same reference numerals as before, there is shown an L-shaped joining bracket indicated generally by the reference numeral 6700. A female connector assembly 6500 has been brought into engagement with one side of male connector assemblies on the L-shaped joining bracket 6700. A small channel is formed at the base of the male connectors on either side thereof. The channel is formed by a pair of projections 6704 from the main body 6702. The channel receives the edge of the female connector assembly 6500.

It will be apparent that the sets of female and male connectors that have been described herein and shown in the accompanying figures fall into two general types. In the first of these, the male connector comprises a projecting finger having a somewhat bulbous head, and the female connector comprises a recess into which a flap, locking clip, leaf spring or similar projects. When the projecting finger of the male connector is pushed into the recess of the female connector, the head thereof will move easily past the locking clip element or the like until it is fully inserted. At this point, the locking clip element or the like will lock against the head of projecting finger, thereby preventing removal of the male connector from the female connector. The second general type of male and female connector sets comprises complementary sawtooth serrations that allow the projecting finger to be easily inserted, but lock against each other when removal is attempted. It will apparent to the person skilled in the art that other known types of male and female connector sets may be used with joining brackets and structural components of the invention and remain within the scope of the invention.

Preferably, female connector assemblies are welded on panels to form structural components such as walls and the like. The weld points provide extra rigidity and strength to the panel. In female connector assemblies comprising a corrugated wall providing the base, the use of the corrugated increases the weld area, creating many different planes and layers. Because many of the lines of weld are not parallel to each other in these connector assemblies, the joint interaction is stronger in a peel or shear stress situation.

Throughout the specification, a number of locking blocks have been shown and described as containing a rubber spring insert to provide biasing of locking surface, such as a serrated surface in a recess of a female connector. It will be understood that the invention is not limited to use with a rubber spring insert and that other suitable biasing elements may also be used, for example a simple coil spring.

Throughout the specification, the term connector assembly is used to refer to an assembly comprising one or more sets of similar connectors, wherein connectors within a set are in the same orientation.

Throughout the specification, the term staggered is used to refer to arrangement where there is no, or only a very small amount of overlap, between in the staggered articles.

It will be understood that any angles or dimensions described herein may be varied without departing from the scope of the invention. In general the tolerances on angles discussed herein is ±1°.

In the specification the terms ‘comprise’, ‘comprises’, ‘comprised’ and ‘comprising’ or any variation thereof and the terms ‘include’, ‘includes’, ‘included’ or ‘including’ or any variation thereof are considered to be totally interchangeable and they should all be afforded the widest possible interpretation.

The invention is not limited to the embodiment herein described, but may be varied in both construction and detail within the terms of the claims.

1. An assembly suitable for use in forming an electrical enclosure comprising
at least one joining bracket having a set of first connectors disposed along at least one edge thereof; and
at least one structural component having at least one set of second connectors affixed thereto, the first connectors being complementary to the second connectors,
such that the at least one joining bracket and the at least one structural component become automatically secured together when the first and second connectors are brought into engagement.

2. The assembly as claimed in claim 1 in which one of the first connector and second connector comprises a female connector having a recess and the other of the first connector and second connector comprises a male connector having a projecting finger.

3. The assembly as claimed in claim 1 in which the first connectors or second connectors comprise a release mechanism adapted to disengage an engagement of the first connectors and second connectors.

4. The assembly as claimed in claim 2 in which the male connector comprises a neck portion adjacent a distal end of the projecting finger.

5. The assembly as claimed in claim 2 in which the male connector comprises a plurality of sawtooth serrations on at least one surface of the projecting finger.

6. The assembly as claimed in claim 2 in which the projecting finger of the male connector tapers towards its distal end.

7. The assembly as claimed in claim 2 in which the female connector comprises a locking mechanism adapted to project into the recess.

8. The assembly as claimed in claim 7 in which the locking mechanism comprises a plurality of sawtooth serrations on at least one surface thereof

9. The assembly as claimed in claim 1 in which one or both of the set of first connectors and second connectors is formed into a connector assembly.

10. The assembly as claimed in claim 9 in which the connector assembly comprises at least two sets of connectors, each at a differing orientation.

11. The assembly as claimed in claim 10 in which the at least two sets of connectors in the connector assembly are opposed to each other.

12. The assembly as claimed in claim 11 in which connectors within a set are spaced-apart with respect to each other and staggered with respect to the opposing set of connectors.

13. The assembly as claimed in claim 11 in which connectors within a set are spaced-apart with respect to each other and in line with the opposing set of connectors.

14. An The assembly as claimed in claim 1 further comprising at least two joining brackets and at least one corner bracket adapted to connect the joining brackets to each other.

15. The assembly as claimed in claim 1 in which the at least one joining bracket in which the set of connectors are distributed along substantially the full length of at least one edge thereof.

16. The assembly as claimed in claim 1 in which the at least one component comprises at least one connector assembly disposed along a plurality of edges thereof

17. The assembly as claimed in claim 16 in which the at least one component comprises at least one set of connectors on a plurality of edges thereof

18. The assembly as claimed in claim 1 in which the at least one joining bracket comprises at least one set of connectors on a plurality of edges thereof.

19. The assembly as claimed in claim 1 further comprising an accessory component, wherein the accessory component comprises at least one set of first connectors or second connectors, and the accessory component is secured to the set of connectors on a structural component.

20. A female connector assembly suitable for use as the first or second connector of the assembly of as claimed in claim 1, the female connector assembly comprising set of aligned recesses, each having a locking mechanism to project into the recess.

21. The female connector assembly as claimed in claim 20 further comprising two opposing sets of female connectors.

22. A male connector assembly suitable for use as the first or second connector in the assembly as claimed in any preprevious claim 1, the male connector assembly comprising a set of aligned projecting fingers.

23. The male connector assembly as claimed in claim 22 further comprising at least two sets of male connectors.

24. The male connector assembly as claimed in claim 23 in which the at least two of the sets of male connectors are mutually orthogonal.
